(19) United States
(12) Patent Application Publication
(10) Pub. No.: US 2025/0296035 A1
(43) Pub. Date: Sep. 25, 2025

(54) SYSTEMS AND METHODS FOR CARBON DIOXIDE CAPTURE AND REGENERATION

(71) Applicant: UNIVERSITY OF SOUTH FLORIDA, Tampa, FL (US)

(72) Inventors: D.Yogi GOSWAMI, Tampa, FL (US); Krishnendu MAITY, Tampa, FL (US); Shreyash BHADIRKE, Tampa, FL (US); Dedeepya RIMMALAPUDI, Tampa, FL (US)

(21) Appl. No.: 19/090,182

(22) Filed: Mar. 25, 2025

Related U.S. Application Data
(60) Provisional application No. 63/569,235, filed on Mar. 25, 2024.
(60) Provisional application No. 63/759,938, filed on Feb. 18, 2025.

(51) Int. Cl. B01D 53/14; B01D 53/62

(52) U.S. Cl. CPC B01D 53/1475; B01D 53/1412; B01D 53/1425; B01D 53/1493; B01D 53/62; B01D 2252/204; B01D 2257/504; B01D 2257/708; B01D 2258/06

(57) ABSTRACT

The present disclosure provides an apparatus for managing CO₂ removal from an environment can include an air inlet that can receive an airflow having an initial amount of CO₂ molecules, a liquid solution that can absorb CO₂ molecules from the airflow and reduce the initial amount of the CO₂ molecules, a reservoir that can receive the liquid solution, a pump in fluid communication with the reservoir that can provide pressure to receive the liquid solution from the reservoir, a pipe in fluid communication with the pump that can move the liquid solution from the pump to a plurality of openings for the liquid solution to contact the airflow, and an air outlet that can discharge the airflow having the reduced amount of the CO₂ molecules.

### CROSS-REFERENCE TO RELATED APPLICATIONS

This application claims the benefit of U.S. Provisional Patent Application Ser. Nos. 63/569,235 filed on Mar. 25, 2024 and 63/759,938 filed on Feb. 18, 2025, the contents of which are incorporated by reference herein in their entireties.

### GOVERNMENT SUPPORT

Not Applicable.

### BACKGROUND

The fight against rising CO₂ emissions has become a global race, with researchers focusing on two key fronts: reducing dependence on fossil fuels by making renewable energy more accessible and efficient, and advancing direct air capture (DAC) and carbon capture and storage (CCS) technologies to remove CO₂ from the atmosphere. These efforts are not just about slowing emissions but also about reversing their impact-aiming to achieve net-zero CO₂ emissions by 2050 and preventing global temperatures from exceeding the critical 1.5° C. threshold. According to the Global Monitoring Laboratory of the National Oceanic and Atmospheric Administration, the average global CO₂ concentration in 2023 was 420 ppm (0.042%), which is considered safe for humans. Nevertheless, indoor CO₂ concentrations, especially in workplaces like offices and conference halls, often surpass recommended limits due to occupant's exhalation, placing increased demands on heating, ventilation, and air conditioning (HVAC) systems to maintain indoor air quality. For instance, concentration of CO₂ in an indoor environment can be four to five times higher than the outdoor air. Prolonged exposure to elevated CO₂ levels can lead to health issues such as respiratory acidosis, increased heart rate, cognitive decline, and hypercapnia. The Occupational Safety and Health Administration (OSHA) has established a maximum permissible exposure limit of 5000 ppm over an 8-hour workday. However, relying solely on ventilation to meet this standard can significantly increase the system's carbon footprint. Additionally, research indicates that keeping CO₂ levels below specific thresholds enhances the occupants' cognitive functions and productivity. Therefore, capturing CO₂ is the only viable option to keep the CO₂ level within the acceptable limit in indoor spaces. Since the concentration of CO₂ in indoor air can be four to five times higher than that in outdoor air, capturing CO₂ directly from indoor air can be easier than from outdoor air. The benefits of capturing CO₂ from indoor air are twofold: first, it removes CO₂ from the atmosphere, and second, it improves the health and work efficiency of individuals working indoors.

Thus, there remains a need for alternative agents and devices to effectively capture CO₂ from an indoor setting to improve air quality.

### SUMMARY

According to some aspects of the present disclosure, an apparatus for managing CO₂ removal from an environment can include an air inlet that can receive an airflow having an initial amount of CO₂ molecules, a liquid solution that can absorb CO₂ molecules from the airflow and reduce the initial amount of the CO₂ molecules, a reservoir that can receive the liquid solution, a pump in fluid communication with the reservoir that can provide pressure to receive the liquid solution from the reservoir, a pipe in fluid communication with the pump that can move the liquid solution from the pump to a plurality of openings for the liquid solution to contact the airflow, and an air outlet that can discharge the airflow having the reduced amount of the CO₂ molecules.

In some embodiments, the apparatus can include at least one sensor that can measure one or more of the initial amount of the CO₂ molecules at the air inlet or the reduced amount of the CO₂ molecules. In some embodiments, the apparatus can include a controller that can provide a signal for regeneration of the liquid solution based on a difference between the initial amount of the CO₂ molecules and the reduced amount of the CO₂ molecules.

In some embodiments, the apparatus can include a secondary filter that can remove volatile organic compounds from the airflow. In some embodiments, the liquid solution can include an amino compound in a solvent comprising water, a glycol, and a surfactant. In some embodiments, the plurality of openings can include a spray nozzle.

In some embodiments, the apparatus can include a fan that can adjustably direct the airflow from the air inlet to the air outlet, a column including a channel that can be in fluid communication with the pipe to receive the liquid solution through the plurality of openings, and a plurality of packings positioned within the channel that can provide the contact between the liquid solution and the airflow. In some embodiments, the plurality of packings can include Raschig rings. In some embodiments, the plurality of packings can include a porous surface that is configured to be coated with the liquid solution. In some embodiments, the air inlet can be arranged at a lower portion of the column, and the air outlet can be arranged at an upper portion of the column. In some embodiments, the reservoir can include one or more of: a sealable reservoir, a removable reservoir, a storage container that can receive absorbed CO₂ molecules from the sealable reservoir, and an indicator that can notify a user to replace or regenerate the liquid solution within the removable reservoir.

In some embodiments, the apparatus can be integrated into an airflow system that can include at least one of: an air conditioning (A/C) unit, a heating, ventilation, and air conditioning (HVAC) unit, and an exhaust, wherein the liquid solution can be heated for regeneration outside of the environment before entering the reservoir to absorb the CO₂ molecules.

According to some aspects of the present disclosure, a method for absorbing CO₂ from an environment can include receiving a first airflow having a first concentration of CO₂ molecules, the first airflow being originated from the environment and flowing in a first direction, circulating a solution from a reservoir so that the solution can contact the first airflow in a second direction that can be different than the first direction, the solution being configured to absorb CO₂ molecules from the first airflow, and discharging a second airflow having a second concentration of CO₂, the second concentration being less than the first concentration.

In some embodiments, the solution can comprise an amino compound in a solvent comprising water, a glycol, and a surfactant.

In some embodiments, the method can include measuring the first concentration of CO₂ via a first sensor, and measuring the second concentration of CO₂ via a second sensor. In some embodiments, based on the measured first concentration of CO₂ or the second concentration of CO₂, the method can include adjusting at least one of: a flow rate of the solution, a temperature of the solution, a flow rate of the first airflow, or a flow rate of the second airflow. In some embodiments, the method can include determining a CO₂ reduction based on the measured first concentration of CO₂ and the measured second concentration of CO₂.

In some embodiments, the method can include storing information regarding the measured first concentration of CO₂, the measured second concentration of CO₂, and the CO₂ reduction for a plurality of time points while circulating the solution, and determining a regeneration status of the solution based on the CO₂ reduction for the plurality of time points.

In some embodiments, the method can include heating the solution for regeneration, the heated solution being configured to further absorb CO₂ from the environment. In some embodiments, discharging the second airflow can include discharging the second airflow into the environment that the first airflow originated from, or discharging the second airflow into a different environment than the environment that the first airflow originated from.

According to some aspects of the present disclosure, a device for controlling or adjusting CO₂ molecules in an environment can include a column including a channel that can include a channel inlet for receiving an airflow having CO₂ molecules and flowing in a first direction and a channel outlet for discharging the airflow from the channel, a reservoir including a liquid solution that can absorb the CO₂ molecules from the airflow, a pipe in fluid communication with the channel that can provide the liquid solution within the channel in a second direction that can be different than the first direction, a plurality of porous structures arranged in the column that can engage the liquid solution when received in the column via the pipe, and a fan in fluid communication with the column that can induce the airflow to move from the channel inlet to the channel outlet, the fan further discharging the airflow from the device.

In some embodiments, the reservoir can include an air inlet that can receive the airflow from the environment, such that the airflow can be directed from the reservoir to the channel via the channel inlet. In some embodiments, the first direction can be opposite the second direction. In some embodiments, the plurality of porous structures can include one or more of an outer surface or an inner surface that each engage with the liquid solution.

### BRIEF DESCRIPTION OF THE DRAWINGS

The following drawings are provided to help illustrate various features of non-limiting examples of the disclosure and are not intended to limit the scope of the disclosure or exclude alternative implementations.

FIG. 1A shows the reaction between CO₂ and amine, presence and absence of water.

FIG. 1B shows the regeneration of amine.

FIG. 2A shows CO₂ absorption during the CO₂ absorption process for aqueous MEA, aqueous L-arginine, H₂O-EG-Arg, and H₂O-PG-Arg solution. Absorption 2 refers to the second cycle after the initial absorption-desorption cycle.

FIG. 2B shows TVOC concentration during the CO₂ absorption process for aqueous MEA, aqueous L-arginine, H₂O-EG-Arg, and H₂O-PG-Arg solution. Absorption 2 refers to the second cycle after the initial absorption-desorption cycle.

FIG. 2C shows RH levels during the CO₂ absorption process for aqueous MEA, aqueous L-arginine, H₂O-EG-Arg, and H₂O-PG-Arg solution. Absorption 2 refers to the second cycle after the initial absorption-desorption cycle.

FIG. 3A shows the effect of MW irradiation time on CO₂ desorption for aqueous MEA solution.

FIG. 3B shows the effect of MW desorption time on volume of the solution for aqueous MEA solution.

FIG. 4 shows (a) absorption-desorption performance over ten cycles of aqueous MEA and H₂O-PG-Arg solution. The percentage reduction of the amount of CO₂ absorbed after each absorption process, as well as the cumulative reduction after ten cycles, is shown at the top of the figure. (b) absorption-desorption performance over ten cycles of aqueous MEA and H₂O-PG-Arg solution with trendline.

FIG. 5 shows (a) Reaction rate constant over ten cycles of aqueous MEA and H₂O-PG-Arg solution. The percentage decrease in the rate constant in each absorption process, as well as the cumulative reduction after ten cycles, is shown at the top of the figure. (b) Reaction rate constant over ten cycles of aqueous MEA and H₂O-PG-Arg solution with trendlines.

FIG. 6 shows the experimental setup used for absorption and desorption of CO₂ scrubbing solution (a) Two-neck round bottom flask absorption system (b) MW setup for solution regeneration.

FIG. 7A shows CO₂ separation over time for aqueous MEA, aqueous Arg, H₂O-EG-Arg, and H₂O-PG-Arg solutions.

FIG. 7B shows the reaction kinetics for aqueous MEA, aqueous Arg, H₂O-EG-Arg, and H₂O-PG-Arg solution.

FIG. 8 shows the relative humidity profile for aqueous MEA and aqueous Arg solution. The slope of the line was determined by linear regression.

FIG. 9 shows the Arg crystals after desorption of aqueous Arg solution.

FIG. 10A shows TVOC for H₂O-PG-based Arg solution with and without activated charcoal canister.

FIG. 10B shows relative humidity profile for H₂O-PG-based Arg solution with and without activated charcoal canister.

FIG. 11A shows relative humidity inside the absorption test chamber over time for H₂O-PG-Arg solution.

FIG. 11B shows TVOC levels inside the absorption test chamber over time for H₂O-PG-Arg solution.

FIG. 12 is a block diagram illustrating a scrubbing device, according to examples of the disclosed technology.

FIG. 13 is a schematic illustration of a scrubbing device, according to examples of the disclosed technology.

FIG. 14 illustrates a flowchart illustrating a method of operating a scrubbing device, according to examples of the disclosed technology.

FIG. 15 is a schematic illustration of an experimental apparatus for capturing carbon dioxide (CO₂) molecules from an enclosed chamber.

FIG. 16 is a graph illustrating experimental data from a data logger of the experimental apparatus of FIG. 15 with respect to changes in various parameters including CO₂ concentration, total volatile organic compounds (TVOCs), relative humidity (RH), temperature, and absolute humidity.

### DETAILED DESCRIPTION

The present disclosure relates to compositions, devices, methods for absorbing carbon dioxide (CO₂) from a gas phase, in particular indoor air.

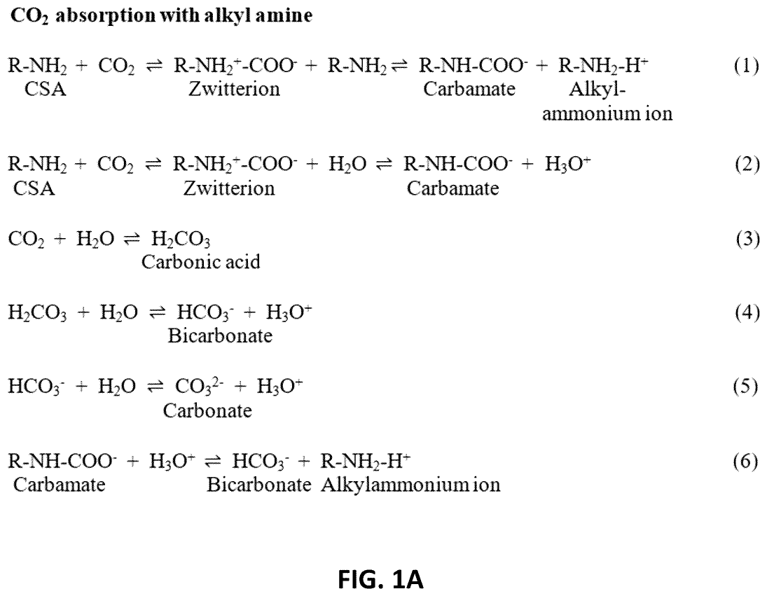

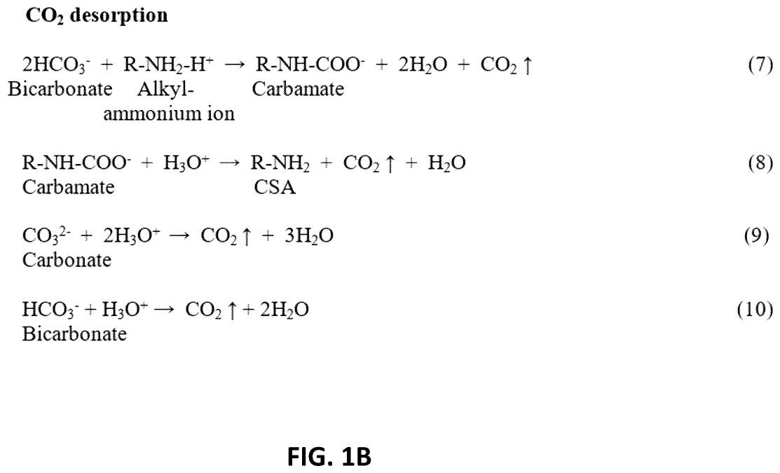

Chemical absorption is one of the most promising technologies for CO₂ capture due to its high selectivity and scalability opportunities. Various absorbing agents were reported, including aqueous alkali solutions, amines, ionic liquids, amine-functionalized adsorbents, and amino acid solutions, to chemically extract CO₂ from air or gas streams. Among these methods, amine-based technology remains the most widely used. Researchers have shown that the interaction between CO₂ and aqueous amines follows the zwitterionic mechanism. The nucleophilic lone pair on the nitrogen atom of the amine attacks the electrophilic carbon of CO₂, forming zwitterionic adduct (R—NH₂⁺—COO⁻), which stabilizes into carbamate (R—NH—COO⁻) and an alkylammonium ion (R—NH₂—H⁺) upon deprotonation (Reaction 1). As absorption progresses, the pH and absorption rate decrease due to the depletion of the CO₂ scrubbing agent (CSA), weakening Reaction. This favors hydration reactions (Reactions 2-5), resulting in the formation of bicarbonate (HCO₃⁻) and carbonate (CO₃²⁻). Additionally, as the pH drops, carbamate formed in Reactions 1 and 2 decomposes into bicarbonate, as shown in Reaction 6. This process is reversible during desorption, as shown in Reactions 7-10. The full sequence of absorption and desorption reactions is outlined in FIGS. 1A-1B.

Alkanolamines are preferred over alkylamines for CO₂ capture due to their higher boiling points and lower volatility, which reduces the emission of VOCs during absorption and desorption processes. Monoethanolamine (MEA) is used as a benchmark solvent due to its affordability, high water solubility, and rapid CO₂ absorption rate. However, it still has drawbacks, such as volatility that can lead to higher TVOC emissions and may limit indoor use, along with a high energy demand for regeneration. Furthermore, it is prone to thermal and oxidative degradation, which results in increased viscosity, solution fouling, and corrosion of downstream equipment. These challenges highlight the need for alternative CSA for indoor CO₂ capture. Aqueous amino acids are emerging as promising alternatives. Known for their high surface tension, they offer comparable CO₂ absorption capacity with negligible vapor pressure and greater resistance to degradation. These properties make them well-suited for capturing CO₂ in indoor applications, providing a viable path forward in overcoming the limitations of conventional absorbents like MEA. Arginine (Arg) specifically offers several advantages over traditional absorbents like MEA, including greater resistance to thermal and oxidative degradation. This allows the Arg solution to undergo multiple absorption-desorption cycles, reducing costs associated with frequent solution replacement. Its higher surface tension also minimizes evaporation losses during both CO₂ capture and release, and its biodegradability makes Arg a more environmentally sustainable option. However, despite these promising attributes, only a limited number of studies have explored the role of Arg in CO₂ capture. No research to date has specifically addressed CO₂ capture from indoor air while simultaneously controlling TVOC and humidity levels. Maintaining optimal levels of both TVOCs and humidity is essential for safeguarding respiratory health and ensuring thermal comfort for occupants.

The present disclosure addresses the deficiencies of previous studies and provides efficient and affordable CO₂ capture compositions, devices, methods. Advantageously, the present compositions and devices can be specifically designed for indoor use, with added functionality for managing TVOCs and humidity to enhance overall indoor air quality.

Concentration of CO₂ in an indoor environment can be four to five times higher than the outdoor air. This higher indoor concentration of CO₂ reduces the work efficiency of individuals working indoors and negatively impacts human health. However, the elevated concentration also makes it easier to capture CO₂ from indoor air. In certain embodiments, the present disclosure demonstrated the performance of monoethanolamine (MEA) and L-arginine (Arg) solutions for indoor carbon dioxide (CO₂) capture through experimental screening. The parameters evaluated include CO₂ absorption and desorption capacity, absorption kinetics, and the impact on relative humidity (RH) and total volatile organic compound (TVOC) concentrations. In particular embodiments, two solvent formulations were studied: one utilizing pure water as the solvent and the other incorporating a water-glycol mixture. The aqueous Arg solution demonstrated minimal to no detectable increase in VOC levels and exhibited lower evaporation rates than the benchmark aqueous MEA solution. Microwave (MW) heating can be utilized to facilitate rapid CO₂ desorption from saturated solutions. The regeneration efficiency, solvent loss, and energy consumption were found to be dependent on the MW desorption time. Optimizing the desorption resulted in faster and almost complete regeneration, minimized solvent loss, and reduced overall energy consumption. The incorporation of glycol minimized evaporation during absorption, decreased the likelihood of complete drying during desorption, and improved solution regeneration. Cyclic absorption-desorption experiments were conducted to evaluate the long-term stability and kinetic performance of the solutions. In representative studies, the water-PG-based Arg solution exhibited a promising performance, with only a 31.24% reduction in CO₂ absorption and a 2.13% decrease in absorption kinetics after ten cycles. In contrast, the aqueous MEA solution showed much larger declines of 54.3% in CO₂ absorption and 34.24% in kinetics. Additionally, the water-PG-based Arg solution resulted in lower volatile organic compound (VOC) levels and provided more effective control over relative humidity. These findings underscore the potential of the water-PG-based Arg solution for cyclic CO₂ absorption and microwave-assisted regeneration processes.

In one aspect, the present disclosure provides a carbon dioxide absorption composition, comprising a solution of an amino compound in a solvent comprising water, a glycol, and a surfactant.

Typically, the amino compound of the present disclosure reacts with CO₂ to form a soluble carbamate, thereby absorbing (or scrubbing) the CO₂ into the solution. The absorbed CO₂ can be released in a desorption process that includes hydrolysis of the carbamate and regeneration of the amino compound. Representative chemical reactions involved in the CO₂ adsorption and desorption processes include those illustrated in FIGS. 1A-1B. The desorption process can be carried out, for example under heating or microwave irradiation.

Suitable amino compounds for the present composition include, but are not limited to, an alkylamine, an alkanolamine, an amino acid, or a combination thereof. The alkylamine refers to a compound having an amino group (—NH₂) attached to an alkyl group. The term “alkyl” as used herein, means a straight or branched chain saturated hydrocarbon. As non-limiting examples, the alkyl can be a C₁₋₁₀alkyl, such as methyl, ethyl, n-propyl, isopropyl, n-butyl, sec-butyl, isobutyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, and n-decyl. The alkanolamine refers to an alkylamine compound further substituted with one or more hydroxyl (—OH) groups. The amino acid refers to compounds having both amino (—NH₂) and carboxylic acid (—COOH) groups, or salts thereof. The amino acids as used herein can include natural or synthetic compounds, such as α-amino acids, β-amino acids, or γ-amino acids.

In some embodiments, the amino compound is an alkanolamine, such as monoethanolamine. In some embodiments, the amino compound is an amino acid, such as a natural amino acid. In some embodiments, the amino compound is arginine.

The glycol of the present composition refers to an organic compound with two hydroxyl (—OH) groups attached to adjacent carbon atoms. For example, the glycol can include a carbon chain and two —OH groups are attached to adjacent carbon atoms of the carbon chain. Suitable glycols can include, for example, ethylene glycol, diethylene glycol propylene, triethylene glycol, propylene glycol, di-propylene glycol, and a mixture thereof. In some embodiments, the glycol is ethylene glycol or propylene glycol. In some embodiments, the glycol is propylene glycol.

The present composition includes a solution of the amino compound dissolved in a solvent, which includes a mixture of water and the glycol. The ratio of the water to the glycol can be about 0.5:1 to about 2:1 by volume. In some embodiments, the ratio of water to the glycol is about 1:1 by volume.

In some embodiments, the amino compound has a concentration of about 500 mM to about 20000 mM in the solution, such as from about 500 mM to about 15000 mM, about 500 mM to about 10000 mM, about 500 mM to about 5000 mM, about 500 mM to about 2000 mM, about 500 mM to about 1000 mM, about 1000 mM to about 15000 mM, about 1000 mM to about 10000 mM, about 1000 mM to about 5000 mM, or about 1000 mM to about 2000 mM. In some embodiments, the amino compound has a concentration of about 500 mM, about 1000 mM, about 2000 mM, about 5000 mM, about 10000 mM, about 15000 mM, or about 20000 mM. In some embodiments, the amino compound is an amino acid having a concentration of about 500 mM to about 2000 mM. In some embodiments, the amino compound is an amino acid having a concentration of about 1000 mM. In some embodiments, the amino compound has a concentration of about 500 mM to about complete saturation in the solution (such as about 1000 mM or about 2000 mM). In some embodiments, the amino compound is a water miscible amine, which may have a concentration of about 1000 mM to about 10000 mM in the solution, such as about 2000 mM, about 5000 mM, or about 8000 mM. In some embodiments, the amino compound is a water miscible amine having a concentration of about 1000 mM.

Suitable surfactants can include, but are not limited to, cationic surfactants, anionic surfactants, amphoteric surfactants, zwitterionic surfactants, nonionic surfactants, and mixtures thereof. In some embodiments, the surfactant includes a nonionic surfactant, such as polyoxyalkylene alkyl ethers, polyoxyalkylene alkenyl ethers, polyoxyalkylene alkyl phenyl ethers, alkyl polyglucosides, fatty acid polyglycerine esters, fatty acid sugar esters, and fatty acid alkanolamides. In some embodiments, the surfactant includes an anionic surfactant, such as a carboxylate-, sulfonate-, or sulfate-based surfactant. In some embodiments, the surfactant includes sodium lauryl sulfate (SLS), sodium laureth sulfate (SLES), linear alkylbenzene sulfonates (LAS), sodium dodecyl sulfate (SDS), alpha olefin sulfonates (AOS), and sulfonated castor oil; the cationic surfactants include cetyltrimethylammonium bromide (CTAB), benzalkonium chloride (BAC), benzethonium chloride, dodecyltrimethylammonium chloride (DTAC), and cetrimonium chloride (CTAC); the non-ionic surfactants include polysorbates (Tween 20, Tween 80), sorbitan esters (Span 20, Span 80), alcohol ethoxylates, polyethylene glycol (PEG) derivatives, cocamide diethanolamine (Cocamide DEA), and cocamide monoethanolamine (Cocamide MEA); and the amphoteric surfactants include cocamidopropyl betaine (CAPB), lauryl betaine, sodium cocoamphoacetate, sodium lauryl amphopropionate, or a combination thereof. In some embodiments, the surfactant is perfluorooctanoic acid (PFOA), sodium dodecyl sulfate (SDS), Triton X-100, or a combination thereof.

In some embodiments, the surfactant has a concentration of about 200 mg/L to about 500 mg/L, such as about 200 mg/L to about 450 mg/L, about 200 mg/L to about 400 mg/L, about 200 mg/L to about 350 mg/L, or about 200 mg/L to about 300 mg/L. In some embodiments, the surfactant has a concentration of about 200 mg/L, about 250 mg/L, about 300 mg/L, about 350 mg/L, about 400 mg/L, about 450 mg/L, or about 500 mg/L. Suitable surfactant concentration can be measured by folds of the critical micelle concentration (CMC) of the surfactant in the solution. In some embodiments, the surfactant has a concentration that is about 4 to about 10 times the CMC, such as about 4 times the CMC, about 5 times the CMC, about 6 times the CMC, about 7 times the CMC, about 8 times the CMC, about 9 times the CMC, or about 10 times the CMC.

The effects of adding surfactants to aqueous amine solutions were previously studied. However, those studies do not examine the implications in a continuous operational setting. The present disclosure provides a deeper analysis of surfactant behavior under real process conditions, which is beyond the scope of earlier reports. Significantly, the present disclosure uncovers insights previously overlooked, making the findings herein uniquely valuable for practical applications.

In some embodiments, the present composition utilizes a 50 ml/50 ml (1:1) water-glycol mixture as a solvent, especially propylene glycol, leveraging the distinct properties of glycol to enhance performance. Glycol reduces solvent volatility, minimizing evaporative losses, which maintains solvent integrity over extended use. Additionally, glycols have lower specific heat capacities, meaning they require less thermal energy to reach the desorption temperature, improving energy efficiency.

The present composition can include one or more glycols in combination with one or more surfactants as described herein to enhance performance for continuous operation. The surfactant can act as a foaming agent to increase CO₂ absorption when the composition contacts CO₂. On the other hand, the glycol can act as a defoamer among its other roles. Further, the present disclosure demonstrates that the incorporation of surfactants and defoamers (such as glycols) can effectively control foam stability. Under continuous operating conditions, excessively stable foam can lead to overflow, causing chemical loss, operational disruptions, and potential safety hazards. Therefore, precisely tuning the foaming behavior is essential when surfactants are present. By adjusting the ratio of surfactants to defoamers, the foam's lifespan can be carefully managed, ensuring it remains transient and does not exceed a controlled level. In some embodiments, the relative proportion of the glycol to the surfactant enhances carbon dioxide absorption. For example, the present composition can include the glycol and the surfactant at a specific relative proportion to create a short-lived foam that enhances CO₂ absorption from a gas phase, such as from indoor air. In some embodiments, a 1:1 ratio of water and glycol was found to be particularly effective, based on the solubility of the CO₂-scrubbing chemicals and a fluorosurfactant concentration that is about 4 to about 10 times the critical micelle concentration (CMC) in water at 25° C.

While many surfactants can be used in the present carbon dioxide absorption composition, fluorosurfactants can be chosen in particular embodiments for their superior ability to reduce surface tension at lower concentrations, enhanced chemical stability over multiple adsorption-desorption cycles, and chemical inertness.

In some embodiments, the amino compound is arginine and the solvent comprises water and propylene glycol in a ratio of about 1:1 by volume.

In some embodiments, the composition includes arginine (e.g., L-arginine), water, and propylene glycol. In some embodiments, the ratio of water and propylene glycol is about 1:1 by volume. In some embodiments, the concentration of arginine (e.g., L-arginine) in water and propylene glycol is about 1 M. In some embodiments, the composition of arginine (e.g., L-arginine), water, and propylene glycol further includes a surfactant selected from perfluorooctanoic acid (PFO), sodium dodecyl sulfate (SDS), and Triton X100. In some embodiments, the composition includes about 1 M arginine (e.g., L-arginine) dissolved in a solvent of water and propylene glycol at a ratio of about 1:1 by volume, and a surfactant selected from perfluorooctanoic acid (PFO), sodium dodecyl sulfate (SDS), and Triton X100.

In some embodiments, the composition includes MEA, water, and propylene glycol. In some MEA composition, the ratio of water and propylene glycol can be about 1:1 by volume. In some embodiments, the MEA composition further includes a surfactant selected from perfluorooctanoic acid (PFO), sodium dodecyl sulfate (SDS), and Triton X100. In some embodiments, the composition includes MEA, water, and propylene glycol at a ratio of about 1:1 by volume, and a surfactant selected from perfluorooctanoic acid (PFO), sodium dodecyl sulfate (SDS), and Triton X100.

In some embodiments, the composition includes MEA, one or more glycols (such as propylene glycol), water, and one or more surfactants (such as fluorosurfactants). In some embodiments, the composition includes arginine (e.g., L-arginine), one or more glycols (such as propylene glycol), water, and one or more surfactants (such as fluorosurfactants).

In some embodiments, the composition includes arginine (e.g., L-arginine), water, ethylene glycol, and a surfactant. In some embodiments, the ratio of water and ethylene glycol is about 1:1 by volume. In some embodiments, the concentration of arginine (e.g., L-arginine) in water and ethylene glycol is about 1 M. In some embodiments, the composition includes about 1 M arginine (e.g., L-arginine) dissolved in a solvent of water and ethylene glycol at a ratio of about 1:1 by volume.

In another aspect, the present disclosure provides a device for carbon dioxide absorption, which comprises the carbon dioxide absorption composition as described herein and a chamber in which the carbon dioxide absorption composition is placed.

The present device can further comprise an inlet connected to the chamber for introducing a gas phase comprising carbon dioxide to react with the carbon dioxide absorption composition in the chamber, thereby reducing content of the carbon dioxide in the gas phase; and a channel connected to the chamber, through which the gas phase with reduced content of carbon dioxide exits the chamber.

The present device can further include other components and accessories, such as a power supply, a monitor, a housing, and a user interface. In some embodiments, the present device can be used to absorb indoor carbon dioxide.

In another aspect, the present disclosure provides a method of removing carbon dioxide in a gas phase. The method can comprise contacting the gas phase with the carbon dioxide absorption composition as described herein, so that the carbon dioxide in the gas phase reacts with the amino compound in the carbon dioxide absorption composition to produce a carbon dioxide-enriched composition, thereby reducing content of the carbon dioxide in the gas phase.

For example, the chemical reactions involved in the CO₂ adsorption process include those illustrated in FIG. 1A. The contact between the gas phase and the carbon dioxide absorption composition can include any form of gas-liquid surface contact. For example, the gas phase can be flowed across the surface of the liquid composition or bubbled through the bulk volume of the liquid composition. Additionally, the gas phase can be introduced to the liquid composition repeatedly through recycling of the gas phase.

The gas phase can be present in an outdoor environment, an indoor environment, or an isolated space (e.g., a sealed container, a chamber with controlled input and output, or a flow path for a gas and/or a fluid). In some embodiments, the gas phase comprises air. The air can include natural air or artificially modified air for animal or human use. In some embodiments, the gas phase is indoor air. The term “indoor” as used herein refers to an enclosed or partially enclosed space for animal or human activities, such as the internal space of a building, a stadium, a laboratory, a room, a residence, an office, a hospital, a vehicle, a ship, a submarine, an aircraft, etc. The indoor air may have a CO₂ level of about 400 ppm to about 5,000 ppm, or higher than 5,000 ppm. In some embodiments, the gas phase comprises more concentrated streams of CO₂. For example, the gas phase with elevated CO₂ content may include a gas product or by-product from a fossil fuel-based power plant, an exhaust gas from a vehicle, or a gas emitted from a source where a biomass is burned.

In another aspect, the present disclosure provides a method of improving indoor air quality. The method can comprise contacting the indoor air with the carbon dioxide absorption composition as described herein, such that the carbon dioxide in the indoor air reacts with the amino compound in the carbon dioxide absorption composition to produce a carbon dioxide-enriched composition, thereby reducing content of the carbon dioxide in the indoor air.

The composition and device as described herein may be particularly suitable for capturing (or scrubbing) CO₂ from indoor air, providing an approach to effectively improve indoor air quality that has not been observed in the art. On the one hand capturing CO₂ from indoor air is beneficial because the concentration of CO₂ in indoor air is much higher than outdoor air. However, it can be also difficult to maintain comfort conditions of temperature and relative humidity (RH) in indoor air. In addition, introduction of additional volatile organic compounds (VOCs) in indoor air should be avoided. Advantageously, the present method may maintain comfort indoor conditions for the occupants while capturing CO₂ from indoor air. Further, by capturing CO₂ from indoor air, the CO₂ levels is maintained below what is unhealthy for occupants.

In some embodiments, the indoor air has a CO₂ level of about 400 ppm to about 5,000 ppm, or higher than 5,000 ppm.

In some embodiments, the method is carried out while a relative humidity (RH) level of the indoor air is maintained at a comfortable condition for the occupants, such as within 0-90%, within 30-70%, or within 40-60%. In some embodiments, the method is carried out while the relative humidity (RH) level of the indoor air is maintained within 30%-70%. In some embodiments, the method is carried out while the relative humidity (RH) level of the indoor air is maintained within 40%-60%.

In some embodiments, the method is carried out while a total volatile organic compounds (TVOCs) level of the indoor air is maintained below 10 ppm, such as below 8 ppm, below 5 ppm, below 2 ppm, or below 1 ppm. In some embodiments, the method is carried out while a total volatile organic compounds (TVOCs) level of the indoor air is maintained below 1 ppm. To further improve the indoor air quality, additional agents (such as activated carbon) may be used in the present device or method to absorb or remove the undesired components in the indoor air (such as organic compounds). For example, the additional agent can be placed in a separate unit or container in the indoor environment. Alternatively, the additional agent can be placed in a compartment or unit of the present device to used together with the present carbon dioxide absorption composition. In some embodiments, the present method for improving indoor air quality further comprises passing the indoor air through activated carbon. In particular, the use of activated carbon can facilitate reducing the TVOCs levels in the indoor air. For example, by passing the indoor air through activated carbon, the present method can be carried out while maintaining the TVOCs further below 1 ppm, such as below 0.5 ppm, below 0.2 ppm, or below 0.1 ppm (100 ppb). In some embodiments, the present method includes passing the indoor air through activated carbon, and the TVOCs level of the indoor air is maintained below 0.1 ppm, such as below 50 ppb, below 20 ppb, or below 10 ppb.

A CO₂ desorption process may be utilized in the present methods to regenerate the CO₂ absorption composition. For example, the chemical reactions involved in the CO₂ desorption process include those illustrated in FIG. 1B. The CO₂ desorption process can be facilitated by the application of external energy, such as heating and microwave irradiation. As an example, the carbon dioxide-enriched composition may be heated (e.g., by a hot plate or heating unit) or subjected to microwave (e.g., an industrial or house-hold equipment). In some embodiments, the carbon dioxide-enriched composition may be more effectively regenerated by microwave irradiation as compared to heating. In some embodiments, the present methods for removing CO₂ or improving indoor air quality further comprises subjecting the carbon dioxide-enriched composition to microwave irradiation, thereby producing a regenerated carbon dioxide absorption composition and releasing the absorbed carbon dioxide.

In some embodiments, the method includes subjecting the carbon dioxide-enriched composition to microwave irradiation for about 10 to about 300 seconds, about 30 to about 270 seconds, about 50 to about 250 seconds, or about 60 to about 210 seconds. In some embodiment, a 1200-watt Panasonic microwave oven at heating power level 10 is utilized for irradiation, with an end temperature in the range about 90 to about 130° C. Typically, a 50 mL solution of the carbon dioxide-enriched composition is irradiated. Typically, the microwave irradiation process will release at least 70% of absorbed CO₂ from the composition.

The present methods can be operated in a continuous manner, by which the CO₂ adsorption-desorption processes are repeated in cycles. As used herein, each “cycle” or “regeneration cycle” refers to a complete sequence of CO₂ adsorption and desorption according to the present methods, resulting in a regenerated carbon dioxide absorption composition. In some embodiments, the present method further comprises reusing the regenerated carbon dioxide absorption composition for reaction with the carbon dioxide in the gas phase or indoor air. Typically, the regenerated composition retains most of its capacity of CO₂ absorption before regeneration. In some embodiments, the present composition can have less than 35% reduction in CO₂ absorption capacity after 10 regeneration cycles. In some embodiment, the initial 3-4 cycles may exhibit a relatively greater drop in capacity, which is stabilized in the later cycles. As a result, the variations in the last four cycles may be minimal. By recycling and reusing the regenerated carbon dioxide absorption composition, the method can be carried out in continuous cycles at reduced cost.

In some embodiment, the present method can include carrying out a plurality of carbon dioxide absorption-desorption cycles, each of which can include the steps of:
(A) contacting the gas phase or indoor air with the carbon dioxide absorption composition to produce a carbon dioxide-enriched composition and reduce the carbon dioxide content in the gas phase or indoor air;
(B) subjecting the carbon dioxide-enriched composition to microwave irradiation, thereby producing a regenerated carbon dioxide absorption composition and releasing the absorbed carbon dioxide; and
(C) recycling the regenerated carbon dioxide absorption composition to step (A) for reaction with the carbon dioxide in the gas phase or indoor air.

Typically, the desorption/regenerate process can be done with the release of CO₂ into an environment where the released CO₂ does not raise a safety concern. For example, the CO₂ absorbed from indoor air by the present composition or device can be released in an outdoor environment. In some embodiments, the desorption process is carried out in an outdoor environment. Alternatively, the absorbed CO₂ can be collected and used for production of other materials. For example, the CO₂ collected from the present method may be used in making mineral water or jet fuel. Thus, the present composition, device, and method offers an effective way to recycle CO₂, in particular CO₂ from indoor air, for a useful purpose. In some embodiments, the present method further comprises collecting the released carbon dioxide, such as in a storage container, for useful applications.

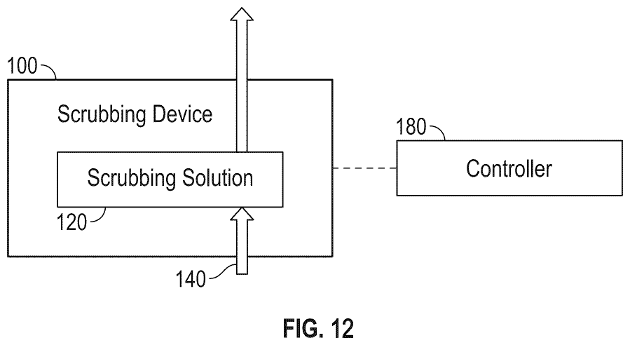

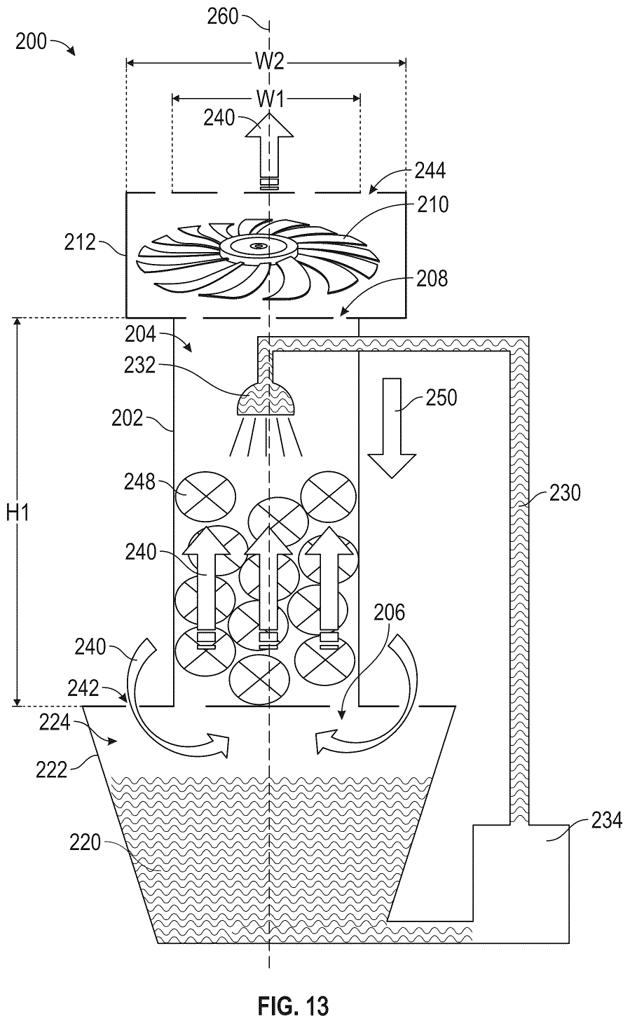

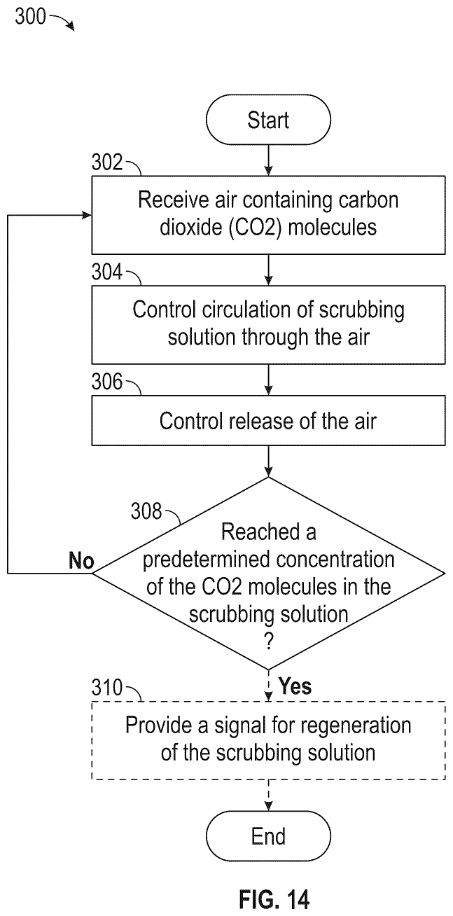

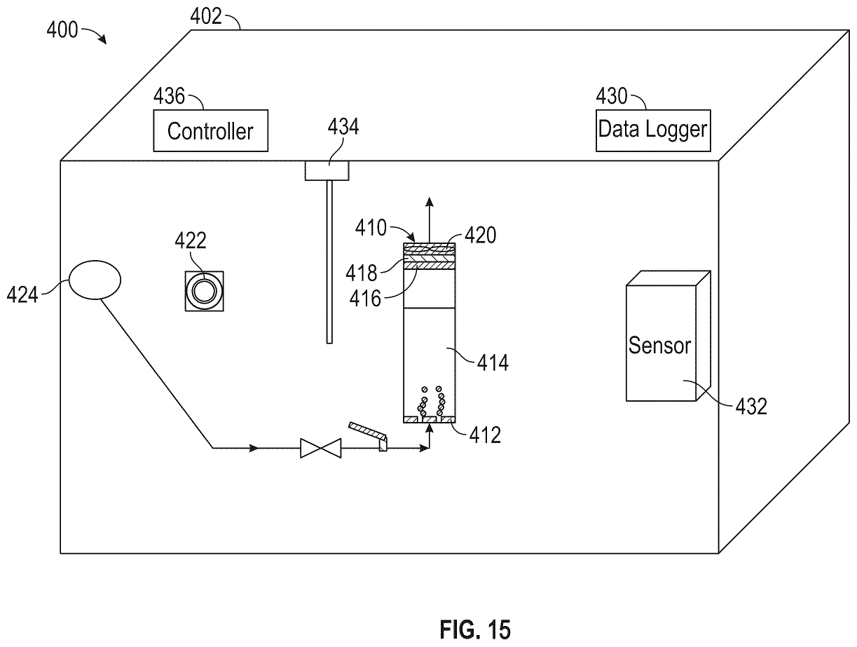

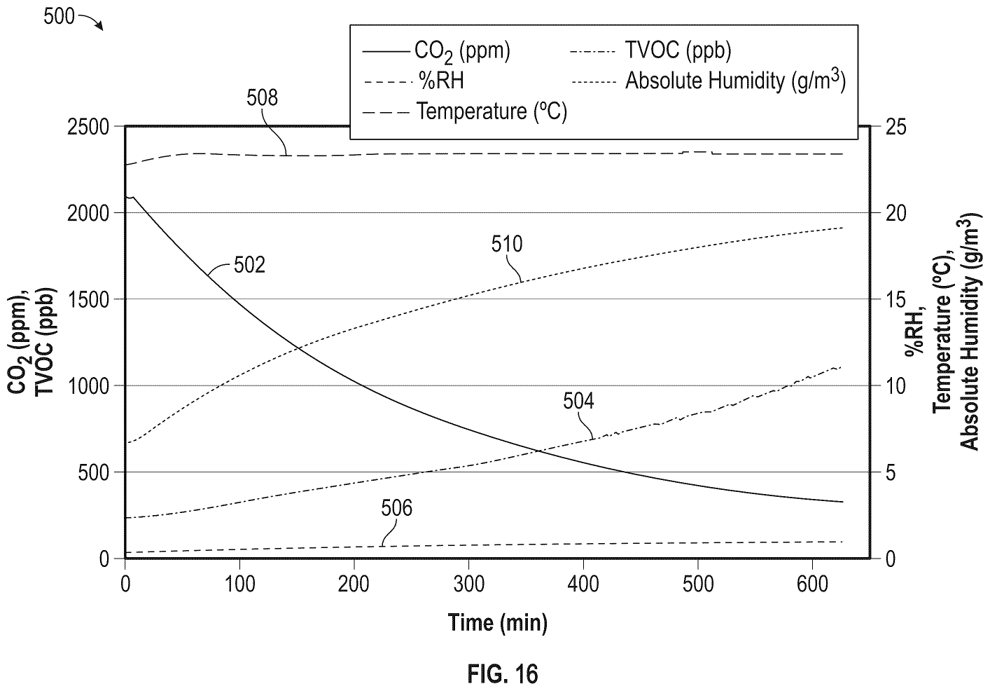

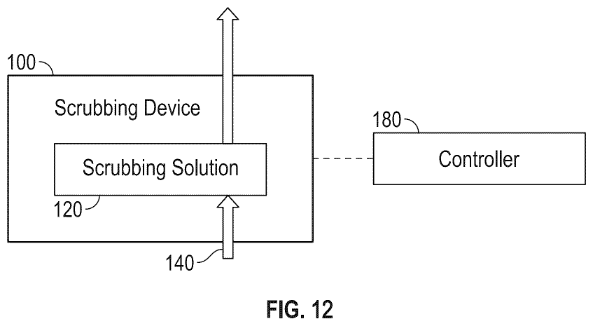

Turning now to FIG. 12, a scrubbing device 100 for reducing a concentration of carbon dioxide (CO₂) molecules in air is illustrated. The scrubbing device 100 can be provided in various environments, including residential homes, office buildings, industrial facilities, enclosed public spaces or other enclosed areas. The scrubbing device 100 can be a standalone unit that may be located in an indoor or enclosed area or an integrated unit for other systems including a heating, ventilation, and air conditioning (HVAC) system, a central air conditioning (A/C) system, or a building/facility-wide airflow system (e.g, a positive air pressure, or positive airflow system, an air handling or air exchange system, a filtration or exhaust system, etc.). When integrated with existing HVAC or A/C systems, the scrubbing device 100 can provide a comprehensive solution for air purification and climate control, for example, by circulating air through the scrubbing device 100 prior to being mixed with outdoor ventilation air. In some cases, the scrubbing device 100 can operate as a standalone unit or as part of a larger system and offer flexibility in addressing specific air quality needs across different types of enclosed spaces. In some cases, the scrubbing device 100 can be provided in facilities with highly concentrated streams of CO₂ molecules, including fossil fuel-based power plants, factories, foundries, mining facilities, agriculture facilities, a biomass plant (e.g., biomass boiler), or the like. Accordingly, the scrubbing device 100 can be thought of as having several purposes: it can be utilized to enhance indoor air quality by reducing various levels of CO₂ concentrations in various context, as well as to scrub exhaust or other air streams vented to the outside.

In particular, the scrubbing device 100 can receive airflow 140 (e.g., a quantity of air, a flow of air, etc.) that includes an initial concentration of CO₂ molecules. The airflow 140 can be treated by the scrubbing device 100 to reduce the concentration of the CO₂ molecules and be released from the scrubbing device 100. In some cases, the treated airflow 140 including the reduced concentration of the CO₂ molecule can be released back into the same environment (e.g., a source of the airflow 140 or a desired indoor space) from which it was drawn, or may be released to another environment (e.g, another room, another conditioned space, outdoors, etc.). In some cases, the treated airflow 140 including the reduced concentration of the CO₂ molecules can be reintroduced into the scrubbing device 100 to further reduce the concentration of the CO₂ molecules. Thus, the scrubbing device 100 can continuously, selectively, or periodically operate to circulate the airflow 140 (e.g., for a predetermined number of cycles) and achieve a desired concentration of the CO₂ molecules for a space. For example, the scrubbing device 100 can maintain a predetermined concentration of the CO₂ molecules within a space or impede accumulation of the CO₂ molecules.

In the illustrated example, a scrubbing solution 120 is provided to absorb CO₂ molecules from air. For example, the scrubbing solution 120 can be located within the scrubbing device 100 and engage with the airflow 140 that passes through the scrubbing device 100. The scrubbing solution 120 can include a CO₂ absorption composition (e.g., as generally discussed above) that absorbs or reduces CO₂ molecules from the airflow 140. Accordingly, the concentration of the CO₂ molecules in the airflow 140 can be decreased after the airflow 140 engages with the scrubbing solution 120. In some examples, the scrubbing device can utilize the carbon dioxide absorption composition as described herein as a CO₂ scrubbing solution. Unless specifically defined otherwise, all variations of the present carbon dioxide absorption composition are suitable for use in the scrubbing device disclosed herein. For example, the scrubbing solution 120 can include a solution of an amino compound in a solvent that includes water and a glycol. In some examples, the scrubbing solution 120 can include various chemical compositions, including amine-based compounds, carbonate solutions, or other formulations capable of binding with CO₂ molecules. The specific composition of the solution can be adjusted to enhance performance based on the intended application and environmental conditions.

In some examples, the scrubbing device 100 can include one or more sensors, including CO₂ sensors, temperature sensors, humidity sensors, pressure sensors, flow rate sensors, pH sensors, Volatile Organic Compound (VOC) sensors, electrochemical sensors, gas sensors, and liquid level sensors. Information from one or more sensors can be used to control one or more aspects of operating the scrubbing device 100. In some embodiments, the operation of the scrubbing device 100 can be controlled via a controller 180. In particular, the controller 180 can monitor or adjust various operational parameters of the scrubbing device 100. The controller 180 can receive information from the one or more sensors of the scrubbing device 100 to provide signals to regulate the operational parameters. In some examples, the operational parameters can include a flow rate of the airflow 140, whether scrubbing solution 120 is being flowed, a flow rate of the scrubbing solution 120, a configuration of the distribution path for the scrubbing solution 120, number of air inlets or air outlets, temperature of the scrubbing device 100, temperature of the scrubbing solution 120, etc. In some examples, when the level of VOCs in the airflow intake reaches a predetermined threshold, the airflow 140 can be passed through a filter (e.g., an activated carbon filter) to absorb excess VOCs from the airflow 140; in alternative examples, the activated carbon filter may always be deployed or deployed based on predetermined or user-defined schedules. In some examples, the controller 180 can interface with external systems, such as building management platforms, to coordinate the device's operation with broader environmental control strategies.

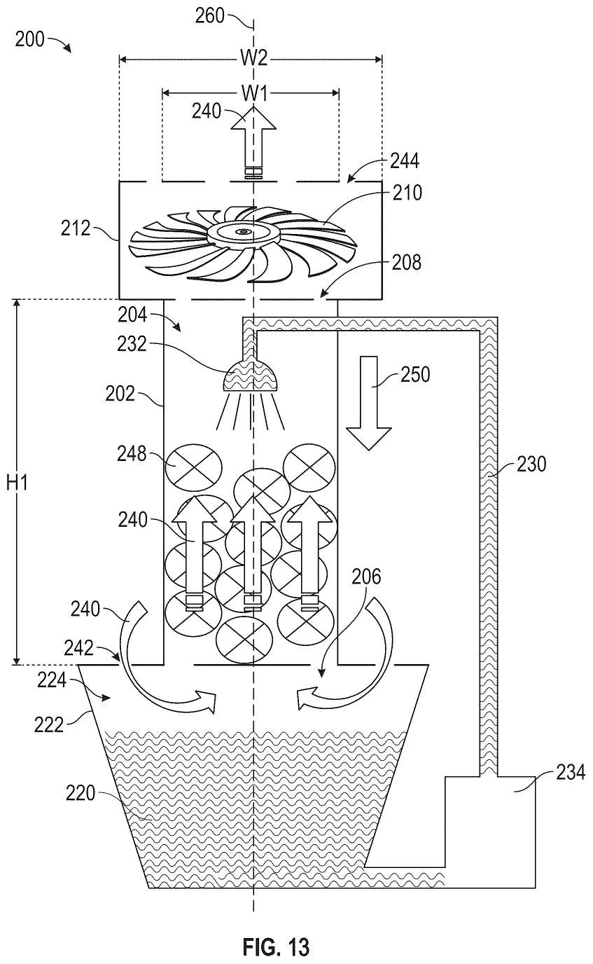

FIG. 13 illustrates an example scrubbing device 200, which is a particular example of the scrubbing device 100 of FIG. 12. To that end, features of the scrubbing device 200 described below include reference numbers that are generally similar to those used in FIG. 12, and discussion above applies to similar named or numbered items below, unless otherwise noted or required. For example, the scrubbing device 200 includes a scrubbing solution 220 and an airflow 240, just as the scrubbing device 100 includes the scrubbing solution 120 and the airflow 140.

In the illustrated example, the scrubbing device 200 includes a column 202, a fan compartment 212, and a reservoir 222 that are in fluid communication with one another. In particular, the reservoir 222 is connected to the column 202, which is connected to the fan compartment 212. The scrubbing device 200 can receive the airflow 240 including an initial concentration of CO₂ molecules and release the airflow 240 (e.g., a treated airflow) including a reduced concentration of the CO₂ molecules. In the illustrated example, the scrubbing device 200 receives the airflow 240 through the reservoir 222 and releases the airflow 240 through the fan compartment 212. The fan compartment 212 houses a fan 210 (e.g., an exhaust fan) that can induce a flow of the airflow 240 through the column 202 and create a draft (e.g., an air current) that circulates the airflow 240 through the scrubbing device 200. In the illustrated example, the airflow 240 generally flows through the column 202 in an upward direction. However, in other examples, the airflow 240 can flow in a different direction, including in a lateral direction or a downward direction.

The reservoir 222 can include an air inlet 242 located near a top portion of the reservoir 222. In some examples, an internal volume 224 of the reservoir 222 can include the scrubbing solution 220 and a headspace that can include the airflow 240. For example, the airflow 240 can enter the reservoir 222 via the air inlet 242 and occupy the headspace above the scrubbing solution 220. In some cases, the airflow 240 can engage with the scrubbing solution 220 within the internal volume 224 prior to flowing to a downstream system of the scrubbing device 200. For example, the CO₂ molecules of the airflow 240 can be absorbed by the scrubbing solution 220 that is accumulated within the reservoir 222. While the illustrated example includes two ports for the air inlet 242, the scrubbing device 200 can include one port for the air inlet 242 or more ports for the air inlet 242 (e.g., three, four, five, etc.). In some examples, the air inlet 242 can be arranged around the reservoir 222 in a linear pattern, an annular pattern, or without a particular pattern. In some cases, the air inlet 242 can be provided on a perforated plate.

Continuing, the scrubbing device 200 circulates the airflow 240 through the column 202 (e.g., to treat the airflow 240). The column 202 includes a channel 204 and is defined by a height H1 and a width W1. The column 202 can include a channel inlet 206 and a channel outlet 208, and the channel 204 can extend between the channel inlet 206 and the channel outlet 208. In the illustrated example, the channel inlet 206 and the channel outlet 208 are located on opposite sides of the column 202, and the channel 204 can extend in a direction parallel to a longitudinal axis 260. Thus, the airflow 240 flow through the channel 204 from the channel inlet 206 to the channel outlet 208 in a direction parallel to the longitudinal axis 260 (e.g., in a first direction). In some cases, the channel inlet 206 and the channel outlet 208 can include openings at a respective distal end of the channel 204. In some cases, the channel inlet 206 can be arranged on the same perforated plate as the air inlet 242 or on a separate plate. In some cases, the air inlet 242 can include the channel inlet 206.

In some cases, the scrubbing solution 220 can be routed into the channel 204 and engage with the airflow 240, as the airflow 240 flows through the channel 204. In particular, a pump 234 can provide a desired level of liquid pressure to transfer the scrubbing solution 220 from the reservoir 222 to a pipe 230 that is connected to an outlet of the pump 234. The pump 234, the reservoir, and the pipe 230 can be in fluid communication with one another. The scrubbing solution 220 that is pressurized by the pump 234 can be routed into the channel 204. For example, a spray nozzle 232 (e.g., a plurality of openings) can be connected to an end of the pipe 230 and spray the scrubbing solution 220 into the channel 204. In the illustrated example, the spray nozzle 232 is positioned near the top of the column 202. Thus, the scrubbing solution 220 can be sprayed downward from the spray nozzle 232, traveling in a liquid flow direction 250 (e.g., a second direction) as indicated by the arrow in FIG. 13. In some embodiments, the scrubbing solution 220 can be flown into the channel 204 along an inner wall of the column 202.

As the scrubbing solution 220 flows downward through the column 202, the scrubbing solution 220 can (directly) engage with the airflow 240 that flows in an upward direction. In some cases, the countercurrent flow configuration of the airflow 240 and the scrubbing solution 220 can increase contact between the airflow 240 and scrubbing solution 220 (e.g., enhancing the absorption process of the CO₂ molecules). In some embodiments, the flow configuration of the airflow 240 and the scrubbing solution 220 can include at least partially countercurrent flow, at least partially concurrent flow, at least partially crossflow, or a flow including other types of flow patterns.

In some cases, the pump 234 can include a variable speed pump that can adjust flow rates based on system demands. The pump 234 may be controlled (e.g., via a controller) to adjust an output of the pump 234 based on information from sensors of the scrubbing device 200, such as CO₂ concentration levels, pressure differentials across the column 202, changes in solution viscosity, etc. In some cases, adaptive control algorithms can be provided to optimize operation of the pump 234 based on historical performance data and changing environmental conditions. In some cases, the pump 234 can include features such as self-priming capabilities, corrosion-resistant materials, or energy-efficient designs to enhance overall system performance. Further, the pump 234 may also include built-in diagnostics and communication capabilities, allowing for remote monitoring and control, predictive maintenance scheduling, and integration with broader building management systems for coordinated operation with other environmental control equipment.

With continued reference to FIG. 13, a plurality of packings 248 (e.g., a plurality of porous structures) is provided within the channel 204. The packings 248 can include various surfaces that provide a high surface area relative to a volume of the packings 248. In some cases, the packings 248 can increase contact between the airflow 240 and the scrubbing solution 220 sprayed via the spray nozzle 232. In some cases, the packings 248 that are (randomly) distributed throughout the column 202 can provide a tortuous path for the descending scrubbing solution 220 and the ascending airflow 240. In some cases, the packings 248 can include porous surfaces (e.g., similar to a sponge) or a matrix, including an outer surface or an inner surface that each engage with the scrubbing solution 220. In some cases, most or an entire surface of the packings 248 can be coated with the scrubbing solution 220.

In particular, as the scrubbing solution 220 flows downward in the liquid flow direction 250, the scrubbing solution 220 can coat the surfaces of the packings 248, forming a liquid film. In some cases, the liquid film can increase an effective surface area for gas-liquid contact, and the airflow 240 travelling upward through the column 202 can engage with the wetted surfaces of the packings 248. Thus, a greater concentration of the CO₂ molecules of the airflow 240 can be absorbed by the scrubbing solution 220 via the packings 248.

In some cases, the packings 248 can include Raschig rings, pall rings, saddle packings, structured packings, balls, wire mesh, or other types of packings. In some cases, materials of the packings 248 can include stainless steel, ceramic, glass, plastic, carbon fiber, titanium, aluminum, copper, etc. In some cases, configurations of the packings 248, including types, sizes, quantities, or materials of the packings 248, can be associated with a desired performance of the scrubbing device 200. For example, the configurations of the packings 248 can be determined based on desired flow rates of the scrubbing solution 220, properties of the scrubbing solution 220 (e.g., inclusion of foaming agents), desired absorption efficiency of CO₂ molecules, etc. Further, the arrangement of the packings 248 within the column 202 can be determined based on a desired overall performance of the scrubbing device 200. In some examples, the packings 248 can be arranged in structured patterns or layers, for example, to optimize flow distribution and minimize channeling effects. Alternatively, the packings 248 can be arranged in a random pattern to create more turbulent flow patterns (e.g., to enhance mixing between the scrubbing solution 220 and the airflow 240).

As shown in FIG. 13, the column 202 includes a rectangular cross-section (e.g., taken in a direction parallel to the longitudinal axis 260). In some examples, the column 202 can include differently shaped cross-sections, including a triangular cross-section, circular cross-section, hexagonal cross-section, octagonal cross-section, elliptical cross-section, or other polygonal cross-section. While the illustrated example includes the column 202 that is generally symmetrical about the longitudinal axis 260, other examples need not include a column that is generally symmetrical about the longitudinal axis 260. For example, a shape of a column may be asymmetrical about the longitudinal axis 260. In some cases, the shape of the column 202 can be associated with a flow pattern of the airflow 240 or the scrubbing solution 220.

Further, one or more dimensions, including the height H1, the width W1, a depth, or a diameter of the column 202 can be adjusted (e.g., increased or decreased). By varying these dimensions in different combinations, the overall shape of the column 202 can be modified or a volume of the column 202 can be modified, for example, based on specific application requirements or space constraints. In some cases, shapes of the column 202 can be associated with specific flow characteristics, gas-liquid contact efficiency, pressure differential within channel 204, configurations of the packings 248, or space constraints in different applications. In some cases, the shape of the column 202 can be adjusted to enhance mass transfer, minimize channeling effects, or accommodate particular installation requirements (e.g., based on available space or a type of application).

With continued reference to FIG. 13, the scrubbing device 200 can release the airflow 240 that is treated with the scrubbing solution 220 (e.g., thus having a reduced concentration of the CO₂ molecules) from the channel 204. In particular, the fan compartment 212 can include an air outlet 244, and the airflow 240 can adjustably or selectively flow through the fan 210 from the channel outlet 208 to the air outlet 244. While the illustrated example shows the air outlet 244 that is located at a top portion of the fan compartment 212, other examples can include one or more air outlets that are additionally or alternatively provided on different sides of the fan compartment 212 (e.g., lateral sides, lower sides, edges, etc.). Further, the illustrated example includes the fan compartment 212 that is defined by a width W2 greater than the width W1. However, in other examples, the width W2 can be smaller than the width W1 or substantially equal to the width W1. Further, the shape of the fan compartment 212 can be associated with the shape of the fan 210.

In some embodiments, the fan 210 can include a variable speed fan that can adjust a rotational speed of the fan 210, which can control the flow rate of the airflow 240 through the scrubbing device 200. In some cases, the speed of the fan 210 can be adjusted based on various factors, including the desired CO₂ removal rate, the concentration of CO₂ in the incoming air, or the overall system efficiency. In some cases, the speed of the fan 210 can be controlled based on input from various sensors in the scrubbing device 200. For example, the speed of the fan 210 can be increased or decreased in response to CO₂ concentration measurements, pressure differentials across the column, changes in humidity levels, etc. In some cases, a controller (e.g., similar to the controller 180) can be provided to implement adaptive control algorithms that optimize fan operation (e.g., based on historical performance data or changing environmental conditions).

In some embodiments, the fan 210 can include different types of fans, including a centrifugal fan, an axial fan, a radial fan, etc. In some embodiments, a plurality of fans (e.g., two, three, four, five, etc. fans) can be arranged in series or parallel configurations, for example, to achieve desired airflow characteristics or to provide redundancy. In some embodiments, the scrubbing device 200 can include a plurality of fans (e.g., multiple small fans instead of a single large fan). In some cases, the plurality of fans can be oriented in the same directions or different directions. In some cases, the plurality of fans can be individually controlled to create specific airflow patterns or to compensate for variations in CO₂ concentration across different sections of the column 202.

Further, in some embodiments, the fan 210 can include adjustable blade angles or variable pitch blades. Accordingly, the airflow characteristics of the fan 210 can be adjusted without changing the rotational speed of the fan 210. Therefore, various configurations of the fan blades can provide additional flexibility in managing airflow patterns and pressure distributions within the scrubbing device 200. Further, the fan compartment 212 can include sound-dampening materials or features to reduce noise levels during operation of the scrubbing device 200. In some cases, the fan compartment 212 can include airflow straighteners or guide vanes to optimize air distribution and reduce turbulence as the treated air exits the scrubbing device 200.

In some embodiments, the scrubbing device 200 can include a secondary absorption element for absorbing CO₂ molecules or undesired molecules from the airflow 240. For example, the secondary absorption element can include a carbon filter. In some cases, the carbon filter can be located within the channel 204 along the inner wall of the column 202. In some cases, activating the carbon filter can reduce TVOCs.

In some embodiments, a photocatalytic oxidation (PCO) unit or a photo-electrochemical oxidation (PECO) unit can be connected to the scrubbing device 200. In some configurations, the PCO or PECO unit can be a stand-alone unit or a part of a HVAC system or a central A/C system. In some configurations, the PCO or PECO unit can provide indoor air disinfection or detoxication system. For example, the PCO or PECO unit can destroy viruses, bacteria, mold, or other VOCs as the airflow 240 passes through the PCO or PECIO unit. In particular, the PCO unit can include a surface with a photocatalyst (e.g., a filter with the photocatalyst) and a light source that includes a bandgap wavelength that is substantially similar to a wavelength of the photocatalyst. In some cases, the photocatalyst can be TiO₂ or TiO₂-based. The light source provide a light that is UV-A (e.g., with a wavelength between 320 nm and 400 nm) or a visible light. In some implementations, the PCO or PECO unit can purify the airflow 240 before, during, or after the CO₂ absorption process via the scrubbing device 200. For example, in some configurations, the PCO or PECO unit can be arranged upstream of the scrubbing device 200, such that microbes or VOCs that are oxidized to CO₂, H₂O, HCl, or other molecules can be provided to the scrubbing device 200. In some configurations, the PCO or PECO unit can be arranged upstream of the scrubbing device 200, such that the scrubbing device 200 can absorb the CO₂ molecules produced by a photocatalytic reaction.

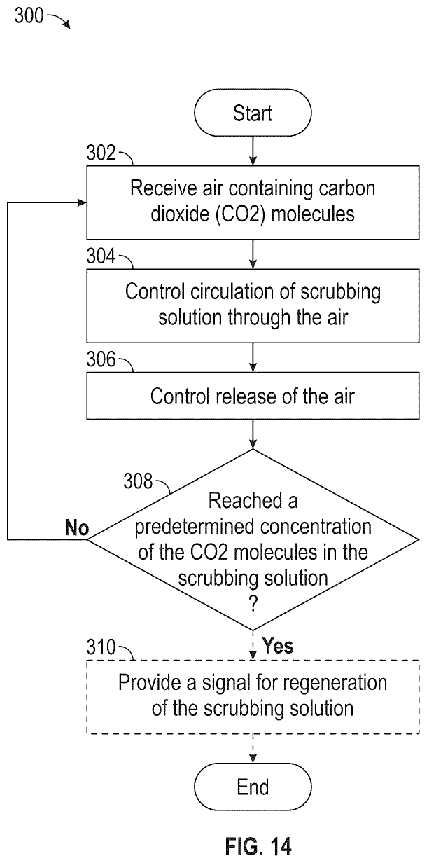

FIG. 14 is a flowchart illustrating a method 300 for capturing and regenerating CO₂ molecules from air using a scrubbing device such as the scrubbing device 100 and the scrubbing device 200, although other types of scrubbing devices can be used.

At block 302, air containing an initial concentration of CO₂ molecules can be received. For example, with reference to FIG. 13, the airflow 240 can enter the scrubbing device 200 via the air inlet 242. The fan 210 within the fan compartment 212 can provide an air current, such that the airflow 240 from a space external to the scrubbing device 200 can be sucked into the scrubbing device 200.

At block 304, circulation of a scrubbing solution can be controlled. For example, the scrubbing solution can be circulated through the air containing the initial concentration of the CO₂ molecules. With reference to FIG. 13, the pump 234 can be powered to supply a flow of pressurized scrubbing solution 220 into the channel 204 that includes the air containing the CO₂ molecules. In particular, the scrubbing solution 220 that is pressurized can be sprayed into the channel 204 and flow in the liquid flow direction 250 through the packings 248. The airflow 240 can continue to travel in a direction that is opposite of the liquid flow direction 250 (e.g., as induced by the fan 210) and engage with the scrubbing solution 220 that includes compounds that absorb the CO₂ molecules from the airflow 240. In some cases, the packings 248 (e.g., Raschig rings) can increase the air-liquid contact area to enhance the absorption rate of the CO₂ molecules. Therefore, the engagement between the airflow 240 and the scrubbing solution 220 can reduce the concentration of the CO₂ molecules in the airflow 240.

At block 306, release of the air including the reduced concentration of the CO₂ molecules can be controlled. For example, with reference to FIG. 13, the fan 210 can continue to induce the airflow 240 to flow through the channel 204 and pull the airflow 240 through the fan 210 and out of the scrubbing device 200 via the air outlet 244. Thus, the air in a space, which can include a relatively higher concentration of the CO₂ molecules, can be replaced with the treated air that includes a reduced concentration of the CO₂ molecules.

At block 308, whether a predetermined concentration of the CO₂ molecules in a scrubbing solution has been reached can be determined. If the scrubbing solution does not include the predetermined concentration of the CO₂ molecules, then the scrubbing device (e.g., the scrubbing device 200) can continue to receive air from the environment to provide air with reduced concentration of the CO₂ molecules. Thus, the block 302, the block 304, the block 306, and the block 308 can be repeated until the scrubbing solution includes a predetermined concentration of the CO₂ molecules.

In contrast, if the scrubbing solution (e.g., the scrubbing solution 220) includes the predetermined concentration of the CO₂ molecules, then a signal can be provided at block 310 (e.g., by the scrubbing device 200, a controller, or an indicator) for regeneration of the scrubbing solution. In some cases, the signal for regeneration can be provided based on a rate of CO₂ absorption or the concentration of the CO₂ molecules in the scrubbing solution 220 relative to the inlet air. For example, a first gas sensor or electrochemical sensor may be disposed near an airflow intake to detect CO₂ level of untreated air, and a second sensor may be disposed near an outflow to detect CO₂ levels of treated air. A controller may monitor the difference between the sensors' respective outputs, and may generate an alert or notification signal if the degree of CO₂ being removed from the air decreases by a given amount or reaches a given minimal level. The alert or notification signal can be utilized to shut off the flow of scrubbing solution 220, to turn on a notification light, or otherwise indicate or communicate to a user that the scrubbing solution should be regenerated or replaced. In other embodiments, the controller may monitor to determine whether the amount of CO₂ in the intake airflow is low enough that the scrubbing solution can be turned off, or to scale the differential of CO₂ removal according to the intake amount.

With reference to FIG. 13, when the scrubbing solution 220 becomes saturated or beings to exhibit a reduced capability of absorbing CO₂, a regeneration step may take place. In some embodiments, the regeneration step may be done automatically by the system or device that controls scrubbing solution flow or may be performed by an external user or system (e.g., a tank of scrubbing solution may be removed and replaced). To regenerate, the scrubbing solution 220 can be heated to desorb the CO₂ molecules from the scrubbing solution 220. In particular, the scrubbing device 200 can include one or more actuators that close (or seal) the reservoir 222, such that the scrubbing solution 220 can be isolated from other components (e.g., the column 202) of the scrubbing device 200. The reservoir 222 can be removed from the scrubbing device 200, or the scrubbing solution 220 can be removed from the reservoir 222. Heat can be applied to the scrubbing solution 220 for regeneration. In some examples, the scrubbing solution 220 can be placed in a microwave oven that can apply electromagnetic radiation to regenerate the scrubbing solution 220. In some examples, the scrubbing solution 220 can be heated on a hot plate. In some examples, the scrubbing solution 220 can be regenerated within the scrubbing device 200 (e.g., via a integrated heater).

The regenerated scrubbing solution can be reused for the CO₂ molecule absorption process, for example, to execute the block 304. In some cases, the desorbed CO₂ molecules can be collected (e.g., in a container or by being routed to a designated location) and be used for further use. For example, the collected CO₂ molecules can be used as a mineral water, jet fuel, etc.

Throughout the method 300, sensors measuring parameters, such as CO₂ concentration or humidity, can be used to provide feedback for automated flow adjustment. Various components of the scrubbing device, such as the pump 234 or the fan 210 of the scrubbing device 200, can be controlled according to the demand of the scrubbing device. 200.

### EXAMPLES

This study explores the potential of various CO₂ capture solutions, including aqueous MEA, aqueous Arg, and water-glycol-Arg solutions, to enhance indoor air quality by regulating CO₂ levels, RH, and TVOC concentrations. Through experimental evaluations, the solutions' desorption capabilities, including regeneration efficiency, solvent stability, and visual integrity post-desorption, were analyzed using microwave irradiation at varying exposure times. A subsequent cyclic study was performed to assess the stability, safety, and long-term performance of aqueous MEA and water-PG-Arg solutions. This investigation advances our understanding of CO₂ capture kinetics and positions Arg as a promising, sustainable alternative to traditional absorbents like MEA.

### Example 1

### Materials and Methods

### Reagents

MEA (purity≥98%), L-arginine (purity≥98%), triethylene glycol (purity≥98%), dipropylene glycol (purity≥99%), diethylene glycol (purity≥99%), and ethylene glycol (purity≥99%) were procured from ThermoFisher Scientific. Propylene glycol (purity≥99.8%) was sourced from Millipore Sigma. All the solutions were prepared using Milli-Q water, and the CO₂ gas (purity≥99.999 mol %) was obtained from the Airgas company.

### Experimental Setup and Procedure

The CO₂ scrubbing solutions (CSS) were formulated by adding 0.05 mol of CSA to 50 mL of solvent. For the aqueous CSS, Milli-Q water was used as the solvent, while the water-glycol-based CSS was prepared by mixing water and glycol in a 1:1 volumetric ratio based on the solubility of Arg in water.

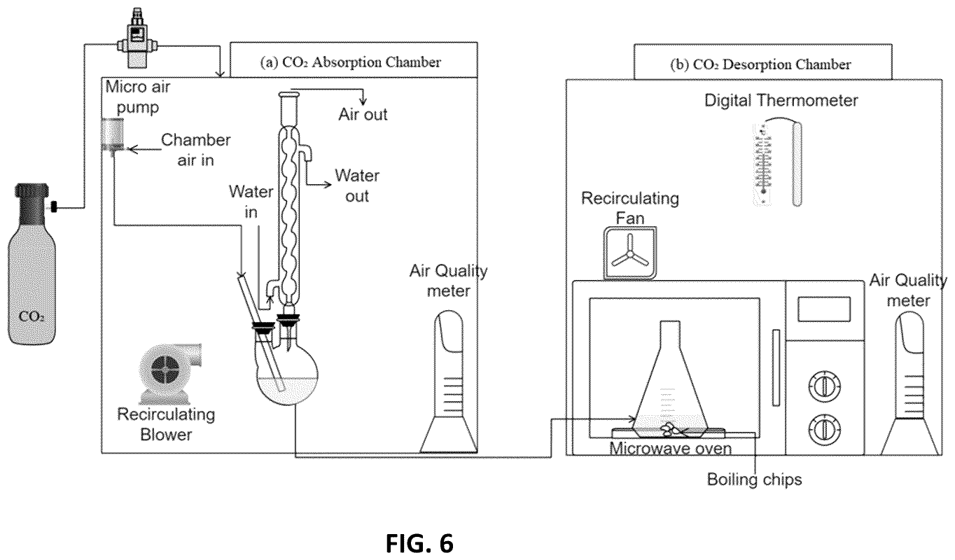

The CO₂ absorption setup consisted of a 100 mL two-neck round-bottom flask filled with the prepared CSS and connected to a condenser to minimize the loss of water and amine vapors. This setup was placed inside a sealed steel chamber measuring 32×33×36 inches (FIG. 6), equipped with a 12 V fan to ensure thorough mixing of air within. CO₂ was introduced from the top of the chamber until the concentration stabilized between 1000 and 1100 ppm.

The air inside was bubbled through the solution using a micro air pump during the CO₂ absorption process. The experiments were performed under laboratory conditions at atmospheric pressure, with an initial relative humidity of 54±5%. Changes in C_{CO}_{₂} (ppm), RH (%), and TVOCs (ppb) were continuously monitored using Graywolf IQ-610 sensors and logged at 30-second intervals with an advanced sense meter. As per the guidelines from Graywolf Sensing Solutions, the TVOC sensor operates accurately within a relative humidity (RH) range of 0 to 90%, becoming unreliable beyond this threshold. Consequently, in our study, TVOC data were recorded until the RH reached 90%. The VOCs generated inside the chamber were collected by passing the air through 20 mL of Milli-Q water for 60 minutes.

The resulting solution (referred to as the TVOC solution) was analyzed using Triple Quadrupole Liquid Chromatography-Mass Spectrometry (LC-QqQ-MS) and Headspace Solid-Phase Microextraction Gas Chromatography-Mass Spectrometry (HS-SPME-GC-MS).

Specifically, Agilent Technologies 1260 infinity LC system coupled with Agilent Technologies 6460 Triple Quad LC/MS (LC-MS/MS) was used and molecules were ionized using an Electrospray Ionization (ESI) source. GC-MS analysis was conducted on an Agilent 7890B gas chromatograph coupled with an Agilent 5977B Mass Selective Detector, utilizing Electronic Impact (EI) for ionization and fragmentation. Mode for qualitative analysis of LC-QqQ-MS: MS2 scan (i.e., Full scan). Mode for quantitative analysis of LC-QqQ-MS: MRM scan (i.e., Multiple reaction monitoring)].

In some studies, the absorption setup included a charcoal canister. For all the absorption experiments, the charcoal canister was excluded to independently assess each solution's performance. It was integrated into the system only after optimizing and selecting the best solution.

Once the CO₂ absorption process was complete, water was added to replenish the solution that had evaporated due to vaporization. The solution was then transferred to a 500 mL conical flask, and a few small porcelain boiling chips were added to ensure smooth boiling and prevent bumping during the regeneration process. MW-assisted regeneration of the saturated scrubbing solution was performed. Initially, the temperature of the solution, along with the CCO₂, RH, and TVOC values, were recorded. The solution was then heated using a Panasonic 1200 W MW oven at heating power level 10 for varying time periods. The temperature and volume of the solution were recorded right after heating, whereas other parameters, such as TVOC and RH, were measured five minutes later after they had stabilized. Rather than using one prolonged MW heating duration, the desorption process was broken into shorter sessions to ensure that the solution did not dry out completely.

In an alternative desorption setup, conventional thermal heating was used. Once the solution was loaded with CO₂, water was added to replenish the volume lost due to vaporization. It was then transferred into a 100 ml three-neck round-bottom flask, with a condenser connected to the middle arm, a glass sparger on the left arm, and a thermometer on the right arm. First, the sand was preheated for 30 minutes by allowing it to stay on the hot plate at 2500 C. Then, the initial temperature of the sand and solution was noted, the two-neck round bottom flask was placed on it, and the chamber door was closed. Initial reading of CO₂, RH, and TVOC was also recorded, and the micropump was turned on. This desorption experiment was continued until the CO₂ concentration curves plateaued over a period of time. At this point, the final reading of the above-mentioned parameters was recorded, and the chamber was opened to note the final temperatures of the solution and the sand bath, thereby concluding the desorption process.

Energy consumption during the desorption process was measured using a P3 Kill-A-Watt meter, connected between the main power supply and the hot plate and microwave. For the micro air pump, energy use was calculated based on the voltage and current from the DC power supply, and the operation duration. The total energy consumed by each equipment was documented.

### Quantitative Analysis and Kinetics

The CO₂ loading (α_{abs}) is defined as the moles of CO₂ absorbed per unit moles of CSA, while the CO₂ unloading (α_{des}) represents the reverse process (Song et al., 2012). These values were calculated using the following formula based on the initial and final CO₂ concentrations.

$${CO}_{2} loading / removed ( α ) = \frac{Moles of {CO}_{2} absorbed / desorbed}{Moles of {CO}_{2} scrubbing agent} ( mol )$$

$$Moles of {CO}_{2} Abs . / Des . ( {n}_{{co}_{2}} ) = \frac{ΔC}{1000000} \times \frac{1}{{M}_{{CO}_{2}}} \times {ρ}_{{CO}_{2}} \times 1000 \times {V}_{c} ( mol )$$

$$ΔC = Initial Conc . of {CO}_{2} ( ppm ) - Final Conc . of {CO}_{2} ( ppm )$$

$$Moles of {CO}_{2} scrubbing agent = \frac{Mass}{Molecular weight} ( mol )$$

Where ΔC is the concentration gradient, M_{CO}_{₂}=44 g/mol and ρ_{CO}_{₂}=1.96×10⁻³ g/ml are the molecular weight and density of CO₂, respectively, and V_{c}=623 liter is the chamber volume. The amount of CO₂ absorbed or desorbed (in mg) depends on the moles of CO₂ absorbed or desorbed (n_{CO}_{₂}) and can be calculated using the following formula:

$$Amount of {CO}_{2} abs . / des . = {n}_{{CO}_{2}} \times {M}_{{CO}_{2}} \times 1000 ( mg )$$

Additionally, based on the CO₂ absorption experimental data, the integrated rate law equation for a second-order reaction was used to model the kinetics of gas-liquid absorption reactions. The reaction rate constant (K″) was determined from the slope of the linear regression plot of 1/C_{CO}_{₂} versus time.

### Results and Discussion

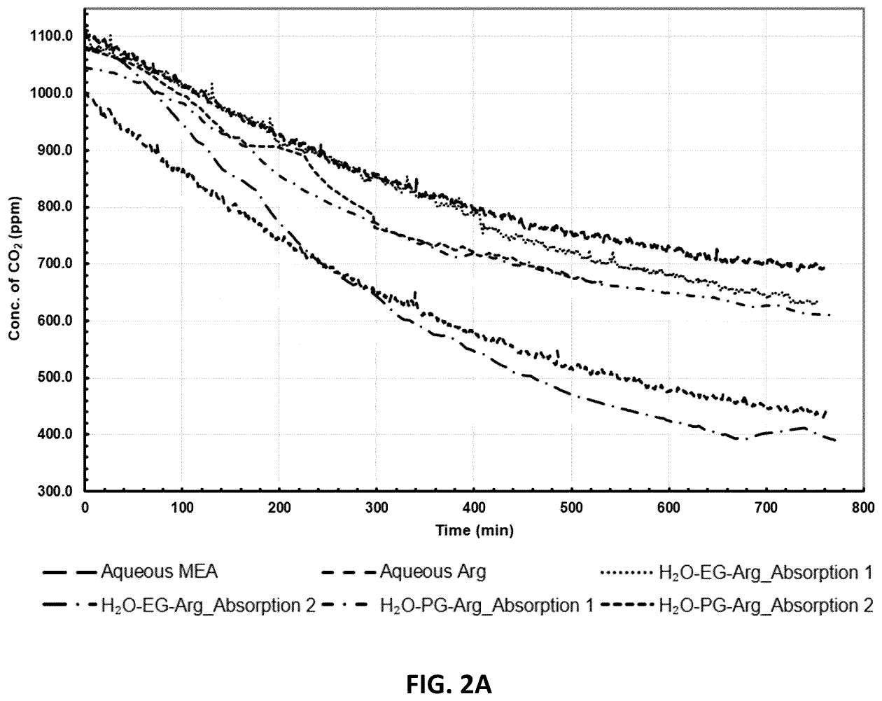

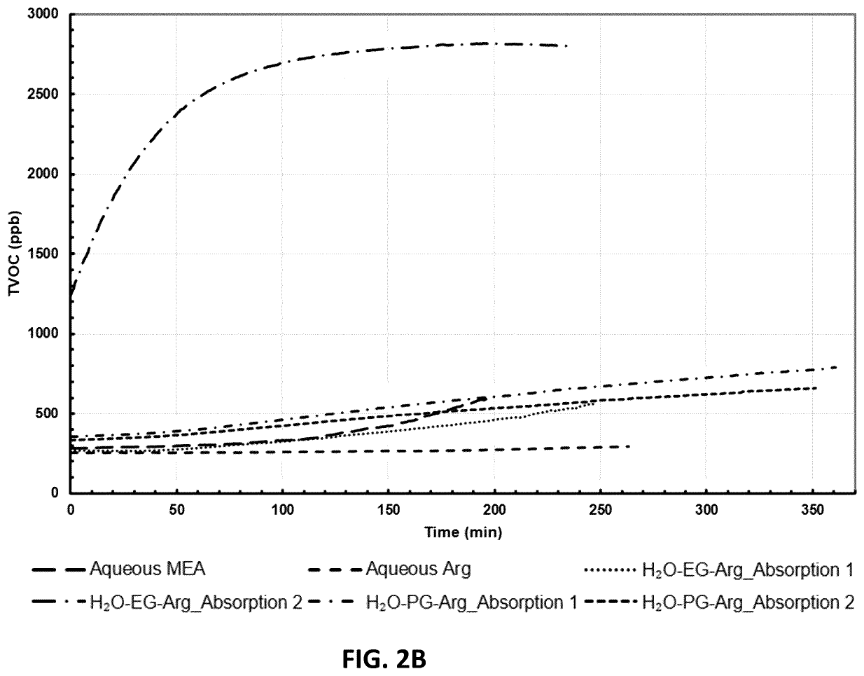

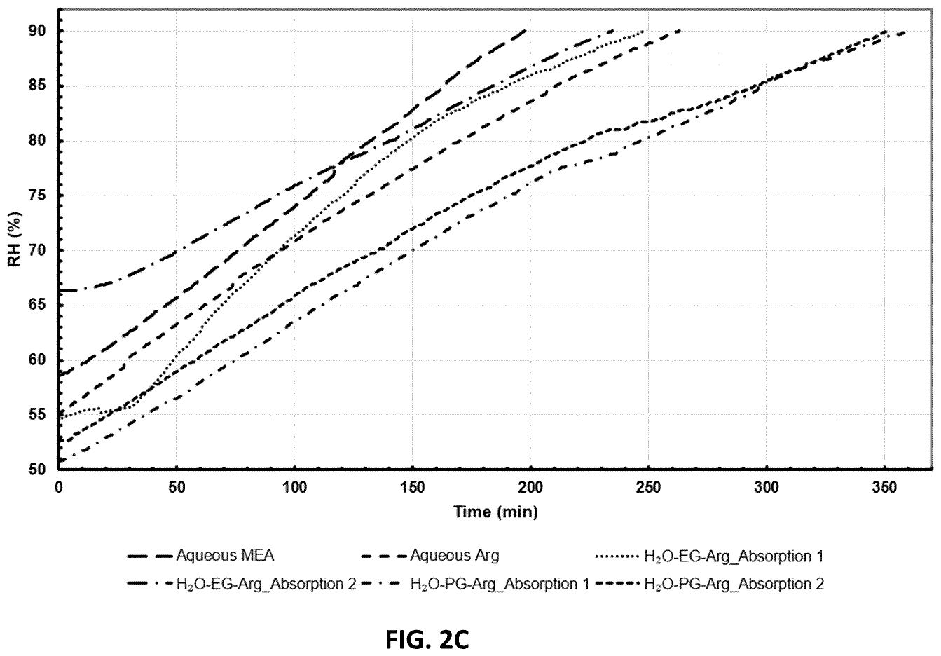

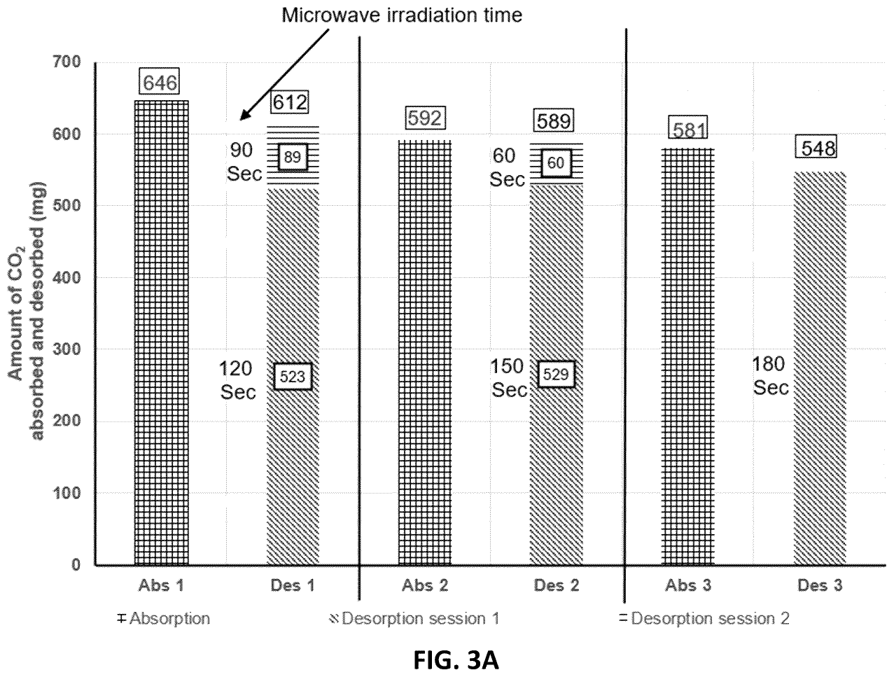

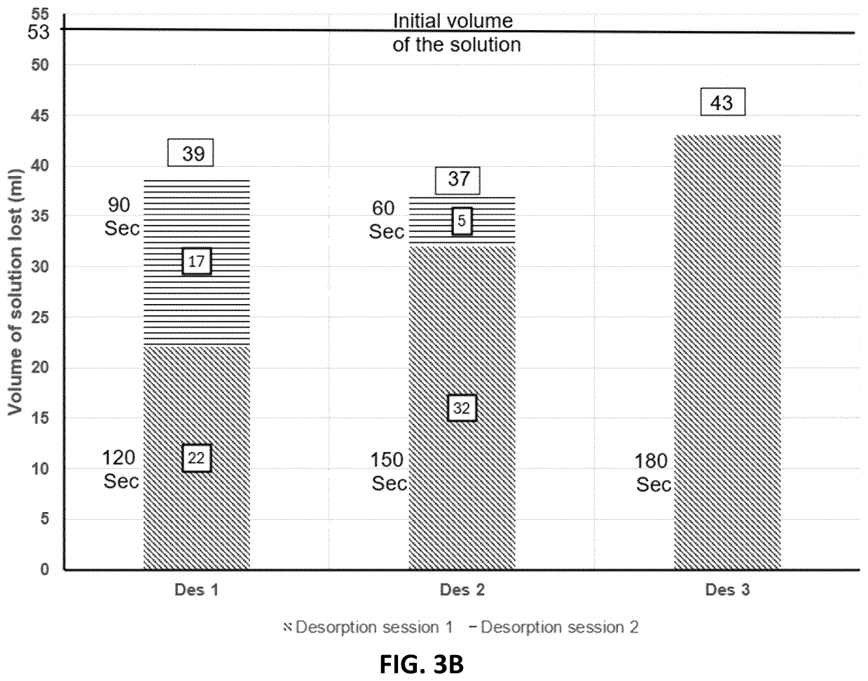

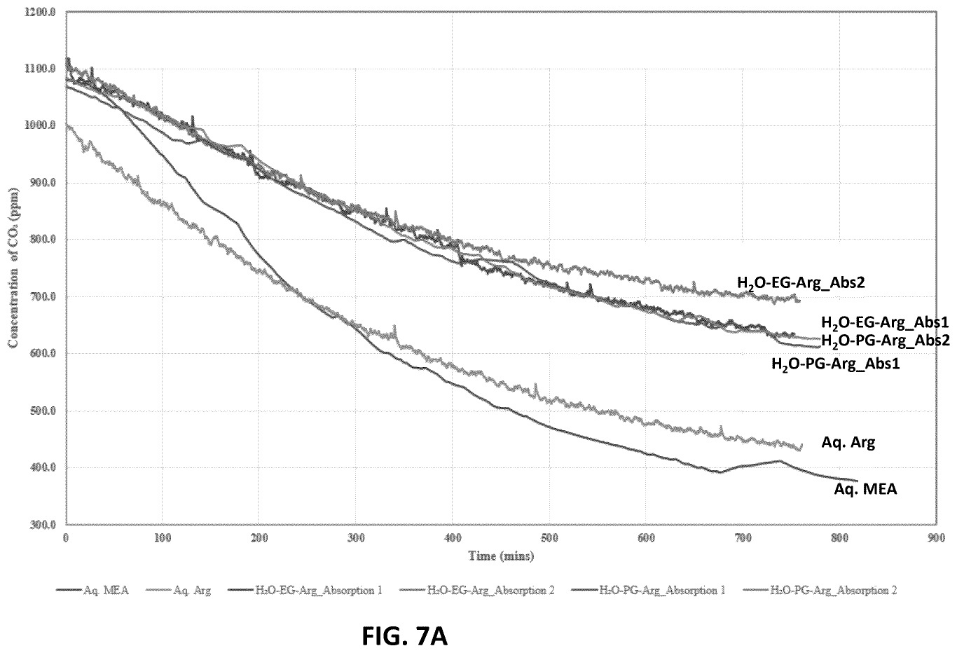

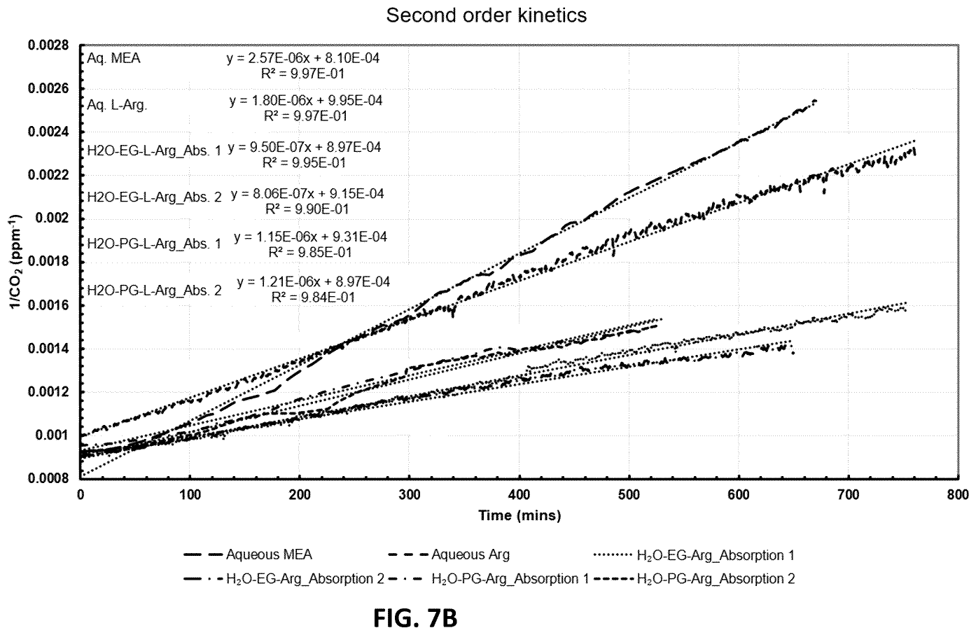

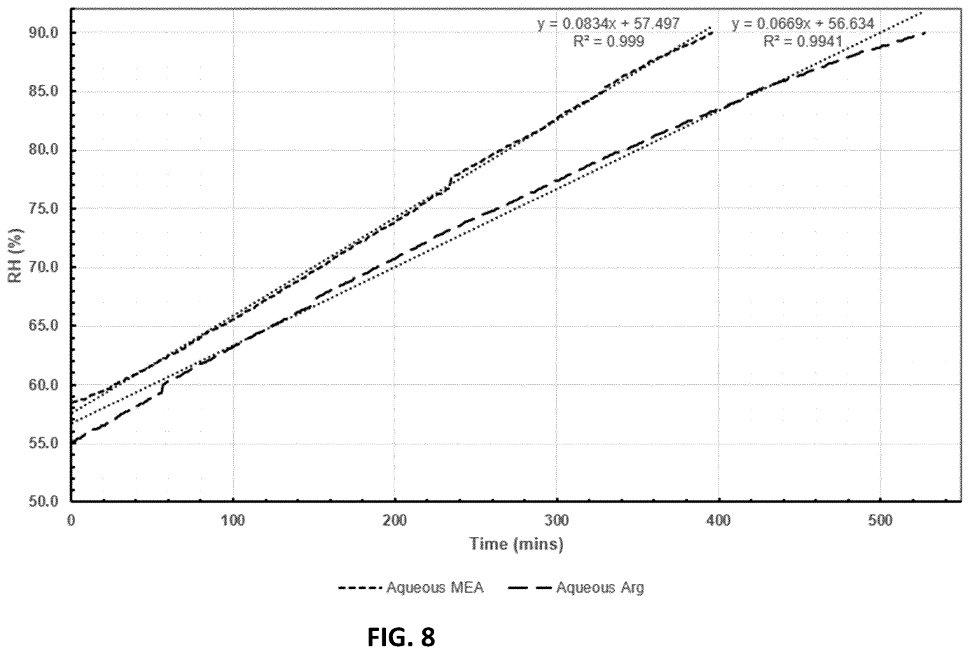

The performances of aqueous MEA and aqueous Arg solutions in terms of CO₂ absorption, kinetics, and their impact on RH levels and TVOC concentrations were evaluated. Although the aqueous Arg solution showed a lower capacity for CO₂ absorption (α=0.31 mol/mol) and slower kinetics (K″=1.80×10⁻⁶ ppm-1 min⁻¹) compared to the aqueous MEA solution (α=0.40 mol/mol and K″=2.57×10⁻⁶ ppm-1 min⁻¹) (FIG. 2A and FIG. 7B), presumably due to Arg's larger molecular size (Suleman et al., 2020) affecting solution viscosity and hindering CO₂ diffusion, it still presents notable advantages over MEA, particularly concerning VOC emissions and RH behavior. The aqueous MEA solution caused a significant increase in TVOC levels during the absorption process, as shown in FIG. 2B, whereas the aqueous Arg solution produced minimal to no detectable rise in TVOCs. Qualitative analysis of the VOCs emitted from the aqueous MEA solution using LC-QqQ-MS identified MEA as the primary volatile component, as its higher vapor pressure likely contributed to elevated TVOC levels, highlighting a potential drawback of using MEA for CO₂ absorption. In contrast, the aqueous Arg solution demonstrated lower vapor pressure, as evidenced by the RH profiles. Analysis of the RH slopes revealed that the Arg solution took longer to reach 90% RH compared to the MEA solution, indicating a lower vaporization rate (FIG. 8). These findings indicate that, while the aqueous Arg solution has slightly lower CO₂ absorption capacity and slower kinetics, it is a more environmentally sustainable option due to its minimal VOC emissions, especially indoors. To further evaluate the practical application of these solutions, MW regeneration experiments were conducted to assess their sustainability for continuous absorption-desorption cycles.

Microwave heating was employed for CO₂ desorption due to its faster process, lower energy consumption, and simpler setup compared to conventional heating. The irradiation process was optimized to achieve full solution regeneration with minimal microwave irradiation time and solvent loss; to this end, a series of absorption-desorption studies were conducted using aqueous MEA solutions. The first MW irradiation time was adjusted by careful inspection of the solution during the MW session to avoid excessive boiling and bumping of the solution inside the MW chamber, while achieving maximum CO₂ desorption possible. As shown in FIGS. 3A and 3B, it was observed that increasing the first MW session beyond 150 secs led to excessive solvent loss and worse CO₂ desorption outcome. The optimum MW irradiation profile was found to be an initial MW session of 150 secs followed by another session of 60 seconds, achieving near-complete regeneration by desorbing 589 mg (99.5%) of CO₂ from 592 mg absorbed, while limiting solvent loss to just 37 ml.

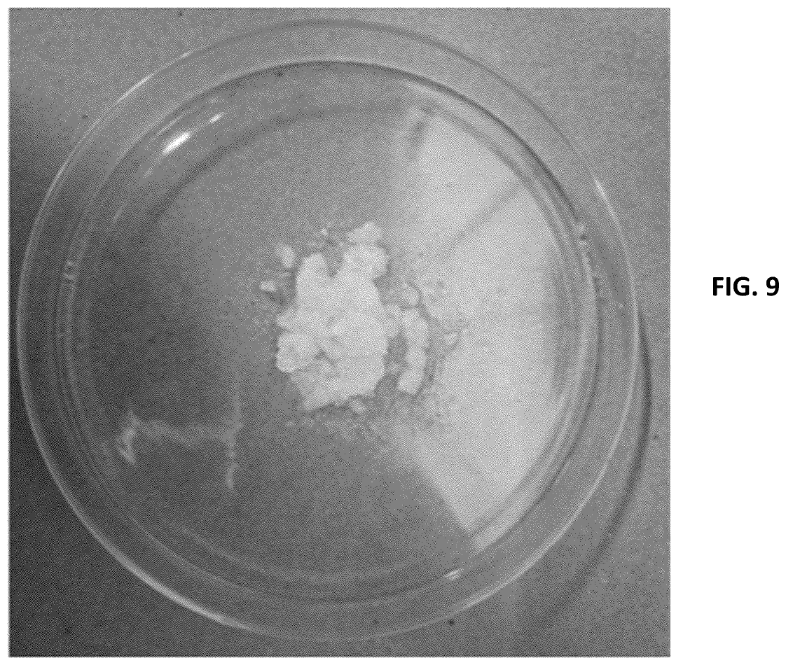

While the optimal MW irradiation times of 150 sec for the first session and 60 sec for the second session were effective for aqueous MEA, they proved insufficient for aqueous Arg solution. Only 436 mg (63.5%) of CO₂ was desorbed from the 687 mg absorbed in the first session. Extending the second session to 90 seconds released an additional 82 mg, totaling 518 mg (75.4%), showing that the desorption remained incomplete. Prolonged MW irradiation also caused complete solvent evaporation, leaving behind solid Arg crystals, as shown in FIG. 9. To address this issue and maintain the solution in liquid form, a water-glycol-based Arg solution was formulated.

The choice of glycol with a higher boiling point was intended to manage the RH during the absorption process in view of its hygroscopic properties and to reduce complete evaporation of the solution during the desorption process. To formulate the water-glycol-based CSS, water and glycol were mixed in an optimized 1:1 volumetric ratio. A comprehensive evaluation of some commonly used glycol compounds was conducted, focusing on key properties such as low vapor pressure, appropriate viscosity, and high molecular weight, as shown in Table 2. Among these, the water-EG-Arg and water-PG-Arg solutions exhibited better Arg solubility and were thus chosen for further studies. Although pure glycol-Arg solutions were initially explored, they exhibited poor solubility of Arg in glycol and resulted in high viscosity of the solution, which hindered CO₂ diffusion. Consequently, water was incorporated to enhance both the absorption performance and kinetics of the solution.

As illustrated in FIGS. 7A and 7B, the presence of glycol in the solution slowed the diffusion of CO₂ from the gas to the liquid phase, reducing both the amount of CO₂ absorbed and its reaction kinetics.

While the water-PG-Arg solution initially showed slightly lower CO₂ absorption capacity (α=0.24 mol/mol, K″=1.15×10⁻⁶ ppm-1 min⁻¹) than the water-EG-Arg solution (α=0.26 mol/mol, K″=0.95×10⁻⁶ ppm-1 min⁻¹) (Table 1), it exhibited comparable kinetics and offered better RH control, taking longer to reach 90% RH during absorption (FIGS. 2A-2C). Qualitative analysis using LC-QqQ-MS and HS-SPME-GC-MS identified only propylene glycol among the emitted VOCs, with no trace of Arg in the case of water-PG-Arg solution. It is worth mentioning that PG, as a VOC, is odorless, non-toxic, and has a Workplace Environmental Exposure Limit (WEEL) of 3200 ppb, averaged over an 8-hour work shift, as set by the American Industrial Hygiene Association (AIHA) (New Jersey Department of Health, 2009). This limit is at least five times higher than the levels detected in our experiment. During desorption, the water-PG-Arg solution achieved ˜90% regeneration in a shorter time, reducing energy consumption by 29% (Table 3). Additionally, no visible color change was observed in the water-PG-Arg solution after the first desorption process, whereas the water-EG-Arg solution exhibited a shift from transparent to amber, indicating possible degradation.

TABLE 1
CO₂ absorption and reaction kinetics of aqueous MEA and aqueous Arg
solutions. Rate Constant (K″) is based on second-order kinetics.

| | Amt. of | Rate constant | | Initial TVOC | Final TVOC |
|---|---|---|---|---|---|
| | CO₂ abs. | K″ × 10⁻⁶ | CO₂ abs. | at RH 54 ± | at RH 90% |
| Solution | (mg) | (ppm⁻¹min⁻¹) | time (min) | 5% (ppb) | (ppb) |
| H₂O (50 ml) + MEA (3 g) | 860 | 2.57 | 819 | 285 | 601 |
| H₂O (50 ml) + Arg (8.71 g) | 687 | 1.80 | 752 | 255 | 293 |
| H₂O (25 ml) + EG (25 ml) + | 582 | 0.95 | 754 | 269 | 562 |
| Arg (8.71 g) | | | | | |
| H₂O (25 ml) + PG (25 ml) + | 531 | 1.15 | 771 | 358 | 789 |
| Arg (8.71 g) | | | | | |

TABLE 2
Summary table of properties of glycols solvents.

| | | Molecular | | Dynamic |
|---|---|---|---|---|
| | Boiling point | weight | Vapor pressure | viscosity |
| Organic solvent | (° C. at 1 atm) | (g/mol) | (mmHg at 20° C.) | (cP at 20° C.) |
| Ethylene Glycol | 196-198 | 62.06 | 0.12 | 21 |
| (EG) | | | | |
| Diethylene | 245 | 106.12 | 0.01 | 37.2 |
| glycol (DEG) | | | | |
| Tri ethylene | 285 | 150.17 | <0.0075 | 48 |
| glycol (TEG) | | | | |
| Propylene | 187 | 76.1 | 0.097 | 45 |
| glycol (PG) | | | | |
| Di-propylene | 180-190 | 148.2 | <0.01 | 4.32 |
| glycol (DPG) | | | | |

TABLE 3
Two absorption-desorption cycle comparisons
between H₂O-EG-Arg and H₂O-PG-Arg solutions.

| | | | | | Energy |
|---|---|---|---|---|---|
| | | | Amount of | Run time | consumed |
| Solutions | Cycles | Process | CO₂ (mg) | (min) | (Whr) |
| H₂O (25 ml) + | 1 | Abs. 1 | 582 | 754 | 17.1 |
| EG (25 ml) + | | Des. 1 | 591 | 5 | 140 |
| Arg (8.71 g) | 2 | Abs. 2 | 521 | 759 | 17.3 |
| | | Des. 2 | 556 | 4.5 | 130 |
| H₂O (25 ml) + | 1 | Abs. 1 | 531 | 771 | 17.6 |
| PG (25 ml) + | | Des. 1 | 481 | 3.5 | 100 |
| Arg (8.71 g) | 2 | Abs. 2 | 499 | 530 | 12.1 |
| | | Des. 2 | 463 | 3.5 | 100 |

In subsequent cyclic test, the water-PG-Arg solution demonstrated improved stability with consistently lower TVOC emissions during absorption (FIG. 2B) and no color change after desorption processes. The water-EG-Arg solution, however, emitted notably higher TVOCs with an unpleasant pungent odor throughout the cyclic study, and its color gradually deepened to a darker red after each desorption process. This degradation was likely driven by elevated temperatures during desorption processes, reaching 156° C. in the first cycle and 176° C. in the second, suggesting potential side reactions and thermal degradation (Tables 5 and 6). In contrast, the water-PG-Arg solution exhibited lower temperature increases during desorption (Tables 7 and 16), attributed to the higher specific heat capacity of PG (Table 4). Additionally, PG's lower polarity and dielectric constant limited the absorption of MW energy, reducing excessive heat generation. Thus, the thermal stability, improved absorption performance, and reduced energy consumption of the water-PG-Arg solution highlight its potential for long-term CO₂ capture applications. These findings support further investigation into its cyclic performance over multiple absorption-desorption processes.

TABLE 4
Dielectric properties and heat capacity
of Ethylene glycol and propylene glycol.

| | | | Specific heat |
|---|---|---|---|
| | Dielectric | Dielectric loss | capacity [cp] |
| Compound | constants [ε′] | factor [ε″] | (J/mol ° C. at 25° C.) |
| Ethylene Glycol | 41.2 | 5 | 149.8 |
| Propylene | 30.2 | 1 | 189.9 |
| Glycol | | | |

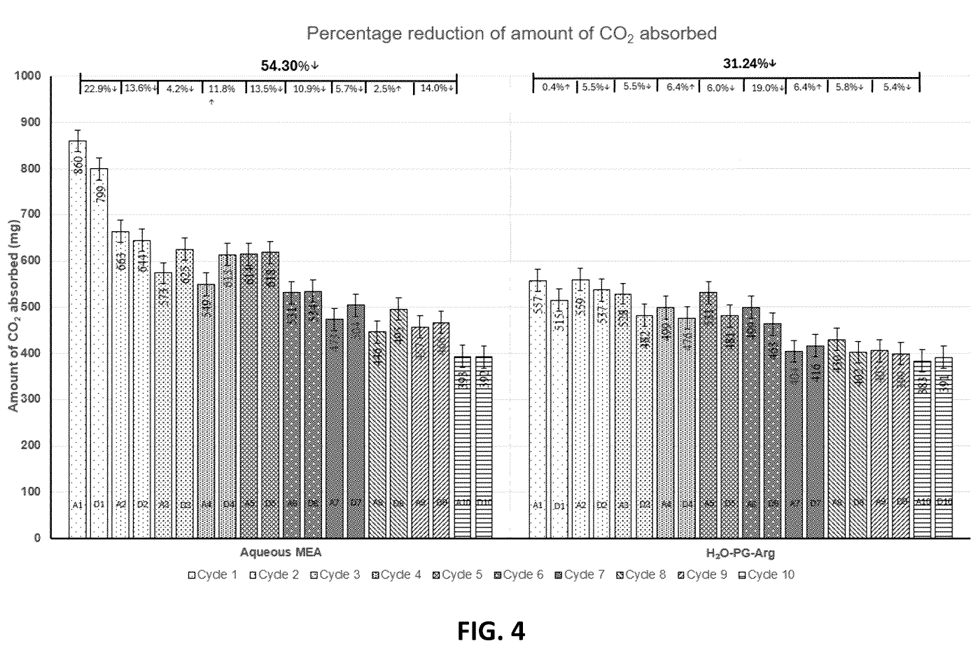

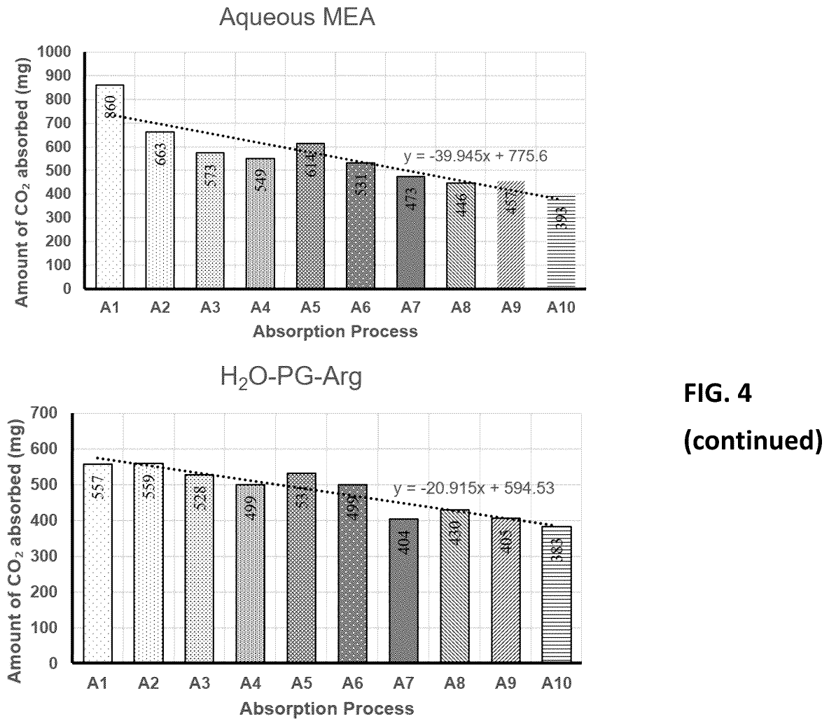

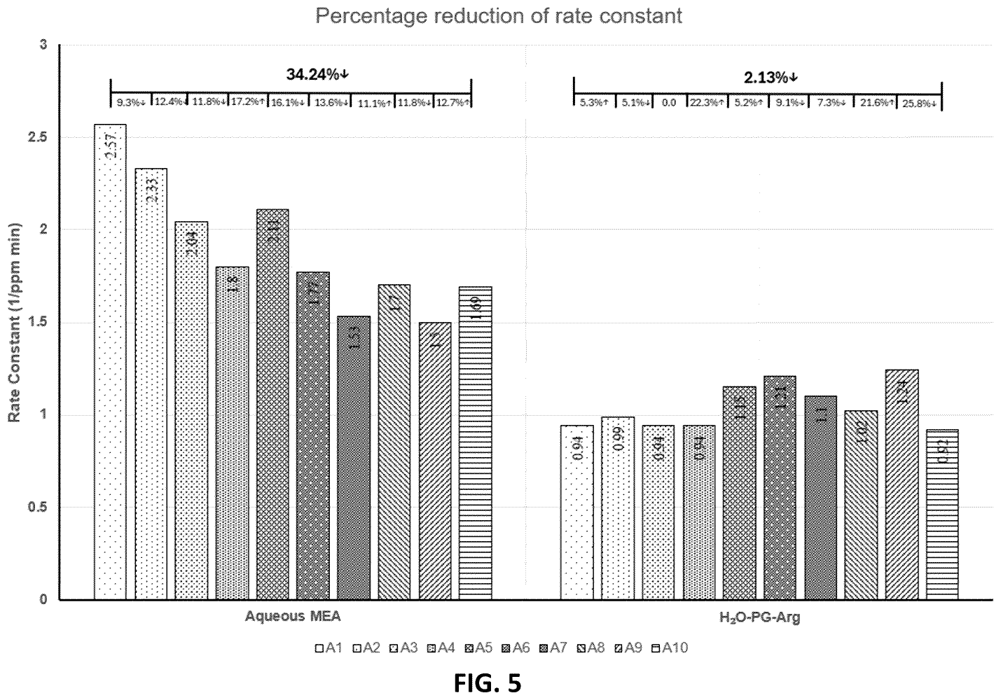

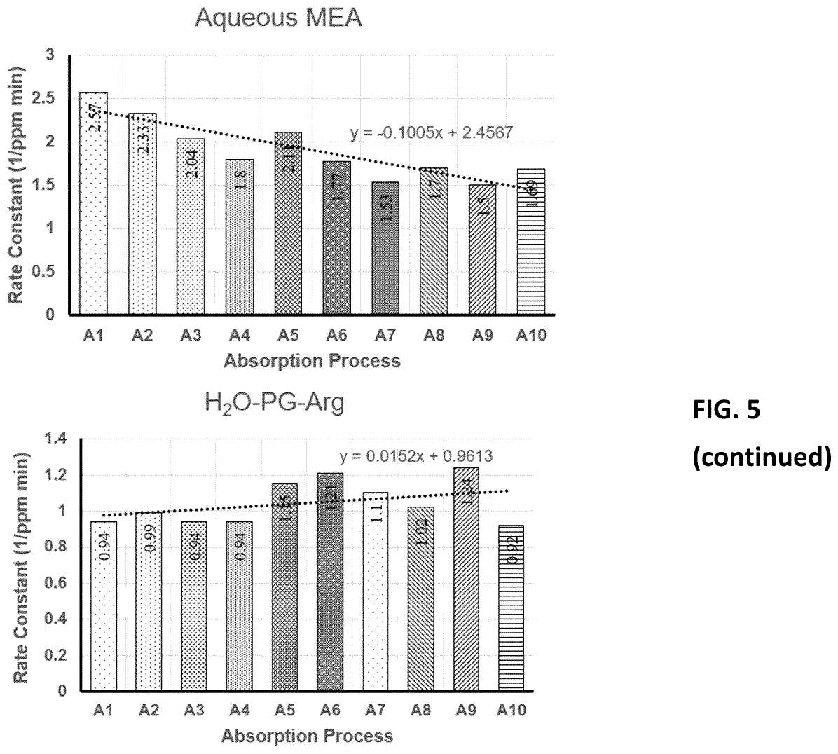

The cyclic performances of aqueous MEA and water-PG-Arg solutions were evaluated over ten absorption-desorption cycles, as shown in FIG. 4, panels (a) and (b). The reaction rate constants for both solutions across these cycles are presented in FIG. 5, panels (a) and (b). Although the aqueous MEA solution initially exhibited higher CO₂ absorption, its performance declined significantly over time, with a 54.3% reduction in CO₂ absorption after ten cycles. In contrast, the water-PG-Arg solution demonstrated greater stability, with only a 31.24% decline over the same period, becoming increasingly more consistent as our study progressed. The steeper downward trend observed in the MEA solution (FIG. 4, panel (b)) highlights its limitations for long-term CO₂ capture applications. Notably, during the third cycle of the aqueous MEA solution, 625 mg of CO₂ was desorbed, exceeding the 573 mg absorbed, attributed to experimental error or due to residual CO₂ from previous cycles. This behaviour was observed several times throughout the study. The effectiveness of the aqueous MEA solution declines over time because of oxidative and thermal degradation, leading to a reduced concentration of MEA available for CO₂ absorption. The degradation products, such as ammonia, acetaldehyde, and acetone, may pose potential risks to indoor environments. As a result, the reaction rate constant of the aqueous MEA solution decreased by 34.24% after ten cycles, compared to only a 2.13% reduction for the water-PG-Arg solution. These findings highlight the superior stability and long-term viability of the water-PG-Arg solution for indoor CO₂ capture applications.

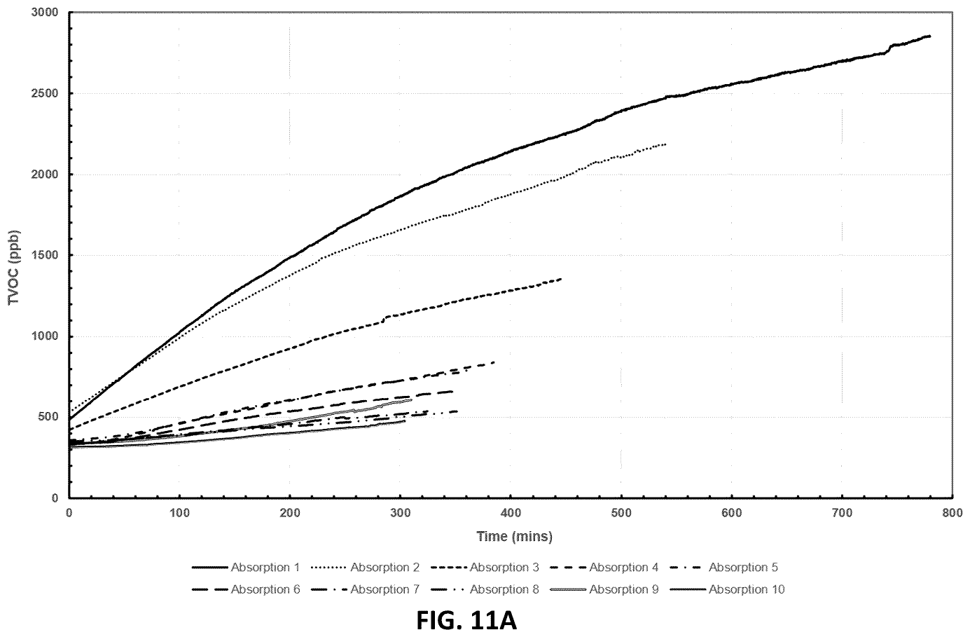

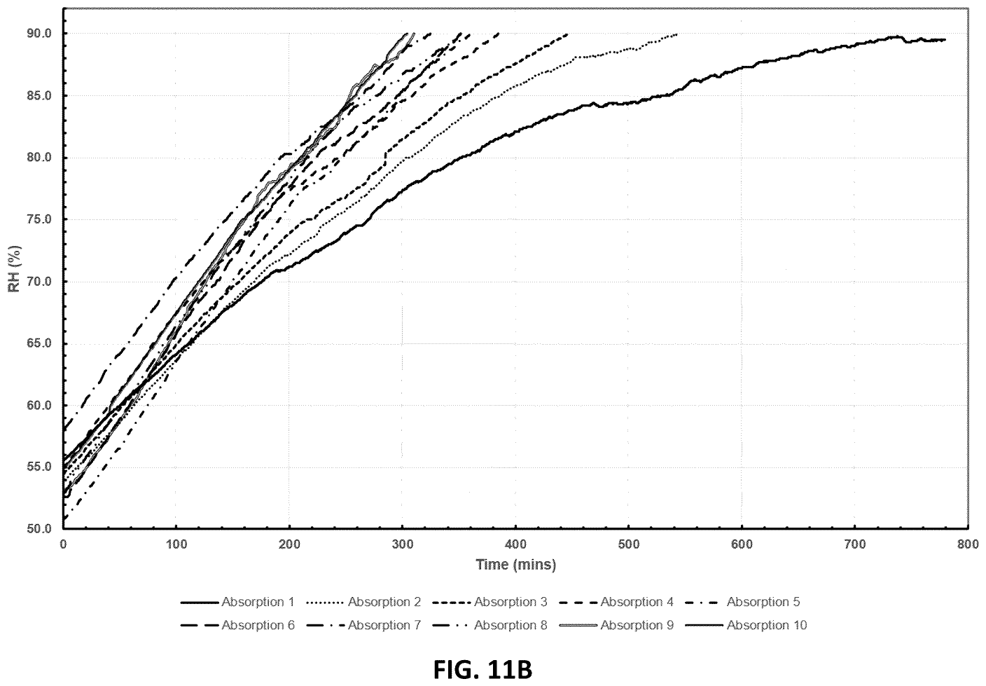

FIGS. 11A-11B illustrates the RH levels and TVOC concentrations during 10 absorption cycles of the H₂O-PG-Arg solution. Initially, the solution took longer to reach a RH of approximately 90% in the chamber; however, its ability to maintain RH progressively declined as the solution was used repeatedly. In contrast, TVOC concentrations were highest during the first cycle and they kept decreasing with each subsequent cycle. To understand this, TVOCs were sampled to analyze the compounds via LC-MS-QqQ and HS-SPME-GC-MS after the initial absorption process.

The analysis confirmed the presence of PG with no trace of Arg, based on the mass spectral data of water-PG-Arg solution and blank, which look similar. This analysis highlights Arg's stability across multiple cycles. However, the solution's declining ability to control RH during absorption can be attributed to PG evaporation during desorption, leading to a reduced mole fraction of PG in the resulting solutions, which can be attributed to a gradually lower TVOC generation.

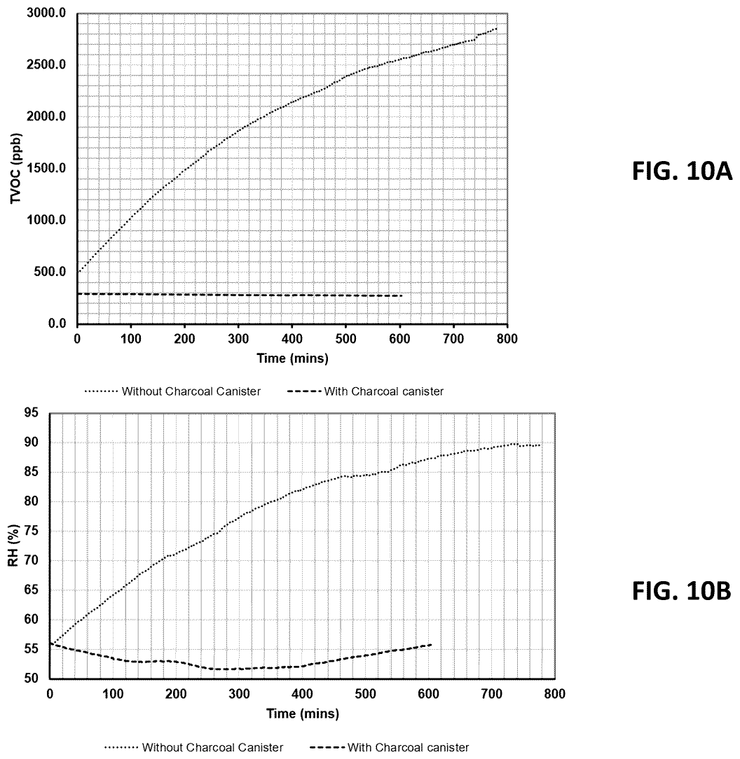

To further enhance indoor air quality by capturing VOCs during absorption, a charcoal canister was integrated into the setup. FIGS. 10A-10B illustrate the system's performance with and without the charcoal canister.

As anticipated, the results indicate that activated charcoal effectively reduced TVOC level throughout the experiment while adsorbing some water vapor, stabilizing RH. It is worth mentioning that PG, as a VOC, is odourless, non-toxic, and has a Workplace Environmental Exposure Limit (WEEL) of 3200 ppb, averaged over an 8-hour work shift, as set by the American Industrial Hygiene Association (AIHA). This limit is at least twelve times higher than the levels recorded in our experiment (i.e., 271 ppb). This stability of VOCs within the chamber highlights the charcoal canister's efficacy in limiting PG escape into the air, further supporting the reliability of the water-PG-Arg solution in capturing CO₂.

Tables 5-6 show experimental data of 2 absorption-desorption cycles of H₂O-EG-Arg solution. Tables 7-16 show experimental data of 10 absorption-desorption cycles of H₂O-PG-Arg solution. Tables 17-27 show experimental data of absorption-desorption cycles of the aqueous MEA solution.

TABLE 5
Experimental data of first absorption-desorption cycle of aqueous H₂O-EG-Arg solution.
Cycle 1

| | Concentration | | | Solution | |
|---|---|---|---|---|---|
| Absorption 1 | of CO₂ (ppm) | RH (%) | TVOC (ppb) | volume (ml) | pH |
| Initial | 1110 | 55 | 269 | 53 | 10 |
| Final | 633 | 100 | 12011 | 48 | 9 |
| | Amount of | CO₂ loading | Rate constant | Volume of | Absorption |
| Concentration of CO₂ | CO₂ absorbed | (Mole CO₂/ | (K″ × 10⁻⁶) | the solution | run time |
| absorbed (ppm) | (mg) | mole L-arg.) | (ppm⁻¹ min⁻¹) | lost (ml) | (min) |
| 477 | 582 | 0.26 | 0.95 | 5 | 754 |

Desorption 1

| Desorption step 1 | Microwave desorption time - 60 sec | | | | |
|---|---|---|---|---|---|
| HPL - 10 | Initial | After | 5 min wait | Final | Difference |
| | | desorption | for air to mix | | |
| Conc. of CO₂ (ppm) | 387 | — | properly in | 600 | 213 |
| Volume of solution (ml) | 53 | 48 | the chamber | — | 5 |
| Temperature (° C.) | 22.7 | 103 | | 54.8 | — |
| Desorption step 2 | Microwave desorption time - 60 sec | | | | |
| HPL - 10 | Initial | After | 5 min wait | Final | Difference |
| | | desorption | for air to mix | | |
| Conc. of CO₂ (ppm) | 600 | — | properly in | 688 | 88 |
| Volume of solution (ml) | 48 | 40 | the chamber | — | 8 |
| Temperature (° C.) | 54.8 | 110 | | 58.9 | — |
| Desorption step 3 | Microwave desorption time - 60 sec | | | | |
| HPL - 10 | Initial | After | 5 min wait | Final | Difference |
| | | desorption | for air to mix | | |
| Conc. of CO₂ (ppm) | 688 | — | properly in | 763 | 75 |
| Volume of solution (ml) | 40 | 32 | the chamber | — | 8 |
| Temperature (° C.) | 58.9 | 118.9 | | 60.7 | — |
| Desorption step 4 | Microwave desorption time - 60 sec | | | | |
| HPL - 10 | Initial | After | 5 min wait | Final | Difference |
| | | desorption | for air to mix | | |
| Conc. of CO₂ (ppm) | 763 | — | properly in | 830 | 67 |
| Volume of solution (ml) | 32 | 27 | the chamber | — | 5 |
| Temperature (° C.) | 60.7 | 133.9 | | 62 | — |
| Desorption step 5 | Microwave desorption time - 60 sec | | | | |
| HPL - 10 | Initial | After | 5 min wait | Final | Difference |
| | | desorption | for air to mix | | |
| Conc. of CO₂ (ppm) | 830 | — | properly in | 895 | 41 |
| Volume of solution (ml) | 27 | 23 | the chamber | — | 4 |
| Temperature (° C.) | 62 | 156 | | 80.2 | — |
| Concentration of CO₂ | 484 | Amount of | 591 | Volume of the | 30 |
| desorbed (ppm) | | CO₂ desorbed | | solution lost | |
| | | (mg) | | (ml) | |
| Energy consumed | 140 | CO₂ unloading (mole | | 0.27 | |
| during Desorption | | CO₂/mole L-arg) | | | |
| (Wh) | | | | | |

TABLE 6
Experimental data of second absorption-desorption
cycle of aqueous H₂O-EG-Arg solution.
Cycle 2

| | Concentration | | | Solution | |
|---|---|---|---|---|---|
| Absorption 1 | of CO₂ (ppm) | RH (%) | TVOC (ppb) | volume (ml) | pH |
| Initial | 1118 | 66.4 | 1234 | 53 | 10 |
| Final | 691 | 100 | 3736 | 47 | 9 |
| Concentration of | Amount of | CO₂ loading | Rate constant | Volume of | Absorption |
| CO₂ absorbed | CO₂ absorbed | (Mole CO₂/ | (K″ × 10⁻⁶) | the solution | run time |
| (ppm) | (mg) | mole L-arg.) | (ppm⁻¹ min⁻¹) | lost (ml) | (min) |
| 427 | 521 | 0.24 | 0.75 | 6 | 759 |

Desorption 1

| Desorption step 1 | Microwave desorption time - 90 sec | | | | |
|---|---|---|---|---|---|
| HPL - 10 | Initial | After | 5 min wait | Final | Difference |
| | | desorption | for air to mix | | |
| Conc. of CO₂ (ppm) | 379 | — | properly in | 615 | 236 |
| Volume of solution | 53 | 38 | the chamber | — | 15 |
| (ml) | | | | | |
| Temperature (° C.) | 23 | 106.7 | | 55 | — |
| Desorption step 2 | Microwave desorption time - 90 sec | | | | |
| HPL - 10 | Initial | After | 5 min wait | Final | Difference |
| | | desorption | for air to mix | | |
| Conc. of CO₂ (ppm) | 615 | — | properly in | 717 | 102 |
| Volume of solution | 38 | 27 | the chamber | — | 11 |
| (ml) | | | | | |
| Temperature (° C.) | 55 | 111.8 | | 65.1 | — |
| Desorption step 3 | Microwave desorption time - 90 sec | | | | |
| HPL - 10 | Initial | After | 5 min wait | Final | Difference |
| | | desorption | for air to mix | | |
| Conc. of CO₂ (ppm) | 717 | — | properly in | 834 | 117 |
| Volume of solution | 27 | 16 | the chamber | — | 11 |
| (ml) | | | | | |
| Temperature (° C.) | 56.1 | 176 | | 68.3 | — |
| Concentration of | 455 | Amount of | 556 | Volume of | 37 |
| CO₂ desorbed | | CO₂ desorbed | | the solution | |
| (ppm) | | (mg) | | lost (ml) | |
| Energy consumed | 130 | CO₂ unloading (mole | | 0.25 | |
| during Desorption | | CO₂/mole L-arg) | | | |
| (Wh) | | | | | |

TABLE 7
Experimental data of first absorption-desorption cycle of H₂O-PG-Arg solution.
Cycle 1

| | Concentration | | | Solution | |
|---|---|---|---|---|---|
| Absorption 1 | of CO₂ (ppm) | RH (%) | TVOC (ppb) | volume (ml) | pH |
| Initial | 1068 | 55.5 | 484 | 55 | 10 |
| Final | 612 | 89.5 | 2850 | 49 | 9 |
| Concentration of | Amount of | CO₂ loading | Rate constant | Volume of | Absorption |
| CO₂ absorbed | CO₂ absorbed | (Mole CO₂/ | (K″ × 10⁻⁶) | the solution | run time |
| (ppm) | (mg) | mole L-arg.) | (ppm⁻¹ min⁻¹) | lost (ml) | (min) |
| 456 | 557 | 0.25 | 0.94 | 6 | 780 |

Desorption 1

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 376 | — | properly in | 798 | 422 |
| Volume of solution | 55 | 25 | the chamber | — | 30 |
| (ml) | | | | | |
| Temperature (° C.) | 13 | 135.5 | | 55 | — |
| Concentration of | 422 | Amount of | 515 | Volume of | 30 |
| CO₂ desorbed (ppm) | | CO₂ desorbed | | the solution | |
| | | (mg) | | lost (ml) | |
| Energy consumed | 70 | CO₂ unloading (mole | | 0.23 | |
| during Desorption | | CO₂/mole L-arg) | | | |
| (Wh) | | | | | |

TABLE 8
Experimental data of second absorption-desorption cycle of H₂O-PG-Arg solution.
Cycle 2

| | Concentration | | | Solution | |
|---|---|---|---|---|---|
| Absorption 1 | of CO₂ (ppm) | RH (%) | TVOC (ppb) | volume (ml) | pH |
| Initial | 1083 | 53.7 | 530 | 55 | 10 |
| Final | 625 | 94.2 | 2715 | 49 | 9 |
| Concentration of | Amount of | CO₂ loading | Rate constant | Volume of | Absorption |
| CO₂ absorbed | CO₂ absorbed | (Mole CO₂/ | (K″ × 10⁻⁶) | the solution | run time |
| (ppm) | (mg) | mole L-arg.) | (ppm⁻¹ min⁻¹) | lost (ml) | (min) |
| 458 | 559 | 0.25 | 0.99 | 6 | 781 |

Desorption 1

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 387 | — | properly in | 787 | 400 |
| Volume of solution | 55 | 26 | the chamber | — | 29 |
| (ml) | | | | | |
| Temperature (° C.) | 22.7 | 104.5 | | 53 | — |
| Desorption step 2 | Microwave desorption time - 60 sec | | | | |
| HPL - 10 | Initial | After | 5 min wait | Final | Difference |
| | | desorption | for air to mix | | |
| Conc. of CO₂ (ppm) | 787 | — | properly in | 827 | 40 |
| Volume of solution | 26 | 21 | the chamber | — | 5 |
| (ml) | | | | | |
| Temperature (° C.) | 53 | 123.8 | | 51.3 | — |
| Concentration of | 440 | Amount of | 537 | Volume of | 34 |
| CO₂ desorbed (ppm) | | CO₂ desorbed | | the solution | |
| | | (mg) | | lost (ml) | |
| Energy consumed | 100 | CO₂ unloading (mole | | 0.24 | |
| during Desorption | | CO₂/mole L-arg) | | | |
| (Wh) | | | | | |

TABLE 9
Experimental data of third absorption-desorption cycle of H₂O-PG-Arg solution.
Cycle 3

| | Concentration | | | Solution | |
|---|---|---|---|---|---|
| Absorption 1 | of CO₂ (ppm) | RH (%) | TVOC (ppb) | volume (ml) | pH |
| Initial | 1066 | 54.5 | 421 | 55 | 10 |
| Final | 634 | 97.1 | 1873 | 49 | 9 |
| Concentration of | Amount of | CO₂ loading | Rate constant | Volume of | Absorption |
| CO₂ absorbed | CO₂ absorbed | (Mole CO₂/ | (K″ × 10⁻⁶) | the solution | run time |
| (ppm) | (mg) | mole L-arg.) | (ppm⁻¹ min⁻¹) | lost (ml) | (min) |
| 432 | 528 | 0.24 | 0.93 | 6 | 773 |

Desorption 1

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 390 | — | properly in | 761 | 371 |
| Volume of solution | 55 | 28 | the chamber | — | 27 |
| (ml) | | | | | |
| Temperature (° C.) | 22.8 | 101.1 | | 55.4 | — |
| Desorption step 2 | Microwave desorption time - 60 sec | | | | |
| HPL - 10 | Initial | After | 5 min wait | Final | Difference |
| | | desorption | for air to mix | | |
| Conc. of CO₂ (ppm) | 761 | — | properly in | 785 | 24 |
| Volume of solution | 28 | 21 | the chamber | — | 7 |
| (ml) | | | | | |
| Temperature (° C.) | 55.4 | 107.3 | | 52.1 | — |
| Concentration of | 395 | Amount of | 482 | Volume of | 34 |
| CO₂ desorbed | | CO₂ desorbed | | the solution | |
| (PPM) | | (mg) | | lost (ml) | |
| Energy consumed | 100 | CO₂ unloading (mole | | 0.22 | |
| during Desorption | | CO₂/mole L-arg) | | | |
| (Wh) | | | | | |

TABLE 10
Experimental data of fourth absorption-desorption cycle of H₂O-PG-Arg solution.
Cycle 4

| | Concentration | | | Solution | |
|---|---|---|---|---|---|
| Absorption 1 | of CO₂ (ppm) | RH (%) | TVOC (ppb) | volume (ml) | pH |
| Initial | 1089 | 54.9 | 330 | 55 | 10 |
| Final | 680 | 98.5 | 1398 | 49 | 9 |
| Concentration of | Amount of | CO₂ loading | Rate constant | Volume of | Absorption |
| CO₂ absorbed | CO₂ absorbed | (Mole CO₂/ | (K″ × 10⁻⁶) | the solution | run time |
| (ppm) | (mg) | mole L-arg.) | (ppm⁻¹ min⁻¹) | lost (ml) | (min) |
| 409 | 499 | 0.23 | 0.94 | 6 | 682 |

Desorption 1

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 370 | — | properly in | 760 | 390 |
| Volume of solution | 55 | 22 | the chamber | — | 33 |
| (ml) | | | | | |
| Temperature (° C.) | 23 | 100.4 | | 50.4 | — |
| Concentration of | 390 | Amount of | 476 | Volume of | 33 |
| CO₂ desorbed (ppm) | | CO₂ desorbed | | the solution | |
| | | (mg) | | lost (ml) | |
| Energy consumed | 70 | CO₂ unloading (mole | | 0.22 | |
| during Desorption | | CO₂/mole L-arg) | | | |
| (Wh) | | | | | |

TABLE 11
Experimental data of fifth absorption-desorption cycle of H₂O-PG-Arg solution.
Cycle 5

| | Concentration | | | Solution | |
|---|---|---|---|---|---|
| Absorption 1 | of CO₂ (ppm) | RH (%) | TVOC (ppb) | volume (ml) | pH |
| Initial | 1045 | 50.8 | 358 | 55 | 10 |
| Final | 610 | 100 | 1664 | 49 | 9 |
| Concentration of | Amount of | CO₂ loading | Rate constant | Volume of | Absorption |
| CO₂ absorbed | CO₂ absorbed | (Mole CO₂/ | (K″ × 10⁻⁶) | the solution | run time |
| (ppm) | (mg) | mole L-arg.) | (ppm⁻¹ min⁻¹) | lost (ml) | (min) |
| 435 | 531 | 0.24 | 1.15 | 6 | 771 |

Desorption 1

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 389 | — | properly in | 752 | 363 |
| Volume of solution | 55 | 25 | the chamber | — | 30 |
| (ml) | | | | | |
| Temperature (° C.) | 22.4 | 96.7 | | 48.3 | — |
| Desorption step 2 | Microwave desorption time - 60 sec | | | | |
| HPL - 10 | Initial | After | 5 min wait | Final | Difference |
| | | desorption | for air to mix | | |
| Conc. of CO₂ (ppm) | 752 | — | properly in | 783 | 31 |
| Volume of solution | 25 | 19 | the chamber | — | 6 |
| (ml) | | | | | |
| Temperature (° C.) | 48.3 | 100 | | 46.4 | — |
| Concentration of | 394 | Amount of | 481 | Volume of | 36 |
| CO₂ desorbed | | CO₂ desorbed | | the solution | |
| (ppm) | | (mg) | | lost (ml) | |
| Energy consumed | 100 | CO₂ unloading (mole | | 0.22 | |
| during Desorption | | CO₂/mole L-arg) | | | |
| (Wh) | | | | | |

TABLE 12
Experimental data of sixth absorption-desorption cycle of H₂O-PG-Arg solution.
Cycle 6

| | Concentration | | | Solution | |
|---|---|---|---|---|---|
| Absorption 1 | of CO₂ (ppm) | RH (%) | TVOC (ppb) | volume (ml) | pH |
| Initial | 1077 | 52.8 | 331 | 55 | 10 |
| Final | 668 | 98.4 | 855 | 49 | 9 |
| Concentration of | Amount of | CO₂ loading | Rate constant | Volume of | Absorption |
| CO₂ absorbed | CO₂ absorbed | (Mole CO₂ / | (K″ × 10⁻⁶) | the solution | run time |
| (ppm) | (mg) | mole L-arg.) | (ppm⁻¹ min⁻¹) | lost (ml) | (min) |
| 409 | 499 | 0.23 | 1.21 | 6 | 530 |

Desorption 1

| Desorption step 1 | Microwave desorption time - 150 sec | | | | |
|---|---|---|---|---|---|
| HPL - 10 | Initial | After | 5 min wait | Final | Difference |
| | | desorption | for air to | | |
| Conc. of CO₂ (ppm) | 378 | — | mix | 725 | 347 |
| Volume of solution | 55 | 27 | properly in | — | 28 |
| (ml) | | | | | |
| Temperature (° C.) | 22.4 | 97.9 | the chamber | 52.7 | — |
| Desorption step 2 | Microwave desorption time - 60 sec | | | | |
| HPL - 10 | Initial | After | 5 min wait | Final | Difference |
| | | desorption | for air to | | |
| Conc. of CO₂ (ppm) | 725 | — | mix | 757 | 32 |
| Volume of solution | 27 | 21 | properly in | — | 6 |
| (ml) | | | | | |
| Temperature (° C.) | 52.7 | 100 | the chamber | 50.4 | — |
| Concentration of | 379 | Amount of | 463 | Volume of | 34 |
| CO₂ desorbed (ppm) | | CO₂ desorbed | | the solution | |
| | | (mg) | | lost (ml) | |
| Energy consumed | 100 | CO₂ unloading (mole | | 0.21 | |
| during Desorption | | CO₂/mole L-arg) | | | |
| (Wh) | | | | | |

TABLE 13
Experimental data of seventh absorption-desorption cycle of H₂O-PG-Arg solution.
Cycle 7

| | Concentration | | | Solution | |
|---|---|---|---|---|---|
| Absorption 1 | of CO₂ (ppm) | RH (%) | TVOC (ppb) | volume (ml) | pH |
| Initial | 1035 | 58.1 | 335 | 55 | 10 |
| Final | 704 | 100 | 845 | 49 | 9 |
| Concentration of | Amount of | CO₂ loading | Rate constant | Volume of | Absorption |
| CO₂ absorbed | CO₂ absorbed | (Mole CO₂/ | (K″ × 10⁻⁶) | the solution | run time |
| (ppm) | (mg) | mole L-arg.) | (ppm⁻¹ min⁻¹) | lost (ml) | (min) |
| 331 | 404 | 0.18 | 1.10 | 6 | 603 |

Desorption 1

| Desorption step 1 | Microwave desorption time - 150 sec | | | | |
|---|---|---|---|---|---|
| HPL - 10 | Initial | After | 5 min wait | Final | Difference |
| | | desorption | for air to mix | | |
| Conc. of CO₂ (ppm) | 367 | — | properly in | 708 | 341 |
| Volume of solution | 55 | 22 | the chamber | — | 33 |
| (ml) | | | | | |
| Temperature (° C.) | 22.8 | 97.3 | | 46.7 | — |
| Concentration of | 341 | Amount of | 416 | Volume of | 33 |
| CO₂ desorbed | | CO₂ desorbed | | the solution | |
| (ppm) | | (mg) | | lost (ml) | |
| Energy consumed | 70 | CO₂ unloading (mole | | 0.19 | |
| during Desorption | | CO₂/mole L-arg) | | | |
| (Wh) | | | | | |

TABLE 14
Experimental data of eight absorption-desorption cycle of H₂O-PG-Arg solution.
Cycle 8

| | Concentration | | | Solution | |
|---|---|---|---|---|---|
| Absorption 1 | of CO₂ (ppm) | RH (%) | TVOC (ppb) | volume (ml) | pH |
| Initial | 1098 | 52.9 | 349 | 55 | 10 |
| Final | 746 | 100 | 1197 | 49 | 9 |

| | | | Rate | | |
|---|---|---|---|---|---|
| | Amount of | CO₂ loading | constant | Volume of | Absorption |
| Concentration of | CO₂ absorbed | (Mole CO₂/ | (K″ × 10⁻⁶) | the solution | run time |
| CO₂ absorbed (ppm) | (mg) | mole L-arg.) | (ppm⁻¹ min⁻¹) | lost (ml) | (min) |
| 352 | 430 | 0.20 | 1.02 | 6 | 740 |

Desorption 1

| Desorption step 1 | Microwave desorption time - 150 sec | | | | |
|---|---|---|---|---|---|
| HPL - 10 | Initial | After | 5 min wait | Final | Difference |
| | | desorption | for air to | | |
| Conc. of CO₂ (ppm) | 381 | — | mix | 710 | 329 |
| Volume of solution | 55 | 18 | properly in | — | 37 |
| (ml) | | | the chamber | | |
| Temperature (° C.) | 22.6 | 94.8 | | 47 | — |
| Concentration of | 329 | Amount of | 402 | Volume of | 37 |
| CO₂ desorbed | | CO₂ desorbed | | the solution | |
| (ppm) | | (mg) | | lost (ml) | |
| Energy consumed | 70 | CO₂ unloading (mole CO₂/ | | 0.18 | |
| during Desorption | | mole L-arg) | | | |
| (Wh) | | | | | |

TABLE 15
Experimental data of ninth absorption-desorption cycle of H₂O-PG-Arg solution.
Cycle 9

| | Concentration | | | Solution | |
|---|---|---|---|---|---|
| Absorption 1 | of CO₂ (ppm) | RH (%) | TVOC (ppb) | volume (ml) | pH |
| Initial | 1079 | 53.1 | 337 | 55 | 10 |
| Final | 747 | 97.2 | 1073 | 49 | 9 |

| | | | Rate | | |
|---|---|---|---|---|---|
| | Amount of | CO₂ loading | constant | Volume of | Absorption |
| Concentration of | CO₂ absorbed | (Mole CO₂/ | (K″ × 10⁻⁶) | the solution | run time |
| CO₂ absorbed (ppm) | (mg) | mole L-arg.) | (ppm⁻¹ min⁻¹) | lost (ml) | (min) |
| 332 | 405 | 0.18 | 1.24 | 6 | 460 |

Desorption 1

| Desorption step 1 | Microwave desorption time - 150 sec | | | | |
|---|---|---|---|---|---|
| HPL - 10 | Initial | After | 5 min wait | Final | Difference |
| | | desorption | for air to | | |
| Conc. of CO₂ (ppm) | 357 | — | mix | 657 | 300 |
| Volume of solution | 55 | 20 | properly in | — | 35 |
| (ml) | | | the chamber | | |
| Temperature (° C.) | 22.6 | 97.9 | | 45.4 | — |
| Desorption step 2 | Microwave desorption time - 60 sec | | | | |
| HPL - 10 | Initial | After | 5 min wait | Final | Difference |
| | | desorption | for air to | | |
| Conc. of CO₂ (ppm) | 657 | — | mix | 684 | 27 |
| Volume of solution | 20 | 13 | properly in | — | 7 |
| (ml) | | | the chamber | | |
| Temperature (° C.) | 45.4 | 97.1 | | 43 | — |
| Concentration of | 327 | Amount of | 399 | Volume of | 42 |
| CO₂ desorbed (ppm) | | CO₂ desorbed | | the solution | |
| | | (mg) | | lost (ml) | |
| Energy consumed | 100 | CO₂ unloading (mole CO₂/ | | 0.18 | |
| during Desorption | | mole L-arg) | | | |
| (Wh) | | | | | |

TABLE 16
Experimental data of tenth absorption-desorption cycle of H₂O-PG-Arg solution.
Cycle 10

| | Concentration | | | Solution | |
|---|---|---|---|---|---|
| Absorption 1 | of CO₂ (ppm) | RH (%) | TVOC (ppb) | volume (ml) | pH |
| Initial | 1054 | 54.9 | 314 | 55 | 10 |
| Final | 740 | 100 | 1048 | 49 | 9 |

| | | | Rate | | |
|---|---|---|---|---|---|
| | Amount of | CO₂ loading | constant | Volume of | Absorption |
| Concentration of | CO₂ absorbed | (Mole CO₂/ | (K″ × 10⁻⁶) | the solution | run time |
| CO₂ absorbed (ppm) | (mg) | mole L-arg.) | (ppm⁻¹ min⁻¹) | lost (ml) | (min) |
| 314 | 383 | 0.17 | 0.92 | 6 | 556 |

Desorption 1

| Desorption step 1 | Microwave desorption time -150 sec | | | | |
|---|---|---|---|---|---|
| HPL - 10 | Initial | After | 5 min wait | Final | Difference |
| | | desorption | for air to | | |
| Conc. of CO₂ (ppm) | 361 | — | mix | 655 | 294 |
| Volume of solution | 55 | 23 | properly in | — | 32 |
| (ml) | | | the chamber | | |
| Temperature (° C.) | 22.8 | 95 | | 47.3 | — |
| Desorption step 2 | Microwave desorption time - 60 sec | | | | |
| HPL - 10 | Initial | After | 5 min wait | Final | Difference |
| | | desorption | for air to | | |
| Conc. of CO₂ (ppm) | 655 | — | mix | 681 | 26 |
| Volume of solution | 23 | 13 | properly in | — | 10 |
| (ml) | | | the chamber | | |
| Temperature (° C.) | 47.3 | 96.4 | | 44.6 | — |
| Concentration of | 320 | Amount of | 391 | Volume of | 42 |
| CO₂ desorbed (ppm) | | CO₂ desorbed | | the solution | |
| | | (mg) | | lost (ml) | |
| Energy consumed | 100 | CO₂ unloading (mole CO₂/ | | 0.18 | |
| during Desorption | | mole L-arg) | | | |
| (Wh) | | | | | |

TABLE 17
Experimental data of absorption-conventional
desorption cycle of aqueous MEA solution.

| | | | | Solution | |
|---|---|---|---|---|---|
| | Concentration | | | volume | |
| Absorption | of CO₂ (ppm) | RH (%) | TVOC (ppb) | (ml) | pH |
| Initial | 1037 | 53.6 | 318 | 53 | 12 |
| Final | 318 | 100 | 22795 | 49 | 9 |

| | | | Microair | Volume of | |
|---|---|---|---|---|---|
| Concentration of | Amount of | CO₂ loading | pump power | the | Absorption |
| CO₂ absorbed | CO₂ absorbed | (Mole CO₂/ | consumption | solution | run time |
| (ppm) | (mg) | Mole MEA) | (Wh) | lost (ml) | (min) |
| 719 | 878 | 0.41 | 19.9 | 7 | 871 |

| | | | | Solution | Solution |
|---|---|---|---|---|---|
| Conventional | Concentration | | | volume | temperature |
| Desorption | of CO₂ (ppm) | RH (%) | TVOC (ppb) | (ml) | (C.) |
| Initial | 361 | 55.5 | 330 | 53 | 24 |
| Final | 660 | 83.3 | 319 | 46 | 67 |

| | | CO₂ | Microair | Volume of | |
|---|---|---|---|---|---|
| Concentration of | Amount of | unloading | pump power | the | Desorption |
| CO₂ desorbed | CO₂ desorbed | (Mole CO₂/ | consumption | solution | run time |
| (ppm) | (mg) | Mole MEA) | (Wh) | lost (ml) | (min) |
| 299 | 365 | 0.17 | 3.2 | 7 | 140 |

| | |
|---|---|
| Energy consumed by hot plate during Desorption (Wh) | 100 |

Additional Data
Temperature set value of hot plate: 250 C., Sand preheating duration: 60 mins, Energy Consumed by hot plate during pre-heating: 50 Whr., Sand Temperature after pre-heating: 125 C., and Micro air pump power: 1.37 W.

TABLE 18
Experimental data of first absorption-desorption cycle of aqueous MEA solution.
Cycle 1

| | Concentration | | | Solution | |
|---|---|---|---|---|---|
| Absorption 1 | of CO₂ (ppm) | RH (%) | TVOC (ppb) | volume (ml) | pH |
| Initial | 1080 | 58.5 | 285 | 53 | 12 |
| Final | 376 | 100 | 27090 | 45 | 9 |

| | | CO₂ loading | Rate constant | Volume of | Absorption |
|---|---|---|---|---|---|
| Concentration of CO₂ | Amount of CO₂ | (Mole CO₂/ | (K″ × 10⁻⁶) | the solution | run time |
| absorbed (ppm) | absorbed (mg) | mole L-arg.) | (1/ppm min) | lost (ml) | (mins) |
| 704 | 860 | 0.40 | 2.57 | 8 | 819 |

Desorption 1

| Desorption step 1 | Microwave desorption time - 60 sec | | | | |
|---|---|---|---|---|---|
| HPL - 10 | Initial | After | 5 min wait | Final | Difference |
| | | desorption | for air to mix | | |
| Conc. of CO₂ (ppm) | 326 | — | properly in | 830 | 504 |
| Volume of solution | 53 | 27 | the chamber | — | 26 |
| (ml) | | | | | |
| RH (%) | 59.8 | — | | 100 | — |
| TVOC (ppb) | 336 | | | 78611 | |
| Temperature (C.) | 22.3 | 95.1 | | 47 | |
| Desorption step 2 | Microwave desorption time - 60 sec | | | | |
| HPL - 10 | Initial | After | 5 min wait | Final | Difference |
| | | desorption | for air to mix | | |
| Conc. of CO₂ (ppm) | 830 | — | properly in | 918 | 88 |
| Volume of solution | 27 | 19 | the chamber | — | 8 |
| (ml) | | | | | |
| RH (%) | 100 | — | | 100 | — |
| TVOC (ppb) | 78611 | | | 78592 | |
| Temperature (C.) | 47 | 93 | | 43.1 | |
| Desorption step 3 | Microwave desorption time - 60 sec | | | | |
| HPL - 10 | Initial | After | 5 min wait | Final | Difference |
| | | desorption | for air to mix | | |
| Conc. of CO₂ (ppm) | 918 | — | properly in | 980 | 62 |
| Volume of solution | 19 | 10 | the chamber | — | 9 |
| (ml) | | | | | |
| RH (%) | 100 | — | | 100 | — |
| TVOC (ppb) | 78592 | | | 78615 | |
| Temperature (C.) | 43.1 | 94 | | 43 | |
| Concentration of CO₂ | 654 | Amount of | 799 | Volume of the | 43 |
| desorbed (ppm) | | CO₂ desorbed | | solution lost | |
| | | (mg) | | (ml) | |
| Energy consumed | 130 | CO₂ unloading (mole CO₂/ | | 0.37 | |
| during Desorption | | mole MEA) | | | |
| (Wh) | | | | | |

TABLE 19
Experimental data of second absorption-desorption cycle of aqueous MEA solution.
Cycle 2

| | Concentration | | | Solution | |
|---|---|---|---|---|---|
| Absorption 2 | of CO₂ (ppm) | RH (%) | TVOC (ppb) | volume (ml) | pH |
| Initial | 1058 | 57.8 | 324 | 53 | 10 |
| Final | 515 | 100 | 18340 | 45 | 9 |

| | | CO₂ | | | |
|---|---|---|---|---|---|
| Concentration of | Amount of | loading | Rate constant | Volume of | Absorption |
| CO₂ absorbed | CO₂ absorbed | (Mole CO₂/ | (K″ × 10⁻⁶) | the solution | run time |
| (ppm) | (mg) | mole MEA | (1/ppm min) | lost (ml) | (mins) |
| 543 | 663 | 0.31 | 2.33 | 8 | 816 |

Desorption 2

| Desorption step 1 | Microwave desorption time - 150 sec | | | | |
|---|---|---|---|---|---|
| HPL - 10 | Initial | After | 5 min wait | Final | Difference |
| | | desorption | for air to | | |
| Conc. of CO₂ (ppm) | 363 | — | mix properly | 890 | 527 |
| Volume of solution | 53 | 27 | in | — | 26 |
| (ml) | | | the chamber | | |
| RH (%) | 57.9 | — | | 100 | — |
| TVOC (ppb) | 310 | | | 67155 | |
| Temperature (C.) | 22.2 | 93.6 | | 55 | |
| Concentration of | 527 | Amount of | 644 | Volume of | 26 |
| CO₂ desorbed | | CO₂ | | the solution | |
| (ppm) | | desorbed | | lost (ml) | |
| | | (mg) | | | |
| Energy consumed | 70 | CO₂ unloading (mole CO₂/ | | 0.30 | |
| during Desorption | | mole MEA) | | | |
| (Wh) | | | | | |

TABLE 20
Experimental data of third absorption-desorption cycle of aqueous MEA solution.
Cycle 3

| | Concentration | | | Solution | |
|---|---|---|---|---|---|
| Absorption 3 | of CO₂ (ppm) | RH (%) | TVOC (ppb) | volume (ml) | pH |
| Initial | 1053 | 61.1 | 343 | 53 | 10 |
| Final | 584 | 100 | 24576 | 45 | 9 |

| | | CO₂ | | | |
|---|---|---|---|---|---|
| Concentration of | Amount of | loading | Rate constant | Volume of | Absorption |
| CO₂ absorbed | CO₂ absorbed | (Mole CO₂/ | (K″ × 10⁻⁶) | the solution | run time |
| (ppm) | (mg) | mole MEA | (1/ppm min) | lost (ml) | (mins) |
| 469 | 573 | 0.26 | 2.04 | 8 | 720 |

Desorption 3

| Desorption step 1 | Microwave desorption time - 150 sec | | | | |
|---|---|---|---|---|---|
| HPL - 10 | Initial | After | 5 min wait | Final | Difference |
| | | desorption | for air to | | |
| Conc. of CO₂ (ppm) | 377 | — | mix properly | 889 | 512 |
| Volume of solution | 53 | 25 | in | — | 28 |
| (ml) | | | the chamber | | |
| RH (%) | 56.8 | — | | 100 | — |
| TVOC (ppb) | 292 | | | 55984 | |
| Temperature (C.) | 22.1 | 95.6 | | 47.5 | |
| Concentration of | 512 | Amount of | 625 | Volume of | 28 |
| CO₂ desorbed | | CO₂ | | the solution | |
| (ppm) | | desorbed | | lost (ml) | |
| | | (mg) | | | |
| Energy consumed | 70 | CO₂ unloading (mole CO₂/ | | 0.29 | |
| during Desorption | | mole MEA) | | | |
| (Wh) | | | | | |

TABLE 21
Experimental data of fourth absorption-desorption cycle of aqueous MEA solution.
Cycle 4

| | Concentration | | | Solution | |
|---|---|---|---|---|---|
| Absorption 4 | of CO₂ (ppm) | RH (%) | TVOC (ppb) | volume (ml) | pH |
| Initial | 1061 | 59.2 | 307 | 53 | 10 |
| Final | 591 | 100 | 9271 | 45 | 9 |

| | | CO₂ | | | |
|---|---|---|---|---|---|
| Concentration of | Amount of | loading | Rate constant | Volume of | Absorption |
| CO₂ absorbed | CO₂ absorbed | (Mole CO₂/ | (K″ × 10⁻⁶) | the solution | run time |
| (ppm) | (mg) | mole MEA | (1/ppm min) | lost (ml) | (mins) |
| 470 | 574 | 0.27 | 1.8 | 8 | 611 |

Desorption 4

| Desorption step 1 | Microwave desorption time - 150 sec | | | | |
|---|---|---|---|---|---|
| HPL - 10 | Initial | After | 5 min wait | Final | Difference |
| | | desorption | for air to | | |
| Conc. of CO₂ (ppm) | 397 | — | mix properly | 899 | 502 |
| Volume of solution | 53 | 26 | in | — | 27 |
| (ml) | | | the chamber | | |
| RH (%) | 57.4 | — | | 100 | — |
| TVOC (ppb) | 350 | | | 52773 | |
| Temperature (C.) | 23 | 93.7 | | 48.7 | |
| Concentration of | 502 | Amount of | 613 | Volume of | 27 |
| CO₂ desorbed | | CO₂ | | the solution | |
| (ppm) | | desorbed | | lost (ml) | |
| | | (mg) | | | |
| Energy consumed | 70 | CO₂ unloading (mole CO₂/ | | 0.28 | |
| during Desorption | | mole MEA) | | | |
| (Wh) | | | | | |

TABLE 22
Experimental data of fifth absorption-desorption cycle of aqueous MEA solution.
Cycle 5

| | Concentration | | | Solution | |
|---|---|---|---|---|---|
| Absorption 5 | of CO₂ (ppm) | RH (%) | TVOC (ppb) | volume (ml) | pH |
| Initial | 1052 | 61.2 | 356 | 53 | 10 |
| Final | 549 | 100 | 14937 | 47 | 9 |

| | | CO₂ | | | |
|---|---|---|---|---|---|
| Concentration of | Amount of | loading | Rate constant | Volume of | Absorption |
| CO₂ absorbed | CO₂ absorbed | (Mole CO₂/ | (K″ × 10⁻⁶) | the solution | run time |
| (ppm) | (mg) | mole L-arg.) | (1/ppm min) | lost (ml) | (mins) |
| 503 | 614 | 0.28 | 2.11 | 6 | 570 |

Desorption 5

| Desorption step 1 | Microwave desorption time - 150 sec | | | | |
|---|---|---|---|---|---|
| HPL - 10 | Initial | After | 5 min wait | Final | Difference |
| | | desorption | for air to | | |
| Conc. of CO₂ (ppm) | 369 | — | mix | 830 | 461 |
| Volume of solution | 53 | 25 | properly in | — | 28 |
| (ml) | | | the chamber | | |
| RH (%) | 57.2 | — | | 100 | — |
| TVOC (ppb) | 346 | | | 61771 | |
| Temperature (C.) | 22.2 | 95.1 | | 47 | |
| Desorption step 2 | Microwave desorption time - 60 sec | | | | |
| HPL - 10 | Initial | After | 5 min wait | Final | Difference |
| | | desorption | for air to | | |
| Conc. of CO₂ (ppm) | 830 | | mix | 875 | 45 |
| Volume of solution | 25 | 18 | properly in | — | 7 |
| (ml) | | | the chamber | | |
| RH (%) | 100 | — | | 100 | — |
| TVOC (ppb) | 61771 | | | 72019 | |
| Temperature (C.) | 47 | 94.9 | | 46.2 | |
| Concentration of | 506 | Amount of | 618 | Volume of | 35 |
| CO₂ desorbed | | CO₂ | | the solution | |
| (ppm) | | desorbed | | lost (ml) | |
| | | (mg) | | | |
| Energy consumed | 100 | CO₂ unloading (mole CO₂/ | | 0.29 | |
| during Desorption | | mole MEA) | | | |
| (Wh) | | | | | |

TABLE 23
Experimental data of sixth absorption-desorption cycle of aqueous MEA solution.
Cycle 6

| | Concentration | | | Solution | |
|---|---|---|---|---|---|
| Absorption 6 | of CO₂ (ppm) | RH (%) | TVOC (ppb) | volume (ml) | pH |
| Initial | 1045 | 61.2 | 371 | 53 | 10 |
| Final | 610 | 100 | 17751 | 45 | 9 |

| | | CO₂ | | | |
|---|---|---|---|---|---|
| Concentration of | Amount of | loading | Rate constant | Volume of | Absorption |
| CO₂ absorbed | CO₂ absorbed | (Mole CO₂/ | (K″ × 10⁻⁶) | the solution | run time |
| (ppm) | (mg) | mole MEA | (1/ppm min) | lost (ml) | (mins) |
| 435 | 531 | 0.25 | 1.77 | 8 | 598 |

Desorption 6

| Desorption step 1 | Microwave desorption time - 150 sec | | | | |
|---|---|---|---|---|---|
| HPL - 10 | Initial | After | 5 min wait | Final | Difference |
| | | desorption | for air to | | |
| Conc. of CO₂ (ppm) | 362 | — | mix properly | 799 | 437 |
| Volume of solution | 53 | 23 | in | — | 30 |
| (ml) | | | the chamber | | |
| RH (%) | 60.5 | — | | 100 | — |
| TVOC (ppb) | 348 | | | 66449 | |
| Temperature (C.) | 22.5 | 94.3 | | 48 | |
| Concentration of | 437 | Amount of | 534 | Volume of | 30 |
| CO₂ desorbed | | CO₂ | | the solution | |
| (ppm) | | desorbed | | lost (ml) | |
| | | (mg) | | | |
| Energy consumed | 70 | CO₂ unloading (mole CO₂/ | | 0.25 | |
| during Desorption | | mole MEA) | | | |
| (Wh) | | | | | |

TABLE 24
Experimental data of seventh absorption-desorption cycle of aqueous MEA solution.
Cycle 7

| | Concentration | | | Solution | |
|---|---|---|---|---|---|
| Absorption 7 | of CO₂ (ppm) | RH (%) | TVOC (ppb) | volume (ml) | pH |
| Initial | 1081 | 61 | 367 | 53 | 10 |
| Final | 694 | 100 | 6261 | 47 | 9 |

| | | CO₂ | | | |
|---|---|---|---|---|---|
| Concentration of | Amount of | loading | Rate constant | Volume of | Absorption |
| CO₂ absorbed | CO₂ absorbed | (Mole CO₂/ | (K″ × 10⁻⁶) | the solution | run time |
| (ppm) | (mg) | mole MEA | (1/ppm min) | lost (ml) | (mins) |
| 387 | 473 | 0.22 | 1.53 | 6 | 466 |

Desorption 7

| Desorption step 1 | Microwave desorption time - 150 sec | | | | |
|---|---|---|---|---|---|
| HPL - 10 | Initial | After | 5 min wait | Final | Difference |
| | | desorption | for air to | | |
| Conc. of CO₂ (ppm) | 367 | — | mix properly | 780 | 413 |
| Volume of solution | 53 | 23 | in | — | 30 |
| (ml) | | | the chamber | | |
| RH (%) | 57.8 | — | | 100 | — |
| TVOC (ppb) | 366 | | | 58864 | |
| Temperature (C.) | 22.5 | 93.5 | | 48.3 | |
| Concentration of | 413 | Amount of | 504 | Volume of | 30 |
| CO₂ desorbed | | CO₂ | | the solution | |
| (ppm) | | desorbed | | lost (ml) | |
| | | (mg) | | | |
| Energy consumed | 70 | CO₂ unloading (mole CO₂/ | | 0.23 | |
| during Desorption | | mole MEA) | | | |
| (Wh) | | | | | |

TABLE 25
Experimental data of eighth absorption-desorption cycle of aqueous MEA solution.
Cycle 8

| | Concentration | | | Solution | |
|---|---|---|---|---|---|
| Absorption 8 | of CO₂ (ppm) | RH (%) | TVOC (ppb) | volume (ml) | pH |
| Initial | 1062 | 59.1 | 367 | 53 | 10 |
| Final | 697 | 100 | 16807 | 47 | 9 |

| | | CO₂ | | | |
|---|---|---|---|---|---|
| Concentration of | Amount of | loading | Rate constant | Volume of | Absorption |
| CO₂ absorbed | CO₂ absorbed | (Mole CO₂/ | (K″ × 10⁻⁶) | the solution | run time |
| (ppm) | (mg) | mole MEA | (1/ppm min) | lost (ml) | (mins) |
| 365 | 446 | 0.21 | 1.7 | 8 | 553 |

Desorption 8

| Desorption step 1 | Microwave desorption time - 150 sec | | | | |
|---|---|---|---|---|---|
| HPL - 10 | Initial | After | 5 min wait | Final | Difference |
| | | desorption | for air to | | |
| Conc. of CO₂ (ppm) | 361 | — | mix properly | 766 | 405 |
| Volume of solution | 53 | 23 | in | — | 30 |
| (ml) | | | the chamber | | |
| RH (%) | 59.5 | — | | 100 | — |
| TVOC (ppb) | 460 | | | 78630 | |
| Temperature (C.) | 22.6 | 94 | | 45 | |
| Concentration of | 405 | Amount of | 495 | Volume of | 30 |
| CO₂ desorbed | | CO₂ | | the solution | |
| (ppm) | | desorbed | | lost (ml) | |
| | | (mg) | | | |
| Energy consumed | 70 | CO₂ unloading (mole CO₂/ | | 0.23 | |
| during Desorption | | mole MEA) | | | |
| (Wh) | | | | | |

TABLE 26
Experimental data of ninth absorption-desorption cycle of aqueous MEA solution.
Cycle 9

| | Concentration | | | Solution | |
|---|---|---|---|---|---|
| Absorption 9 | of CO₂ (ppm) | RH (%) | TVOC (ppb) | volume (ml) | pH |
| Initial | 1079 | 56.5 | 437 | 53 | 10 |
| Final | 705 | 100 | 10982 | 47 | 9 |

| | | CO₂ | | | |
|---|---|---|---|---|---|
| Concentration of | Amount of | loading | Rate constant | Volume of | Absorption |
| CO₂ absorbed | CO₂ absorbed | (Mole CO₂/ | (K″ × 10⁻⁶) | the solution | run time |
| (ppm) | (mg) | mole MEA | (1/ppm min) | lost (ml) | (mins) |
| 374 | 457 | 0.21 | 1.5 | 6 | 426 |

Desorption 9

| Desorption step 1 | Microwave desorption time - 150 sec | | | | |
|---|---|---|---|---|---|
| HPL - 10 | Initial | After | 5 min wait | Final | Difference |
| | | desorption | for air to | | |
| Conc. of CO₂ (ppm) | 378 | — | mix properly | 760 | 382 |
| Volume of solution | 53 | 27 | in | — | 26 |
| (ml) | | | the chamber | | |
| RH (%) | 58.9 | — | | 100 | — |
| TVOC (ppb) | 481 | | | 78649 | |
| Temperature (C.) | 22.8 | 94.7 | | 46.7 | |
| Concentration of | 382 | Amount of | 466 | Volume of | 26 |
| CO₂ desorbed | | CO₂ | | the solution | |
| (ppm) | | desorbed | | lost (ml) | |
| | | (mg) | | | |
| Energy consumed | 70 | CO₂ unloading (mole CO₂/ | | 0.22 | |
| during Desorption | | mole MEA) | | | |
| (Wh) | | | | | |

TABLE 27
Experimental data of tenth absorption-desorption cycle of aqueous MEA solution.
Cycle 10

| | Concentration | | | Solution | |
|---|---|---|---|---|---|
| Absorption 10 | of CO₂ (ppm) | RH (%) | TVOC (ppb) | volume (ml) | pH |
| Initial | 1045 | 61.8 | 411 | 53 | 10 |
| Final | 723 | 100 | 8826 | 46 | 9 |

| | | CO₂ | | | |
|---|---|---|---|---|---|
| Concentration of | Amount of | loading | Rate constant | Volume of | Absorption |
| CO₂ absorbed | CO₂ absorbed | (Mole CO₂/ | (K″ × 10⁻⁶) | the solution | run time |
| (ppm) | (mg) | mole MEA | (1/ppm min) | lost (ml) | (mins) |
| 322 | 393 | 0.18 | 1.69 | 7 | 375 |

Desorption 10

| Desorption step 1 | Microwave desorption time - 150 sec | | | | |
|---|---|---|---|---|---|
| HPL - 10 | Initial | After | 5 min wait | Final | Difference |
| | | desorption | for air to | | |
| Conc. of CO₂ (ppm) | 343 | — | mix properly | 664 | 321 |
| Volume of solution | 53 | 27 | in | — | 26 |
| (ml) | | | the chamber | | |
| RH (%) | 59.5 | — | | 100 | — |
| TVOC (ppb) | 369 | | | 78646 | |
| Temperature (C.) | 22 | 96 | | 48.6 | |
| Concentration of | 321 | Amount of | 392 | Volume of | 26 |
| CO₂ desorbed | | CO₂ | | the solution | |
| (ppm) | | desorbed | | lost (ml) | |
| | | (mg) | | | |
| Energy consumed | 70 | CO₂ unloading (mole CO₂/ | | 0.18 | |
| during Desorption | | mole MEA) | | | |
| (Wh) | | | | | |

### CONCLUSION

This study evaluated seven CSS, focusing on their appearance, CO₂ absorption-desorption performance, reaction kinetics, and effects on RH levels and TVOC concentrations. Aqueous MEA showed high CO₂ absorption and faster reaction kinetics but proved less suitable for indoor air capture due to elevated VOC emissions compared to aqueous Arg. Although the aqueous Arg solution performed better than aqueous MEA in terms of TVOC and RH control, it faced challenges with incomplete regeneration and significant solvent vaporization, limiting its use in continuous cycles. To address these issues, we introduced a water-PG-Arg solution, which demonstrated promising results by outperforming aqueous MEA in stability, safety, and long-term efficiency. The inclusion of PG effectively regulated RH during absorption and maintained the solution's liquid state during desorption. Overall, the water-PG-Arg solution exhibited consistent CO₂ absorption and reliable cyclic performance, positioning it as a viable and sustainable solution for indoor CO₂ capture. In our preliminary testing, the integration of an activated charcoal canister within the absorption setup further stabilized RH levels and reduced TVOC concentrations, as illustrated in FIGS. 10A-10B. As we progressed through the cyclic study, the water-PG-Arg solution's capacity to control RH was slowly impacted (FIG. 11A), presumably due to the loss of PG to evaporation primarily during the desorption processes, leading to a reduced mole fraction of PG in the resulting solutions, which can be attributed to a gradually lower TVOC generation (FIG. 11B) during the subsequent absorption processes.

### Example 2

CO₂ absorption was assessed with different surfactants. Foaming that occurs when the air is passed through the absorber is assessed in correlation with the use of the surfactant. One of the goals was to minimize foaming during this process in the optimization studies. Conditions that led to max absorption and least foaming have been identified (see Table 28). Least amount of foaming makes the process more sustainable, thus it is more desirable even though another formulation may show higher absorption but uncontrolled foaming.

### Absorption

The CO₂ absorption experiment was conducted using a 500 mL two-neck round-bottom flask containing a CO₂ scrubbing solution. The flask was connected to a condenser to recover evaporated water and amine vapors. The entire setup was placed inside a closed steel chamber (dimensions: 32×33×36 inches) equipped with an 8V fan to ensure air mixing. CO₂ was injected from the top of the chamber until the concentration reached 1000-1100 ppm, after which air was bubbled through the solution using a micro air pump to facilitate absorption.

The experiment was conducted under lab conditions at atmospheric pressure, with an initial temperature of 25±5° C. and initial relative humidity of 55±5%. Throughout the process, changes in CO₂ concentration (ppm), RH (%), and TVOCs (ppb) inside the chamber were measured using Graywolf IQ-610 sensors and logged every 30 seconds with a Graywolf Data Logger.

Multiple formulations of CO₂ scrubbing solutions were tested, including solutions with L-arginine, MEA, with and without surfactants such as Perfluorooctanoic acid (PFOA) Sodium dodecyl sulfate (SDS), Triton X-100.

### Results

The CO₂ absorption performance was evaluated for different scrubbing solutions containing MEA (monoethanolamine) or L-arginine, with and without surfactants (PFOA, SDS, Triton X-100) in propylene glycol (PG) and water mixture. The key parameters analyzed were relative humidity (RH), total volatile organic compounds (TVOCs), and CO₂ concentration before and after the absorption process. See Table 28.

TABLE 28

| | Initial | Final | Change | Initial | Final | Change | Initial | Final | Total CO2 |
|---|---|---|---|---|---|---|---|---|---|
| Solution | RH | RH | in RH | TVOC | TVOC | in TVOC | CO2 | CO2 | Absorbed |
| MEA + PG + H2O | 34 ± 12 | 81 ± 6 | 47 ± 8 | 134 ± 59 | 2166 ± 331 | 2032 ± 331 | 1065 ± 10 | 917 ± 21 | 148 ± 20 |
| MEA + PG + H2O + PFO | 55 ± 2 | 87 ± 2 | 32 ± 2 | 324 ± 33 | 2402 ± 468 | 2078 ± 501 | 1060 ± 8 | 737 ± 16 | 323 ± 8 |
| MEA + PG + H2O + SDS | 55 ± 2 | 88 ± 1 | 33 ± 1 | 329 ± 48 | 2727 ± 937 | 2398 ± 953 | 1066 ± 2 | 750 ± 60 | 316 ± 58 |
| MEA + PG + H2O + | 63 ± 5 | 88 ± 1 | 25 ± 4 | 391 ± 98 | 1819 ± 689 | 1428 ± 777 | 1058 ± 7 | 665 ± 30 | 393 ± 24 |
| TritonX100 | | | | | | | | | |
| L Arginine + PG + H2O | 57 ± 1 | 89 ± 0 | 31 ± 1 | 238 ± 44 | 5158 ± 1738 | 4920 ± 1742 | 1045 ± 10 | 923 ± 13 | 121 ± 10 |
| L Arginine + PG + H2O + | 42 ± 13 | 89 ± 0 | 46 ± 13 | 246 ± 30 | 6131 ± 1560 | 5884 ± 1591 | 1060 ± 7 | 744 ± 15 | 316 ± 10 |
| PFO | | | | | | | | | |
| L Arginine + PG + H2O + | 58 ± 2 | 89 ± 0 | 30 ± 2 | 297 ± 52 | 4787 ± 1004 | 4490 ± 1048 | 1055 ± 4 | 808 ± 52 | 247 ± 50 |
| SDS | | | | | | | | | |
| L Arginine + PG + H2O + | 60 ± 1 | 89 ± 0 | 28 ± 1 | 335 ± 40 | 5019 ± 556 | 4683 ± 594 | 1039 ± 12 | 774 ± 17 | 265 ± 25 |
| TritonX100 | | | | | | | | | |

MEA: Monoethanolamine
SDS: Sodium Dodecyl Sulfate
PFO: Perfluorooctanoic Acid
PG: Propylene Glycol

### Discussion

MEA+PG+H₂O+Triton X-100 demonstrated the highest CO₂ absorption among all tested solutions.

The highest CO₂ absorption was observed with MEA+PG+H₂O+Triton X-100, absorbing 393±24 ppm, followed closely by MEA+PG+H₂O+PFO (323±8 ppm) and MEA+PG+H₂O+SDS (316±58 ppm).

Among the L-arginine-based solutions, L-arginine+PG+H₂O+PFO exhibited the best absorption at 316±10 ppm, followed by L-arginine+PG+H₂O+Triton X-100 (265±25 ppm) and L-arginine+PG+H₂O+SDS (247±50 ppm).

The control solutions (MEA+PG+H₂O and L-arginine+PG+H₂O) showed the lowest CO₂ absorption at 148±20 ppm and 121±10 ppm, respectively, confirming the positive effect of surfactants on absorption performance.

Solutions that led to the least amount of foaming while achieving max absorption were also identified: MEA+PG+H₂O+PFO and L Arginine+PG+H₂O+PFO.

### Desorption

A microwave heating method was used for efficient CO₂ desorption from the scrubbing solution. The CO₂-loaded solution was placed in a 500 ml conical flask and sealed within the desorption chamber. After a five-minute stabilization, initial temperature, CO₂ concentration, RH, and TVOC levels were recorded.

Desorption was performed using a Panasonic 1200 W microwave oven at Power Level 10 for a set duration. Immediately after heating, the solution temperature and volume were measured, and the flask was covered to minimize vapor loss. After a five-minute waiting period, final readings of all parameters were taken.

This step was repeated multiple times without opening the chamber to ensure complete CO₂ desorption while maintaining the solution volume, allowing for an efficient and repeatable recovery process.

### Example 3

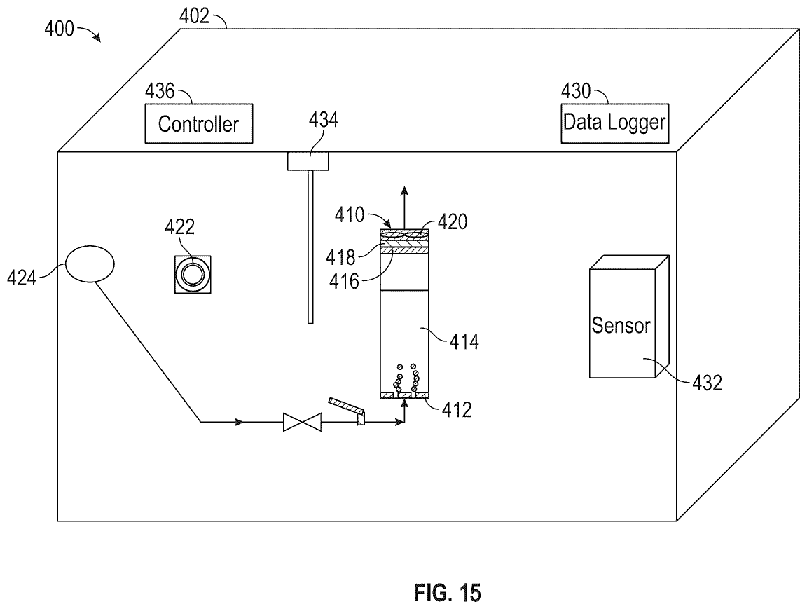

FIG. 15 illustrates a design of an apparatus 400 which the inventors created for capturing the CO₂ molecules from an enclosed chamber (e.g., a CO₂ chamber 402) in their characterization and validation studies. In particular, the apparatus 400 was designed to develop an efficient and scalable system to reduce elevated CO₂ levels in indoor air, thereby improving air quality. The design specifically targeted enclosed (e.g., sealed) spaces where CO₂ concentrations can be significantly higher due to human activity and insufficient ventilation. For example, the experiment as conducted in the CO₂ chamber 402 to simulate indoor CO₂ concentrations. By integrating physical and chemical processes for CO₂ capture, the apparatus 400 could offer a sustainable and energy-efficient alternative to traditional ventilation-based approaches. It should be understood that the apparatus 400 as described herein is merely one contemplated embodiment, and that the features, components, processes, and advantages described throughout this disclosure can be implemented in a variety of other embodiments and configurations, using some or all different components and materials.

In particular, the apparatus 400 integrated a sophisticated bubbling column system with chemical absorption, physical filtration, and air recirculation processes, creating an efficient system for capturing and managing CO₂ from air. Each stage of the mechanism was engineered to maximize effectiveness, utilizing both physical and chemical principles to achieve optimal performance.

The interior of the apparatus 400 contained a bubbling column 410, where air containing high levels of CO₂ was introduced through a sparger 412. The bubbling column 410 was made of acrylic with a height of 60 cm and a diameter of 5 cm and designed to facilitate gas-liquid interactions. The sparger 412 was constructed from stainless steel with a diameter of 5 cm, a length of 2 cm, and a pore size of 0.2 cm to create fine bubbles for enhanced gas-liquid contact. The sparger 412 generated a dense stream of fine bubbles and increased the surface area for interaction between the air and the absorbent liquid. This enhanced gas-liquid interface allowed CO₂ molecules in the air to dissolve into the liquid, initiating the absorption process.

A liquid absorbent 414 (e.g., absorbent solution or absorbent mixture) was a meticulously formulated mixture of water, propylene glycol, and L-arginine. L-arginine played an important role in chemically reacting with dissolved CO₂ to form carbamates, stabilizing the captured CO₂ in a bound form. Propylene glycol enhanced the solubility and facilitated the chemical absorption of CO₂ by improving the medium's efficiency. This combination ensured that CO₂ was absorbed and chemically fixed in a single, streamlined step and enhanced capture performance of the bubbling column 410. A mixture of 250 mL each of water and propylene glycol, combined with 87.1 grams L-arginine powder was utilized (e.g., or combined with 250 mL of a 1 M L-arginine solution). The solution was heated and stirred before the experiment. The total volume of the mixture after addition of L-arginine powder was estimated to be 650 mL, which was accounted as the initial volume of the liquid absorbent 414.

To prevent loss of the liquid absorbent 414 during the bubbling process, a mesh pad 416 (e.g., a mist eliminator) was positioned at the top of the bubbling column 410. The mesh pad 416 eliminated any liquid droplets carried upward by the bubbles and ensured that filtered air exited the bubbling column 410. The mesh pad 416 not only improved the system efficiency but also minimized waste and maintained the integrity of the liquid absorbent 414. The mesh pad 416 was placed at the top of the bubbling column 410 and included a height of 3.4 cm and a diameter of 5 cm, to capture liquid droplets and prevent carryover.

Above the mesh pad 416 lied a layer of activated charcoal (e.g., a charcoal layer 418 or a charcoal filling), which acted as a secondary filtration system. The charcoal layer 418 provided additional CO₂ adsorption through physical adsorption mechanisms. The porous structure of activated charcoal captures any residual CO₂ that might have escaped chemical absorption, ensuring a high degree of purification in the exiting air. Above the mesh pad 416, 25 grams of charcoal layer 418 was added to enhance CO₂ absorption.

A ventilation fan 420 (e.g., a 12-volt fan) located at the top of the design played an important role in maintaining airflow and environmental conditions within the system. It ensured continuous air circulation, prevented stagnation, and allowed fresh CO₂-rich air to enter the bubbling column 410 while expelling processed air. This circulation was important to prevent excessive buildup of CO₂ or other gases within the system and ensured desired conditions for the bubbling column 410 to function effectively. Additionally, the ventilation fan 420 helped to manage the moisture levels inside the bubbling column 410 by expelling humid air generated during the bubbling process, minimizing condensation, and protecting the components from excessive moisture exposure. This functionality supported the system's reliability and effectiveness in capturing CO₂ over extended operation periods.

An integral part of the system is a recirculation fan 422 (e.g., a 12-volt fan) located within the CO₂ chamber 402. The recirculation fan 422 continuously recirculated the air within the apparatus 400 and ensured uniform distribution of CO₂ concentrations. This consistency enhanced the efficiency of the bubbling process and ensured desired interaction between the air and the liquid absorbent 414.

An air pump 424 (e.g., a 12-volt micro air pump) was dedicated to introducing a steady flow of CO₂-rich air into the bubbling column 410. For example, the air pump 424 was used to bubble air into the liquid absorbent 414 at a controlled flow rate. The continuous flow ensured a constant supply of air for processing and allowed the apparatus 400 to operate efficiently without interruptions. The synergy between the air pump 424 and the recirculation fan 422 created a dynamic flow environment, maximizing the overall CO₂ capture capability.

The apparatus 400 was equipped with advanced monitoring technology, specifically a data logger 430 (e.g. GreyWolf DB-11-8), which tracked desired environmental parameters, including CO₂ concentration, RH, TVOCs, and temperature, in real time. The data logger 430 provided continuous feedback on the system's performance and enabled precise evaluation and optimization of the CO₂ capture process. This real-time monitoring ensured that the apparatus 400 operated at peak efficiency and offered insights into further improvements. A sensor 432 (e.g., a GreyWolf DB-11-8 sensor) was used to record CO₂ concentration, total volatile organic compounds (TVOCs), relative humidity (RH), and temperature throughout the experiment.

The experiment was conducted according to the following steps. First, the liquid absorbent 414 was prepared. The liquid absorbent 414 used in this experiment was a specially formulated mixture designed to maximize carbon dioxide (CO2) capture. Its composition included Propylene glycol (250 mL). Propylene glycol was chosen for its hygroscopic nature and ability to enhance the solubility of CO₂. Propylene glycol is a colorless, viscous liquid commonly used in chemical processes due to its stability and miscibility with water. In this experiment, 250 mL of propylene glycol was added to the liquid absorbent 414 to provide a stable medium that could facilitate CO₂ dissolution and interaction with other components.

Water served as the primary solvent and medium for dissolving CO₂. Water also played an important role in maintaining the overall fluidity and reactivity of the absorbent solution. The addition of 250 mL water ensured the solution remained homogeneous and suitable for bubbling L-Arginine (87.1 grams in 250 ml of water). L-Arginine, a naturally occurring amino acid, was used as a CO₂-reactive agent. L-Arginine reacted with CO₂ to form carbamates and enhanced CO₂ absorption efficiency. A 1 M solution of L-arginine was prepared by dissolving 87.1 grams of L-arginine in 250 ml of water. The mixture was heated to improve dissolution and enhance reactivity, ensuring that the L-arginine was fully dissolved before being incorporated into the liquid absorbent.

After heating and stirring the L-arginine solution, the L-arginine solution was mixed with 250 mL of propylene glycol to form the final absorbent solution (e.g., the liquid absorbent 414). The combination of water, propylene glycol, and L-arginine provided a desired balance of physical and chemical properties for CO₂ capture, including solubility, reactivity, and stability under experimental conditions. This liquid absorbent 414 was then used in the bubbling column 410 to enhance gas-liquid interactions and capture CO₂ effectively. The composition of the liquid absorbent 414 was important for maximizing the experiment's performance and achieving high absorption efficiency.

The calculation for 87.1 grams of L-Arginine used in the liquid absorbent was based on the requirement to prepare a 1 M solution of L-Arginine in 250 ml of water. Molarity of the Solution Molarity (M) is defined as the number of moles of solute per liter of solution. A 1 M solution means there is 1 mole of solute in 1 liter of solution. For 250 mL (0.25 L), the amount of solute required is 0.25 moles. The molecular weight of L-Arginine was 174.2 g/mol. The mass of solute required was calculated by Mass=Moles×Molecular Weight. Accordingly, the mass of L-Arginine required was 43.55 grams (for 250 mL of solution). Since the absorbent preparation included 500 mL of L-Arginine solution, the amount of solute was doubled: Mass for 500 mL is 43.55 g×2=87.1 g.

L-Arginine was used as a chemical reactant to enhance the CO₂ absorption efficiency. The role of L-Arginine was based on its ability to chemically bind CO₂, as it reacted with CO₂ to form stable carbamate compounds, effectively capturing CO₂ from the air. The presence of amino groups in L-Arginine facilitated chemical reactions with CO₂, increasing the solution's capacity to retain CO₂. By calculating and using precisely 87.1 grams of L-Arginine, the liquid absorbent 414 achieved the desired molarity for effective CO₂ capture under the specified experimental conditions.

Second, the mesh pad 416 was placed, and 25 grams of the charcoal layer 418 was added. The charcoal layer 418 and the mesh pad 416 played an important role in enhancing the overall efficiency and functionality of the carbon dioxide (CO₂) capture system. In particular, the charcoal layer 418, made of 25 grams of charcoal powder, was strategically placed above the mesh pad 416 at the top of the bubbling column 410 to provide an additional layer of filtration for CO₂ removal. The primary purpose of the charcoal layer 418 was to absorb residual CO₂ and other impurities that may not have been captured by the liquid absorbent 414. Activated charcoal had a highly porous structure, providing a large surface area for the adsorption of gas molecules, including CO₂. When air passed through the charcoal layer, residual CO₂ adhered to the surface of the charcoal pores, effectively reducing the CO₂ concentration in the outgoing air. While the primary CO₂ capture occurred in the liquid absorbent 414, charcoal acted as a secondary system to capture any CO₂ that escaped the absorbent phase, ensuring a higher capture efficiency. Overall benefits included improvement of the overall CO₂ removal efficiency of the apparatus 400, capturing volatile organic compounds (VOCs) and other impurities in the air, enhancing air quality, and providing an additional safety measure by ensuring minimal CO₂ leakage from the apparatus 400.

The mesh pad 416 was located just below the charcoal layer 418 at the top of the bubbling column 410. The primary purpose of the mesh pad 416 was to prevent liquid droplets from escaping the bubbling column 410 during the bubbling process. The mesh pad 416 ensured that the liquid absorbent 414 remained contained within the bubbling column 410 while allowing purified air to pass through. As air bubbles rose through the bubbling column 410, some liquid droplets could carry over with the air stream. The mesh pad 416 acted as a physical barrier that traps these droplets. By removing liquid droplets, the mesh pad 416 prevented contamination of the outgoing air and ensured the efficiency of the downstream charcoal layer 418. Overall, using the mesh pad 416 was beneficial as the mesh pad 416 retained the liquid absorbent 414 within the system, minimizing loss and ensuring continuous operation. The mesh pad 416 also prevented wet air from exiting the system, which could compromise the cleanliness and quality of the purified air. Further, the mesh pad 416 protected the charcoal layer 418 from becoming saturated with liquid, preserving adsorption capacity of the charcoal layer 418 for CO₂.

The combination of the mesh pad 416 and the charcoal layer 418 had benefits, including providing a two-stage filtration system. For example, the mesh pad 416 removed liquid droplets, and the charcoal of the charcoal layer 418 captured residual CO₂ and VOCs. The combination ensured that the outgoing air was free of both liquid contaminants and CO₂ and maximized the system's effectiveness. The mesh pad 416 protected the charcoal layer 418 from liquid saturation, prolonging functional lifespan of the charcoal layer 418 and ensuring consistent CO₂ adsorption over time.

The volume of the charcoal used over the mesh pad 416 was calculated using the formula for the volume of a cylinder, as the bubbling column 410 was interpreted to have a cylindrical structure. A diameter of the mesh pad 416 was 5 cm, and a height of the mesh pad 416 was 3.4 cm. Accordingly, the volume of the charcoal powder used was 66.8 cm³.

Third, the bubbling column 410 was placed in the CO₂ chamber 402 for testing. The CO₂ chamber 402 was designed to simulate indoor air conditioning with elevated CO₂ concentrations. The structure of the CO₂ chamber 402 and the integrated components ensured desired level of mixing, recirculation, and controlled delivery of CO₂ for the experiment. The dimension of the CO₂ chamber was 32 inches (81.28 cm) in length, 33 inches (83.82 cm) in width, and 36 inches (91.44 cm) in height. Thus, a volume of the CO₂ chamber was approximately 30,849.36 in³ (504,261.24 cm³). In the experiment, the size of the CO₂ chamber was sufficient to house the experimental apparatus, including the bubbling column 410, the sparger 412, and associated equipment, while maintaining an enclosed environment for consistent CO₂ levels.

Further, the recirculation fan 422 was installed inside the CO₂ chamber 402 to ensure uniform distribution and mixing of air within the CO₂ chamber 402. The recirculation fan 422 played an important role in maintaining consistent CO₂ concentrations, preventing localized variations in gas distribution, and ensuring the liquid absorbent 414 in the bubbling column 410 interacted effectively with the air. The operation of the recirculation fan 422 helped simulate natural air currents within a closed indoor space, enhancing the reliability of the results.

The air pump 424 was utilized to bubble air through the bubbling column 410 containing the liquid absorbent 414. The air pump 424 introduced air into the bubbling column 410 via the sparger 412, which created fine bubbles for improved gas-liquid interaction. The small bubble size maximized the surface area for CO₂ transfer into the liquid absorbent 414. The air pump 424 was designed to operate continuously, maintaining a steady flow rate throughout the experimental period.

During the experiment, the recirculation fan 422 and the air pump 424 were coordinated to work within the closed chamber environment. The recirculation fan 422 ensured even air distribution, and the air pump 424 introduced air directly into the bubbling column 410 (e.g., absorbent column). The recirculation fan 422 and the air pump 424 were powered by 12-volt supplies which ensured consistent performance during the extended duration of the experiment (e.g., from 9:02 PM to 5:32 AM).

Fourth, a CO₂ purging system 434 was activated, and the CO₂ chamber 402 was closed. In particular, the CO₂ chamber 402 was closed with all the apparatus inside and the CO₂ purging system 434 was manually turned on. A wait time of 10 minutes was proceeded, and the CO₂ purging system 434 was turned on. The data logger 430 began its estimation of the parameters within the chamber from 9:02 PM. The initial volume of the liquid absorbent 414 was 650 mL when the procedure started. The apparatus 400 could include a controller 436 (e.g., a power controller) that control operation of one or more components of the apparatus 400, including supplying power to the recirculation fan 422, the air pump 424, or the CO₂ purging system 434.

Finally, the CO₂ chamber 402 was opened to observe the results by 5:32 AM. The CO₂ concentration and other parameters were analyzed to evaluate the efficiency of the setup in capturing CO₂. The volume of the liquid absorbent 414 was 600 mL after the experiment was conducted. This suggested that 50 mL of liquid absorbent 414 was lost over a duration of 600 minutes.

The inventors' study thus provided evaluation data regarding the efficiency of CO₂ capture and system performance under controlled experimental conditions. Using a bubbling column system, the objectives were focused on optimizing air recirculation, minimizing CO₂ levels, and assessing environmental parameters such as temperature, relative humidity (RH), total volatile organic compounds (TVOCs), and absolute humidity. The results from the inventors' experiments provided a comprehensive understanding of how these variables interact over time, informing both the design and operational success of the system.

The experiments, conducted from 9:03 PM on Dec. 2, 2024 to 5:32 AM on Dec. 3, 2024, involved recording various parameters using the data logger 430. These parameters included CO₂ concentration, temperature, relative humidity (% RH), and absolute humidity. The recorded values were plotted against time, as illustrated in the figure below. Additionally, the minimum and maximum observed values are tabulated, along with the results of the regression analysis for this data.

The recorded experimental data covered a span from 9:03 PM on December 2nd to 5:32 AM on December 3rd, during which parameters were logged at regular intervals. The regression analysis and plotted trends allowed interpretation of the variations in CO₂ concentration, TVOCs, RH, temperature, and absolute humidity. The data logger 430 effectively captured key trends and relationships, giving insight into the system's behavior.

The CO₂ concentration exhibited a significant decline over time, from a maximum of 2103 ppm to 320 ppm. This steady decrease aligned with the expected outcome of the CO₂ capture process, validating the efficiency of the bubbling column 410. Conversely, TVOC levels demonstrated a gradual increase from 228 ppb to 1107 ppb. This upward trend reflects the volatilization of compounds within the system, which may require additional measures for secondary filtration or adsorbent optimization. Similarly, % RH increased linearly, progressing from 33% to 91%, indicative of the system's ability to manage environmental saturation over extended periods. Absolute humidity values followed a parallel trajectory, increasing from 7 g/m³ to 19 g/m³, revealing that the liquid medium was becoming increasingly saturated.

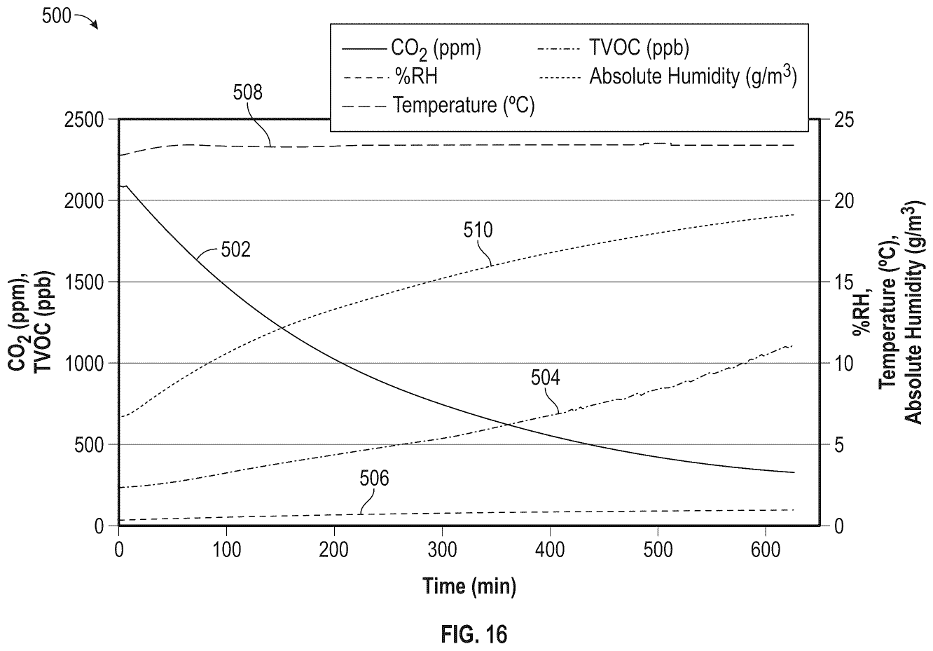

Interestingly, temperature displayed minimal variation, with a narrow range between 23° C. and 24° C., confirming the system's thermal stability. However, the regression analysis revealed a relatively weak correlation for temperature (R²=0.4956), suggesting that other factors may have contributed to minor fluctuations. FIG. 16 illustrates a graph 500 showing plots of integrated results for CO₂ concentration (e.g., line 502), TVOCs (e.g., line 504), RH (e.g., line 506), temperature (e.g., line 508), and absolute humidity (e.g., line 510) from the data logger 430 between 9:02 PM to 5:32 AM. Table 29 below shows minimum and maximum values and curve fitting coefficient for each plot lines 502, 504, 506, 508, and 510.

TABLE 29
minimum and maximum values and curve fitting
coefficient for plots in FIG. 1 above.

| | Measured Data | | Regression Parameter | | | |
|---|---|---|---|---|---|---|
| Parameter | Minimum | Maximum | a | b | c | R² |
| CO₂ (ppm) | 320 | 2103 | 0.0052 | −5.9023 | 2035.2 | 0.995 |
| TVOC (ppb) | 228 | 1107 | 0.0011 | 0.6788 | 238 | 0.998 |
| % RH | 33 | 91 | −0.0001 | 0.1639 | 34.1 | 0.996 |
| Temperature | 23 | 24 | −1*10⁻⁵ | 0.0012 | 23.16 | 0.497 |
| (° C.) | | | | | | |
| Absolute | 7 | 19 | −3*10⁻⁵ | 0.0352 | 7.09 | 0.996 |
| Humidity | | | | | | |
| (g/m³) | | | | | | |

As illustrated by line 502, the reduction in CO₂ concentration from an initial value of 2103 ppm to 320 ppm demonstrated the effectiveness of the bubbling column 410 in capturing CO₂. This outcome aligned directly with the system's objectives, wherein the absorbent mixture of water, propylene glycol, and L-arginine chemically bound CO₂ through carbamate formation. The fine bubbles generated by the sparger 412 maximized the gas-liquid interaction surface area, facilitating rapid absorption of CO₂. The regression analysis (R²=0.995) indicated a strong correlation and confirmed the precision of the system in reducing CO₂ levels. This level of performance validates the operational design of the system and its chemical absorbent. However, improving the consistency of capture over extended timeframes could enhance the system's long-term efficiency.

As illustrated by line 504, the increase in TVOC concentration from 228 ppb to 1107 ppb over the time frame presented a secondary challenge within the system. This rise likely reflected the volatilization of compounds from the absorbent mixture or from interactions within the chamber. A key contributing factor was the loss of 50 mL of liquid absorbent 414 during the experiment, reducing the total volume from 650 mL to 600 mL. As the volume of the absorbent decreased, the surface area for gas-liquid interaction remained consistent, potentially increasing the volatilization of organic compounds into the air. This trend suggested that the absorbent loss may be linked to the rise in TVOCs, either through direct off-gassing or as a result of interactions within the chamber. Addressing this issue would require additional filtration mechanisms, such as a second layer of activated charcoal, or optimizing the composition of the absorbent to reduce volatile emissions.

As shown by line 506, the relative humidity increased steadily from 33% to 91% over the course of the experiment. This trend was consistent with the moisture content being introduced into the chamber through the bubbling column 410. As the system captures CO₂, the continuous bubbling action and evaporation from the absorbent medium increased the moisture content in the air. The reduction in absorbent volume from 650 mL to 600 mL further supported this observation, as the 50 mL loss was likely attributed to evaporation and mist escaping into the air. While this increase in RH aligned with the system's closed-loop operation, managing such high humidity levels will be important for downstream applications or long-term operation. Future iterations could incorporate advanced mist eliminators or dehumidification systems to mitigate excessive humidity buildup.

As shown by line 510, absolute humidity followed a similar trend, increasing from 7 g/m³ to 19 g/m³. This result was directly tied to the loss of 50 mL of absorbent and the continuous evaporation occurring within the system. The bubbling process, while effective for CO₂ capture, also introduced moisture into the air, leading to a rise in absolute humidity. The regression analysis (R²=0.996) strongly correlated the trend with time, further emphasizing the impact of the absorbent's evaporation. While this increase was not unexpected, excessive humidity levels could pose challenges for system maintenance and air quality control. To address this, future designs could focus on improving the liquid absorbent's retention properties or incorporating humidity control mechanisms.

As shown by line 508, temperature remained stable within a narrow range of 23° C. to 24° C. throughout the experiment. This stability was indicative of the system's ability to maintain thermal equilibrium despite prolonged operation. However, the regression analysis (R²=0.4956) indicated a weak correlation, suggesting that temperature variations were not significant in driving the system's behavior. This outcome supported the design's adherence to safety considerations, ensuring no thermal stress on system components. While temperature stability was not a major challenge, maintaining this equilibrium in larger-scale or longer-duration operations will be important.

Overall, the data confirmed that the system effectively achieved its primary objective of reducing CO₂ concentration. However, the challenges of increased TVOC concentrations, rising relative and absolute humidity, and liquid absorbent loss highlighted areas for further optimization. By addressing these secondary issues, such as refining the absorbent composition, implementing enhanced filtration, and improving humidity control, the system's efficiency and reliability can be enhanced.

In conclusion, the experimental evaluation of the bubbling column 410 demonstrated effectiveness of the system in reducing CO₂ concentration, showcasing the potential of the liquid absorbent 414 and the sparger 412 in achieving high levels of gas capture. The results validated the system's primary objective of CO₂ removal, with an observed decline from 2103 ppm to 320 ppm. However, the analysis also revealed several design considerations which systems and methods herein may take into account, including: the potential for an increase in TVOC concentrations, rising humidity levels, and a loss of 50 mL of absorbent within the operation period. These issues may be solved appropriately based on the particular application involved, such as by enhancing the absorbent's stability, incorporating secondary filtration mechanisms like activated carbon filters, and implementing improved humidity management strategies. Despite these challenges not having been initially addressed by the inventors' first prototype, the prototype system still maintained stable thermal conditions, ensuring operational reliability. This experiment served as a foundation for future advancements in the inventors' work (as described above) in CO₂ capture technologies, providing knowledge into balancing efficiency, environmental parameters, and system longevity to meet both environmental and industrial objectives.

Unless defined otherwise, all technical and scientific terms used herein have the same meaning as commonly understood by one of ordinary skill in the art to which the invention pertains. All definitions, as defined and used herein, should be understood to control over dictionary definitions, definitions in documents incorporated by reference, and/or ordinary meanings of the defined terms. As used herein, the terms “have,” “has,” “having,” “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter. As used herein, the singular forms “a,” “an,” and “the” include plural embodiments unless the context clearly dictates otherwise. The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9 to 1.1.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention. All references, including publications, patent applications, and patents, cited herein are hereby incorporated by reference.

The present invention has been described in terms of one or more embodiments, and it should be appreciated that all possible equivalents, alternatives, variations, and modifications, aside from those expressly stated are within the scope of the invention.

As used herein, unless otherwise specified or limited, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “a single one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

Likewise, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

In some implementations, devices or systems disclosed herein can be utilized, manufactured, installed, etc. using methods embodying aspects of the disclosed technology. Correspondingly, unless otherwise indicated, any description herein of particular features, capabilities, or intended purposes of a device or system should be considered to disclose, as examples of the disclosed technology a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated, discussion herein of any method of manufacturing or using for a particular device or system, including installing the device or system, should be understood to disclose, as examples of the disclosed technology, the utilized features and implemented capabilities of such device or system.

Some methods of the disclosed technology may be presented above or below with operations listed in a particular order. Unless otherwise required or specified, the operations of such methods can be implemented in different orders, in parallel, or as selected sub-sets of one or more individual operations (e.g., with a particular listed operation being implemented alone, rather than in combination with others).

Abbreviations

| | |
|---|---|
| HVAC | Heating, Ventilation, and |
| | Air Conditioning system |
| OSHA | Occupational Safety and |
| | Health Administration |
| NOAA | National Oceanic and |
| | Atmospheric Administration |
| C_{CO}_{₂} | Concentration of CO₂ |
| CSS | CO₂ scrubbing solution |
| CSA | CO₂ scrubbing agent |
| MW | Microwave |
| TVOCs | Total Volatile Organic Compounds |
| RH | Relative Humidity |
| ppm | parts per million |
| Ppb | parts per billion |
| LC-MS-QqQ | Liquid Chromatography Mass |
| | Spectroscopy triple quadruple |
| HS-GC-MS | Headspace Gas Chromatography |
| | Mass Spectroscopy |
| Arg | L-arginine |
| MEA | Monoethanolamine |
| PG | Propylene Glycol |
| EG | Ethylene Glycol |

### REFERENCES

Ma, J., Li, L., Wang, H., Du, Y., Ma, J., Zhang, X., and Wang, Z. (2022). Carbon Capture and Storage: History and the Road Ahead. Engineering 14, 33-43. doi: 10.1016/j.eng.2021.11.024.
Chen, H., Lu, J., and Obobisa, E. S. (2023). Striving towards 2050 net zero CO₂ emissions: How critical are clean energy and financial sectors? Heliyon 9 (12), e22705. doi: 10.1016/j.heliyon.2023.e22705.
Global Monitoring Laboratory-NOAA. (2023). Carbon Cycle Greenhouse Gases. https://gml.noaa.gov/ccgg/trends/global.html (Accessed Sep. 6, 2023).
Young, A. S., Parikh, S., Dedesko, S., Bliss, M., Xu, J., Zanobetti, A., et al. (2024). Home indoor air quality and cognitive function over one year for people working remotely during COVID-19. Build. Environ. 257, 111551. doi: 10.1016/j.buildenv.2024.111551.
Azuma, K., Kagi, N., Yanagi, U., and Osawa, H. (2018). Effects of low-level inhalation exposure to carbon dioxide in indoor environments: A short review on human health and psychomotor performance. Environ. Int. 121, 51-56. doi: 10.1016/j.envint.2018.08.059.
Jacobson, T. A., Kler, J. S., Hernke, M. T., Braun, R. K., Meyer, K. C., and Funk, W. E. (2019). Direct human health risks of increased atmospheric carbon dioxide. Nat. Sustain. 2 (8), 691-701. doi: 10.1038/s41893-019-0323-1.
Kuramochi, H., Tsurumi, R., and Ishibashi, Y. (2023). Meta-analysis of the effect of ventilation on intellectual productivity. Int. J. Environ. Res. Public Health 20 (8), 5576. doi: 10.3390/ijerph20085576.
Tsubaki, S., Furusawa, K., Yamada, H., Kato, T., Higashii, T., Fujii, S., et al. (2020). Insights into the dielectric-heating-enhanced regeneration of CO₂-rich aqueous amine solutions. ACS Sustain. Chem. Eng. 8 (36), 13593-13599. doi: 10.1021/acssuschemeng.0c05342.
Zeman, F. (2007). Energy and material balance of CO₂ capture from ambient air. Environ. Sci. Technol. 41 (21), 7558-7563. doi: 10.1021/es070874m.
Kim, Y. E., Lim, J. A., Jeong, S. K., Yoon, Y. il, Bae, S. T., and Nam, S. C. (2013). Comparison of carbon dioxide absorption in aqueous MEA, DEA, TEA, and AMP solutions. Bull. Korean Chem. Soc. 34 (3), 783-787. doi: 10.5012/bkcs.2013.34.3.783.
Zhao, H., and Baker, G. A. (2023). Functionalized ionic liquids for CO₂ capture under ambient pressure. Green Chem. Lett. Rev. 16 (1). doi: 10.1080/17518253.2022.2149280.
Lee, S. Y., and Park, S. J. (2015). A review on solid adsorbents for carbon dioxide capture. J. Ind. Eng. Chem. 23, 1-11. doi: 10.1016/j.jiec.2014.09.001.
Aronu, U. E., Svendsen, H. F., and Hoff, K. A. (2010). Investigation of amine amino acid salts for carbon dioxide absorption. Int. J. Greenhouse Gas Control 4, 771-775. doi: 10.1016/j.ijggc.2010.04.003.
Wei, D., Kotwica, D., Nardi, G., Moazezbarabadi, A., Spannenberg, A., Ludwig, R., et al. (2023). A lysine-based system for CO₂ capture and catalytic utilization to produce formates: Irreproducibility and conflicting reactivity. ChemistrySelect 8 (32), e202302307. doi: 10.1002/slct.202302307.
Masiren, E. E., and Harun, N. (2017). Comparison of different types of carbamate amine for stripping process. Chem. Eng. Trans. 56, 721-726. doi: 10.3303/CET1756121.
Lv, B., Guo, B., Zhou, Z., and Jing, G. (2015). Mechanisms of CO₂ capture into monoethanolamine solution with different CO₂ loading during the absorption/desorption processes. Environ. Sci. Technol. 49, 10728-10735. doi: 10.1021/acs.est.5b02356.
Said, R. ben, Kolle, J. M., Essalah, K., Tangour, B., and Sayari, A. (2020). A unified approach to CO₂-amine reaction mechanisms. ACS Omega 5 (40), 26125-26133. doi: 10.1021/acsomega.0c03727.
Chai, S. Y. W., Ngu, L. H., and How, B. S. (2022). Review of carbon capture absorbents for CO₂ utilization. Greenhouse Gases Sci. Technol. 12 (3), 394-427. doi: 10.1002/ghg.2151.
Custelcean, R. (2022). Direct air capture of CO₂ using solvents. Annu. Rev. Chem. Biomol. Eng. 13 (1), 217-234. doi: 10.1146/annurev-chembioeng.
Mai, B., Halfdan, E., Mai Lerche, B., Stenby, E. H., and Thomsen, K. (2023). CO₂ capture from flue gas using amino acid salt solutions. Downloaded from orbit.dtu.dk on. Available at: http://www.risoe.dtu.dk/Knowledge_base/publications/Reports/ris-r-1712.aspx.
Sang Sefidi, V., and Luis, P. (2019). Advanced amino acid-based technologies for CO₂ capture: A review. Ind. Eng. Chem. Res. 58 (44), 20181-20194. doi: 10.1021/acs.iecr.9b01793.
Guo, H., Li, H., and Shen, S. (2018). CO₂ capture by water-lean amino acid salts: Absorption performance and mechanism. Energy Fuels 32 (6), 6943-6954. doi: 10.1021/acs.energyfuels.8b01012.
Mahmud, N., Benamor, A., Nasser, M. S., Al-Marri, M. J., Qiblawey, H., and Tontiwachwuthikul, P. (2017). Reaction kinetics of carbon dioxide with aqueous solutions of L-Arginine, Glycine & Sarcosine using the stopped flow technique. Int. J. Greenhouse Gas Control 63, 47-58. doi: 10.1016/j.ijggc.2017.05.012.
Wei, D., Kotwica, D., Nardi, G., Moazezbarabadi, A., Spannenberg, A., Ludwig, R., et al. (2023). A lysine-based system for CO₂ capture and catalytic utilization to produce formates: Irreproducibility and conflicting reactivity. ChemistrySelect 8 (32). doi: 10.1002/slct.202302307.
Song, H. J., Park, S., Kim, H., Gaur, A., Park, J. W., and Lee, S. J. (2012). Carbon dioxide absorption characteristics of aqueous amino acid salt solutions. Int. J. Greenhouse Gas Control 11, 64-72. doi: 10.1016/j.ijggc.2012.07.019.
Pokorný, V., Lieberzeitová, E., Štejfa, V., Havlín, J., Fulem, M., and Růžička, K. (2021). Heat capacities of l-Arginine, 1-Aspartic Acid, 1-Glutamic Acid, l-Glutamine, and 1-Asparagine. Int. J. Thermophys. 42 (11). doi: 10.1007/s10765-021-02911-z.
Sengwa, R. J. (2003). A comparative dielectric study of ethylene glycol and propylene glycol at different temperatures. J. Mol. Liq. 108 (1-3), 47-60. doi: 10.1016/S0167-7322 (03) 00173-9.
Bougie, F., and Iliuta, M. C. (2014). Stability of aqueous amine solutions to thermal and oxidative degradation in the absence and the presence of CO₂. Int. J. Greenhouse Gas Control 29, 16-21. doi: 10.1016/j.ijggc.2014.07.008.
Chanchey, A., Saiwan, C., Supap, T., Idem, R., and Tontiwachwuthikul, P. (2011). Off-gas emission in CO₂ capture process using aqueous monoethanolamine solution. Energy Procedia 4, 504-511. doi: 10.1016/j.egypro.2011.01.081.
New Jersey Department of Health. (2009). Propylene Glycol Hazardous substance Fact sheet. https://nj.gov/health/eoh/rtkweb/documents/fs/3595.pdf. [Accessed Oct. 15, 2024]
National Library of Medicine—Ethylamine. (2024). C₂H₅NH₂|CID 6341—PubChem. https://pubchem.ncbi.nlm.nih.gov/compound/Ethylamine#section=Nikkaji-Number. [Accessed Oct. 27, 2024]
National Library of Medicine-Monoethanolamine. (2024). C₂H₇NO|CID 700—PubChem. https://pubchem.ncbi.nlm.nih.gov/compound/Monoethanolamine. [Accessed Oct. 27, 2024]
Gabriel, C., Gabriel, S., Grant, E. H., Halstead, B. S. J., and Mingos, D. M. P. (1998). Dielectric parameters relevant to microwave dielectric heating. Chem. Soc. Rev. 27 (3), 213-223. doi: 10.1039/a827213z.
Suleman, H., Maulud, A. S., Syalsabila, A., and Shahid, M. Z. (2020). The contribution of aqueous L-arginine salts to equilibrium carbon dioxide absorption in a co-promoter role at high pressure. Fluid Phase Equilib. 524, 112743. doi: 10.1016/j.fluid.2020.112743.
Taylor, C. D. L., Klemm, A., Al-Mahbobi, L., Bradford, B. J., Gurkan, B., and Pentzer, E. B. (2024). Ionic Liquid-Glycol Mixtures for Direct Air Capture of CO₂: Decreased Viscosity and Mitigation of Evaporation Via Encapsulation. ACS Sustainable Chem. Eng. 12 (20), 7882-7893. doi: 10.1021/acssuschemeng.4c01265.
McGurk, S. J., Martín, C. F., Brandani, S., Sweatman, M. B., and Fan, X. (2017). Microwave swing regeneration of aqueous monoethanolamine for post-combustion CO₂ capture. Appl. Energy 192, 126-133. doi: 10.1016/j.apenergy.2017.02.012.
Garg, U., Lowry, J., and Algren, D. A. (2019). Ethylene glycol and other glycols: Analytical and interpretation issues. In Critical Issues in Alcohol and Drugs of Abuse Testing (pp. 59-69). Elsevier. doi: 10.1016/B978-O-12-815607-0.00005-8.
New Jersey Department of Health. (2009). Right to Know Hazardous Substance Fact Sheet. https://nj.gov/health/eoh/rtkweb/documents/fs/3595.pdf. [Accessed Oct. 31, 2024]

1. An apparatus for managing CO₂ removal from an environment, comprising:
an air inlet configured to receive an airflow having an initial amount of CO₂ molecules;
a liquid solution configured to absorb CO₂ molecules from the airflow and reduce the initial amount of the CO₂ molecules;
a reservoir configured to receive the liquid solution;
a pump in fluid communication with the reservoir and configured to provide pressure to receive the liquid solution from the reservoir;
a pipe in fluid communication with the pump and configured to move the liquid solution from the pump to a plurality of openings for the liquid solution to contact the airflow; and
an air outlet configured to discharge the airflow having the reduced amount of the CO₂ molecules.

2. The apparatus of claim 1 further comprising at least one sensor configured to measure one or more of the initial amount of the CO₂ molecules at the air inlet or the reduced amount of the CO₂ molecules.

3. The apparatus of claim 1 further comprising a controller configured to provide a signal for regeneration of the liquid solution based on a difference between the initial amount of the CO₂ molecules and the reduced amount of the CO₂ molecules.

4. The apparatus of claim 1 further comprising a secondary filter to remove volatile organic compounds from the airflow.

5. The apparatus of claim 1, wherein the liquid solution includes an amino compound in a solvent comprising water, a glycol, and a surfactant.

6. The apparatus of claim 1, wherein the plurality of openings includes a spray nozzle.

7. The apparatus of claim 1 further comprising:
a fan configured to adjustably direct the airflow from the air inlet to the air outlet;
a column including a channel that is in fluid communication with the pipe to receive the liquid solution through the plurality of openings;
a plurality of packings positioned within the channel to provide the contact between the liquid solution and the airflow.

8. The apparatus of claim 7, wherein the plurality of packings includes one or more of: Raschig rings or a porous surface that is configured to be coated with the liquid solution.

9. (canceled)

10. The apparatus of claim 7, wherein the air inlet is arranged at a lower portion of the column and the air outlet is arranged at an upper portion of the column.

11. The apparatus of claim 7, wherein the reservoir includes one or more of:
a sealable reservoir;
a removable reservoir;
a storage container configured to receive absorbed CO₂ molecules from the sealable reservoir; and
an indicator that is configured to notify a user to replace or regenerate the liquid solution within the removable reservoir.

12. The apparatus of claim 1, wherein the apparatus is integrated into an airflow system that includes at least one of: an air conditioning (A/C) unit, a heating, ventilation, and air conditioning (HVAC) unit, and an exhaust,
wherein the liquid solution is heated for regeneration outside of the environment before entering the reservoir to absorb the CO₂ molecules.

13. A method for absorbing CO₂ from an environment, comprising:
receiving a first airflow having a first concentration of CO₂ molecules, the first airflow being originated from the environment and flowing in a first direction;
circulating a solution from a reservoir so that the solution contacts the first airflow in a second direction that is different than the first direction, the solution configured to absorb CO₂ molecules from the first airflow; and
discharging a second airflow having a second concentration of CO₂, the second concentration being less than the first concentration.

14. The method of claim 13, wherein the solution comprises an amino compound in a solvent comprising water, a glycol, and a surfactant.

15. The method of claim 13 further comprising:
measuring the first concentration of CO₂ via a first sensor; and
measuring the second concentration of CO₂ via a second sensor.

16. The method of claim 15, wherein, based on the measured first concentration of CO₂ or the second concentration of CO₂, adjusting at least one of: a flow rate of the solution, a temperature of the solution, a flow rate of the first airflow, or a flow rate of the second airflow.

17. The method of claim 15 further comprising one or more steps of:
determining a CO₂ reduction based on the measured first concentration of CO₂ and the measured second concentration of CO₂;
storing information regarding the measured first concentration of CO₂, the measured second concentration of CO₂, and the CO₂ reduction for a plurality of time points while circulating the solution;
determining a regeneration status of the solution based on the CO₂ reduction for the plurality of time points; and
heating the solution for regeneration, the heated solution configured to further absorb CO₂ from the environment.

18. (canceled)

19. (canceled)

20. The method of claim 13, wherein discharging the second airflow includes:
discharging the second airflow into the environment that the first airflow originated from; or
discharging the second airflow into a different environment than the environment that the first airflow originated from.

21. A device for controlling or adjusting CO₂ molecules in an environment, the device comprising:
a column including a channel that includes a channel inlet for receiving an airflow having CO₂ molecules and flowing in a first direction and a channel outlet for discharging the airflow from the channel;
a reservoir including a liquid solution that is configured to absorb the CO₂ molecules from the airflow;
a pipe in fluid communication with the channel to provide the liquid solution within the channel in a second direction that is different than the first direction;
a plurality of porous structures arranged in the column and configured to engage the liquid solution when received in the column via the pipe; and
a fan in fluid communication with the column and induces the airflow to move from the channel inlet to the channel outlet, the fan further discharging the airflow from the device.

22. The device of claim 21, wherein the reservoir includes an air inlet that is configured to receive the airflow from the environment, such that the airflow is directed from the reservoir to the channel via the channel inlet.

23. The device of claim 21, wherein the first direction is opposite the second direction.

24-50. (canceled)
